(19) United States
(12) Patent Application Publication
(10) Pub. No.: US 2018/0317640 A1
(43) Pub. Date: Nov. 8, 2018

(54) A BODY CARE BRUSH WITH INJECTED BRISTLES

(71) Applicant: TRISA HOLDING AG, Triengen (CH)

(72) Inventors: Michael SCHÄR, Egolzwil (CH); Peter ZURFLUH, Alpnach-Dorf (CH); Martin ZWIMPFER, Luzern (CH)

(73) Assignee: TRISA HOLDING AG, Triengen (CH)

(21) Appl. No.: 15/773,943

(22) PCT Filed: Nov. 1, 2016
(86) PCT No.: PCT/EP2016/076309

§ 371 Date: May 4, 2018

(30) Foreign Application Priority Data
Nov. 4, 2015 (EP) 15193030.2

(51) Int. Cl. A46B 3/00; A46B 9/04; A46B 15/00; B29C 45/26; B29C 45/16; B29C 45/44

(52) U.S. Cl. CPC A46B 3/005; A46B 9/04; A46B 15/0081; B29L 2031/425; B29C 45/1615; B29C 45/4407; A46B 2200/1066; B29C 45/2626

(57) ABSTRACT

A body care brush, especially a toothbrush, having a brush head, containing a main body that has a head part and containing a plurality of care bristles, wherein the care bristles are provided on the head part via a bristle carrier and form a bristle field, the head part and bristle field being part of the brush head. The care bristles are injection molded as one piece together with the bristle carrier by an injection molding process.

The invention relates to the field of body care brushes such as applicators for cosmetic products, such as e.g. mascara brushes, nail varnish brushes, facial brushes, and in particular toothbrushes and interdental brushes.

The invention concerns a body care brush, in particular toothbrush, with a brush head, comprising a main body with a head part as well as comprising a plurality of care bristles, in particular cleaning bristles, such as tooth cleaning bristles, wherein the care bristles are arranged on the head part via a bristle carrier and form a bristle field, and the head part and bristle field are part of the brush head.

The invention further concerns a method for manufacturing a body care brush as well as an injection moulding tool for carrying out the method.

It is known to manufacture the grip body of toothbrushes by way of an injection moulding method. However, as was hitherto the case, the tooth cleaning bristles are inserted into the bristle carrier in a conventional manner by way of a stamping process or by way of a method which is similar to the stamping process. Concerning this procedure, the tooth cleaning bristles are anchored in the head part in bundle-wise or tuft-wise manner.

Whereas the bristle tuft or bristle bundle as a rule itself has a defined cross-sectional geometry which is usually circularly round inherent of the manufacture, the tooth cleaning bristles within the bristle tuft or bristle bundle are not arranged in an organised manner. In contrast, the tooth cleaning bristles of a bristle tuft or bristle bundle bear compactly and forcibly on one another in the region of their base. As a rule, the bristle tuft or bristle bundle fans out somewhat towards the free bristle end.

Conveying bristling methods therefore limit the design freedom with regard to the cross-sectional shape of the bristle tufts or bristle bundles as well as with regard to the arrangement of the tooth cleaning bristles within the bristle tuft.

Approaches, concerning which the tooth cleaning bristles are likewise manufactured by way of an injection moulding method have become known in the meanwhile. Expressed simply, the tooth cleaning bristles are likewise injected. Hence for example WO-A-2012/093085 describes a toothbrush with injected tooth cleaning bristles as well as an associated manufacturing method.

However, the development of toothbrushes with injected tooth cleaning bristles is still at the very beginning. In connection with injected tooth cleaning bristles, it is therefore of no surprise that no new and cleaning-efficient ideas with regard to the arrangement of the tooth cleaning bristles within the bristle field are known.

However, it has now been found that the bristle field can be designed in a more optimal manner by way of cross-sectional geometries which are an alternative to the circular cross section of the bristle tuft or bristle bundle as well as by way of alternative and always organised arrangements of the tooth cleaning bristles within the bristle tuft or bristle bundle. In particular, a more optimal design or fashioning of the bristle field is targeted towards an improvement of the cleaning effect, an improved application of the care means or of the cosmetic product, such as e.g. toothpaste, varnish/paint, etc., as well as towards a gentle treatment of the body portions which are to be cleaned or cared for, such as the teeth, gums, skin, fingers/fingernails, eyebrows/eyelashes, lips.

It is therefore the object of the present invention to suggest a body care brush, in particular toothbrush, with an alternative bristling. A method as well as an associated injection moulding tool for manufacturing a body care brush, in particular toothbrush, having an alternative bristling is also to be suggested.

The object of the invention is achieved by the independent claims 1, 23, 28 and 35. The dependent claims as well as the description and the figures contain particular embodiments and further developments of the invention. Herein, the features of the method claims, of the device claims and of the product claims can be combined with one another where appropriate.

The bristles according to the invention, their arrangement and manufacture are predominantly shown and explained for example by way of toothbrushes. In order to avoid repetition, the described embodiments explicitly also apply to the body care brushes which are described above, without departing from the scope of the invention. Moreover, the described embodiment or design features can be applied individually or in combination.

The invention is characterised in that the care bristles, in particular cleaning bristles such as tooth cleaning bristles are injection moulded as one part together with the bristle carrier by way of an injection moulding method.

A care bristle in particular is to be understood as a firm, in particular stiff, but flexible, hair-like formation of plastic. A care bristle in particular at its tip has a diameter of larger than 0.5 mm in the cross section transverse to its longitudinal direction. The tip indicates the upper 5 mm of the free end section.

Whenever in the present description it is not noted otherwise, the mentioned care bristles are always manufactured by way of an injection moulding method, in particular as one part with a bristle carrier.

Known massage/cleaning elements are likewise manufactured by way of injection moulding. At their tip/extremity, they usually have a diameter of larger than 0.5 mm transverse to their longitudinal direction and are injected of a component with a lower Shore hardness than the care bristles.

For the sake of simplicity, the terms “injected” or injecting” are used in the present description as being representative for the manufacture in an injection moulding method.

The mentioned bristle carrier can now be an integral constituent of the head part. I.e., the bristle carrier is formed by or on the head part itself. It therefore forms no separate component.

According to this embodiment, the bristle carrier together with the care bristles can be injection moulded on the head part in a common injection moulding step.

According to an alternative construction manner of the body care brush, the bristle carrier can be a component which is formed independently of the head part. This component is hereinafter called (bristle) carrier body.

According to this embodiment, the care bristles can be formed on the carrier body in an injection moulding step. The premanufactured carrier body is inserted into an injection moulding cavity for this.

However, the carrier body can also be injection moulded together with the care bristles in a common injection moulding step.

The carrier body is connected to the head part on manufacture of the body care brush. As a rule, this step is effected subsequently to the bristling of the carrier body or to the manufacture of a unit of the carrier body and care bristles. The mentioned connection can be a material-fit connection, such as for example plastic welding (ultrasonic welding) or bonding. The connection can also be a positive connection and/or non-positive connection.

For this, the head part in particular forms a receiving bed for the carrier body, in the form of a deepening, into which the carrier body can be brought. The head part for example is spoon-like for this.

The carrier body can be platelet-like. In this case, the carrier body is a carrier platelet.

The carrier body can have a thickness or height of 0.7 mm to 2.0 mm, in particular 1.2 mm to 1.6 mm.

The head part or the bristle carrier can comprise one or more channels which are filled with the bristle component and which on manufacture correspond to the feed runners or injection points or distribution channels (distribution runners) in the injection moulding tool.

What is means by component in the present description is a “plastic component” or a “plastic material”.

The head part comprises a front side and a rear side. The front side corresponds to that side, on which the care bristles or their bristle field are arranged in the end product.

As already mentioned, the head part can form a receiving bed at the front side, for receiving a carrier body or for receiving care bristles.

If the bristle carrier is an integral part of the head part, then the receiving bed in particular is formed for receiving the injection moulded bristle carrier.

In the case of toothbrushes, the front side corresponds to that side, on which the thumb is placed upon the grip part or the grip body for the purpose of holding the toothbrush for cleaning the teeth.

The rear side lies opposite the front side and consequently also opposite the bristle field.

According to a further development, the bristle field comprise at least one bristle segment of a plurality of care bristles.

A bristle segment is particularly characterised in that this forms a surface region, or a part-field of the bristle field, in which care bristles are arranged on the bristle carrier at distances to one another, said distances being smaller, in particular significantly smaller, than the distance between the mentioned surface region, thus the bristle segment, and the surrounding care bristles.

In particular, a bristle segment is characterised in that this forms a surface region of the bristle field, in which care bristles are arranged on the bristle carrier in an interruption-free or continuous, in particular also regular or structured arrangement.

In particular, the care bristles of a bristle segment are arranged in the bristle segment in an organised manner. This means that the arrangement or position of the individual care bristles is predetermined and in particular follows logic and is not therefore random. Accordingly, the care bristles of a bristle segment can be arranged in the bristle segment according to a predefined order.

The care bristles can hence be arranged for example in rows or columns. The rows or columns can be straight-lined. The rows can also be arched or arcuate, in particularly circular-arc-shaped. The orientation in each case can be longitudinal, transverse or at an angle to the longitudinal direction of the brush head.

The bristle ends or the centre of the base of the care bristles can be used for fixing the arrangement. The care bristles can be arranged in a geometric manner, for example on a triangle, circle, ellipse, rectangle, square, polygon, etc. The care bristles can also follow another regular order or structure.

The care bristles can alternatively be arranged irregularly, following no structure.

As a further alternative, a share of the care bristles can follow a regular arrangement or structure and another share of care bristles can be arranged in an irregular manner, following no structure.

A combination of longitudinal rows/transverse rows or columns is also conceivable.

According to a further development, the care bristles within at least one bristle segment are arranged distanced to one another at their base. The distance between the care bristles within the bristle segment can be for example 0.1 mm to 0.8 mm, in particular 0.1 mm to 0.3 mm.

Concerning the design of the bristle length in the case of straight care bristles with a conical shape, in the case of shorter care bristles the bristle ends are closer together than in the case of longer care bristles. The distances between the care bristle bases in particular are identical for longer as well as shorter care bristles, wherein the ends of the shorter care bristles herewith lie closer together due to the given conical shape.

The same mould removal (demoulding) angle can therefore be provided in the case of longer and shorter care bristles.

The density of the bristle ends per surface unit decreases with the distance to the bristle carrier in the case of this embodiment.

What is means by base is that location, at which the free length of the care bristle ends towards the bristle carrier. The care bristle at its base merges into the bristle carrier or the segment pedestal (segment stand) or at the base is integrally connected to these and is injected with the same component (bristle component) as the bristle carrier in the same working operation.

A bristle segment can consist of care bristles of the same or different shape or geometry. Possible shapes or geometries of care bristles are described further below. The care bristles can moreover have the same sizes, such as diameter and length, within a bristle segment. The care bristles can also have different sizes, such as diameter or length, within a bristle segment. The care bristles can also have different demoulding angles within a bristle segment.

A bristle segment can comprise e.g. 2 to 30, in particular 4 to 15 care bristles. In particular, a bristle segment can comprise 4, 5, 6, 7, 8, 9, 10, 11, 12, 13, 14 or 15 care bristles.

According to a further development, the bristle field is organised into a plurality of bristle segments each with a plurality of care bristles. The bristle segments are distanced to one another in each case. In particular, the distance between the bristle segments is larger than the distance, in particular the largest distance, between the care bristles within a bristle segment.

A bristle field can comprise bristle segments with exclusively the same number of care bristles. A bristle field can comprise bristle segments of a different number of care bristles. A bristle field can comprise bristle segments of a different number of care bristles, wherein a number of bristle segments can each comprise an equal number of care bristles.

A bristle field can comprise bristle segments with the same shape. A bristle field can comprise bristle segments of a different shape. A bristle field can comprise bristle segments of a different shape, wherein a number of bristle segments have the same shape.

A bristle field can comprise 2, 3, 4, 5, 6, 7, 8, 9 or 10 bristle segments of a different shape.

The distance between the bristle segments can be 1 mm to 10 mm, in particular 1 mm to 5 mm.

The bristle field, apart from the bristle segments with injected care bristles and massage elements/cleaning elements, can also comprise conventional care bristles which in particular are manufactured by way of extrusion and which can be fastened to the bristle carrier by way of conventional bristling methods, such as anchor stamping or anchor-free methods such as AFT (anchor free tufting), IMT (in mould tufting), AMR, PTt technology or IAP (integrated anchorless production). The conventional care bristles are e.g. extruded bristles.

The convention care bristles can be e.g. pointed (tapered) or cylindrical. Pointed bristles are pointed at one side or both sides e.g. by way of a mechanical or chemical method. The mentioned care bristles can be conically pointed or tapered.

The interaction of conventional, in particular extruded care bristles and injected care bristles results in a higher cleaning performance than if only one of the bristle types were to be used.

Particularly preferably, conventional, in particular extruded cylindrical and conventional, extruded, pointed, care bristles are combined with injected care bristles.

The mentioned anchor-free methods are mentioned in various patents. Bristling machines which operate according to this mentioned are generally known and are manufactured and sold for example by the company G. B. Boucherie N. V., Izegem, Belgium, as so-called AFT machines (anchor free tufting machines). An appliance for fastening bristle carrier platelets provided with bristle tufts to head parts is disclosed for example in the document DE 200 06 311 U1.

A further type of bristling machine for manufacturing anchor-free bristled products is known from EP 0 343 646. In contrast to the already mentioned AFT technology, concerning which the convention care bristles are fastened by way of melting, here, for the anchoring, the conventional care bristles are peripherally injected by way of plastic in an injection moulding machine (in mould tufting IMT). A further type of bristling machine for manufacturing anchor-free toothbrushes is known from DE 10 2006 026 712. This combines the methods which have already been mentioned above. A bristle carrier platelet which is provided with bristle tufts (analogously to a bristled carrier platelet from the AFT process) is inserted into a cavity of an injection mould, into which cavity plastic is subsequently injected for anchoring and for forming the remaining part of the brush head (IMT).

The brush head can therefore comprise a combination of bristles tufts or bristle bundles with conventionally manufactured, i.e. extruded care bristles, which are fastened to this brush head, and bristle segments with injected care bristles.

The conventional care bristles can be arranged perpendicularly to the surface of the bristle carrier. The injected care bristles can run at an angle to the conventional care bristles.

Furthermore, it is also possible to arrange the conventional care bristles at angle and the injected care bristles in a straight manner. The injected care bristles and the conventional care bristles can also stand at an angle or in a straight manner.

The angles can be pronounced in any direction. This however is preferably orientated in the longitudinal or transverse direction.

The angle can concern individual bristle tufts or bristle segments, and an angle for a row/column is preferably designed identically.

The ends of the conventional care bristles can be higher than the ends of the injected care bristles. In particular, the ends of the conventional, extruded and pointed care bristles can be longer than the injected bristles.

The bristle ends of the care bristles of the bristle field can also end at the same height. In this case, the bristle ends form a plane bristle end surface in the bristle field. The bristle end surface corresponds to a cleaning-effective surface of the bristle field which is formed by the bristle ends.

The bristle ends can also be arranged staggered to one another in height and comprise bristle ends which protrude and bristle ends which are set back/set more deeply. The arrangement of protruding bristles ends and ones which are set back/set more deeply, in the bristle field, can thus result in a topography of the bristle end surface. Bristle part-end-surfaces which protrude and ones which are set-back/set more deeply can be therefore formed in the bristle field.

The bristle ends of the care bristles in the inside of the bristle field can therefore be set back/set more deeply compared to the bristle ends of a bristle ring which surrounds them.

Moreover, several bristle field regions can also be designed with set-back/more deeply set bristle ends.

The arrangement of protruding bristle ends and ones which are set back/set more deeply in a bristle field can also result in a pattern or symmetry seen in a plan view. Such an arrangement can form an oval, circular or polygonal pattern such as e.g. a cross.

The arrangement of protruding and set-back/set more deeply bristle ends in a bristle field can moreover result on a spherical or hemispherical or calotte-shaped bristle end surface or bristle part-end-surface. The shape in each case is either convexly protruding or concavely receding. The bristle end surface can also assume a different shape, for example the shape of a rotation body or a polyhedron.

The arrangement of protruding and set-back/set more deeply bristle ends in a bristle field can also result in an inclined bristle end surface or bristle part-end-surface.

The arrangement of protruding and set-back/set more deeply bristle ends in a bristle field can also result in a thinning. This is characterised in that adjacent care bristles protrude or are set back/set more deeply, to a different extent. Accordingly, it is also possible to generally design the care bristles differently long or to assign a different length to each care bristle. The different bristle lengths of adjacent care bristles can be provided in an organised manner (pattern, symmetry) or preferably in a non-organised manner (without pattern or symmetry). The height differences of adjacent care bristles in the case of this type of design are less than 5 mm, in particular less than 3 mm.

Moreover, one or more care bristles in the bristle field can be aligned obliquely. In this case, obliquely means at an angle with respect to the surface normal of the head part.

The base surface of the bristle segment, hereinafter called segment base surface, in particular has a geometry which is different from a circular shape. The segment base surface is defined by the cross-sectional outer contour of the bristle arrangement in the bristle segment at its base.

All base surfaces of the bristle segments can uniformly have the same shape in the bristle field. Moreover, different shapes of bristle segment base surfaces can however also be realised in the same bristle field.

Furthermore, a number of bristle segment base surfaces can have a first shape whilst another number of bristle segment base surfaces can have a second shape. At all events, the bristle segment base surfaces are organised, for example with an order or symmetry.

In particular, the segment base surface lies in a geometric plane, whose surface normal runs parallel to the demoulding direction. The demoulding direction in particular runs parallel to the longitudinal direction of the bristle cavity.

The bristle cavities of a bristle segment in particular are grouped together into a bristle cavity segment insert in the injection moulding tool. The bristle cavity segment inserts can be exchanged in particularly individually in the injection moulding tool. Alternatively, several bristle segments can also be grouped together into a bristle cavity segment insert. The injection moulding tool in particular comprises several equal bristle cavity segment inserts. This permits an efficient manufacture of the bristle cavity segment inserts.

The bristle longitudinal axes of the care bristles in particular run perpendicularly to the mentioned geometric plane. The bristle longitudinal axes of all or individual care bristles can also be inclined with respect to this plane. The inclination of the bristle longitudinal axes can be uniform or different.

Several, such as 2, 3, 4, 5, or 6 different inclinations of bristle longitudinal axes can be envisaged in the bristle field.

According to a further development, the outer contour of the segment base surface of the at least one bristle segment forms at least one corner.

At least one of the sides, in particular both sides which form the corner can be straight-lined. However, they do not necessary have to be straight-lined.

The sides which enclose the corners can enclose an obtuse angle to the corner, e.g. of 90° to 170° (angle degrees).

The sides which enclose the corner can enclose an acute angle to the corner, e.g. of 10° to 90° (angle degrees). A particular embodiment of such a corner is present in the form of a point.

According to a further development, the bristle segment along the sides which form a corner comprises at least two, in particular at least three care bristles. In particular, these are arranged in a row.

Surprisingly, it has indeed been found that bristle segments with corners improve the care effect, in particular the cleaning effect. The mentioned corners thus tackle contamination on body surfaces, such as on the teeth or skin, much better than e.g. round cross sections. The corners of the bristle segments moreover engage better in dental interstices.

However, the base surface can also assume a shape without the presence of a corner.

The outer contour of the segment base surface of at least one bristle segment can basically comprises at least one straight-lined stretch section or side.

The segment base surface of the at least one bristle segment can be polygonal. The polygonal geometry can be:
rhombic;
rectangular;
square;
triangular;
trapezoidal or truncated-pyramid-shaped,
hexagonal;
octagonal;
pentagonal.

Further, in particular polygonal shapes can be:
star-shaped;
rectangular base shape with pointedly tapering narrow sides;
T-shaped;
Y-shaped;
V-shaped;
C-shaped;
arrow-shaped;
cross-shaped.

The segment base surface of the at least one bristle segment however can also have a round geometry. Round geometries can be:
consisting of one or more segments of a circle;
annular;
oval;
elliptical.

Mixed forms of polygonal and roundish structures are likewise possible.

The segment base surface of the at least one bristle segment can moreover also be e.g. sickle-shaped, spiral-shaped, antennae-shaped, fishbone-shaped or drop-shaped.

The segment base surface of the at least one bristle segment can moreover also comprise two-dimensional geometries with a curvy rolling contour, such as e.g. kidney-shaped geometries or basically a free shape.

The segment base surface of the at least one bristle segment can moreover also have the shape of a circle segment or circle sector. A part of the segment base surface can also have the shape of a circle segment or circle sector.

The segment base surface of the at least one bristle segment according to a particular further development can have the shape of a ring sector, in particular of an annulus sector.

The size of the ring sector or annulus sector can vary and in particular is defined by the number of bristle rows and their length. Two, three or more than three bristle rows can therefore be provided for forming a ring sector. The length of the bristle row determines the sector angle.

Mixed forms of all mentioned bristle segments are likewise possible. Herein, individual segments are composed of the mentioned structures or geometries.

According to a further development, the bristle field comprises a plurality of bristle segments each with a ring-sector-shaped, in particular annulus-sector-shaped segment base surface. Several, in particular uniform bristle segments thus form annular, in particular annulus-shaped bristle arrangements in the bristle field. The bristle segments can also form ring-sector-shaped, in particular annulus-sector-shaped bristle arrangements in the bristle field. In particular, these can be open rings.

In a preferred embodiment, other oral hygiene members (cleaning or care elements) in particular conventional, extruded care bristles can be arranged within the ring or the ring sector.

According to a particular further development, the segment base surface of the bristle segment is strip-like. The segment strips can be straight-lined. The segment strips can also be arched, in particular wave-like (wavy). The strip shape is characterised by a large ratio of length to width.

Concerning the strip shape, it is possible for only one care bristle to be arranged in the width.

Several bristle segments can now be arranged into patterns. In particular, the patterns can be perceived given a plan view of the bristle field. Plan view in particular indicates the viewing direction from the outside towards the front side of the head part.

In particular, the bristle segments can be aligned relative to one another for forming a pattern. Bristle segments of any shape can be arranged on lines, circles, circle segments, ellipses, parts of ellipses, triangles, squares, rectangles, polygons or parts of polygons.

Hexagonal bristle segments can form a honeycomb structure in the bristle field. Rhombic bristle segments can form a rhombic pattern in the bristle field.

Generally, the shape of a bristle segment can also be repeated with respect to the alignment of several bristle segments relative to one another. This arrangement also permits a particularly efficient segment shape to be visually highlighted.

In particular, the shape of the segments can also be repeated in their alignment. I.e. circular segments can be arranged for example on circles or rhombic segments can be arranged in a rhombic (diamond) shape.

The bristle segments can be arranged in a manner directed at angles to the longitudinal axis. For example, rectangular or square bristle segments can be at an angle to the longitudinal axis of the bristle field which is not 90°.

The bristle segments can basically also be arranged at angles to one another and thus not aligned to one another. This for example can be such that no lanes, in which no care bristles are arranged, are formed in the bristle field in a lateral view.

Bristle segments can also be arranged without a visible organisation relative to one another, at least in a part-region.

Bristle segments which are arched in a strip-like manner can be combined into wave-shaped patterns. The final shape therefore continues over several bristle segments. For example, the mentioned wave-like pattern if ring-sector-shaped bristle segments are arranged in a manner alternately rotated by 180°.

Several straight-lined, strip-like bristle elements can be arranged parallel to one another. In this manner, the bristle segments form a hatching-like strip pattern. With regard to this, the bristle strips can be aligned:
obliquely to the longitudinal direction of the body care brush,
parallel to the longitudinal direction of the body care brush, or
perpendicularly to the longitudinal axis of the body care brush.

Obliquely to the longitudinal direction of the body care brush means at an angle between 0° and 90° (angle degrees), in particular between 10° and 80° and very particularly between 20° and 70°. In particular, an oblique position or setting of 40° to 50° gives the bristle field a hatching-like pattern.

It is also possible for the strip-like bristle segments to be aligned at different angles relative to the longitudinal direction of the body care brush. In such arrangements, the bristle segments can form patterns such as a fishbone pattern or grid.

A bristle segment can moreover also consist of several, continuous strip-like segment sections which are arranged at different angles relative to the longitudinal direction of the body care brush.

The continuous, strip-shaped segment sections can enclose a segment free space. The bristle segment which encloses a segment free space can be open or closed.

If the strip-like segment sections are arcuate, then according to this further development, these form a ring shape.

The segment free space can be bristle-less. Moreover, one or more further bristle segments can be arranged in the segment free space. Thus several bristle segments which form segment free spaces can be arranged nested within one another. Thus rings lying in one another can be formed.

Moreover, in the case of a toothbrush, an oral hygiene member can also be arranged in the segment free space. Oral hygiene members are described in more detail further below.

Several strip-like, continuous segment sections can form polygonal shapes such as rectangles, triangles or rhombuses and each form a correspondingly shaped segment free space. The strip-like segment sections in this case are designed in a straight-lined manner and are arranged at different angles relative to the longitudinal direction of the body care brush.

Moreover, it is also possible to arrange the bristle segments in a manner such that an extensive, carpet-like form of the bristle field results. In particular, larger, rectangular bristle segments or combinations of bristle segments result in the mentioned extensive appearance of the bristle field.

In a particular embodiment, the bristle field consists only of a single extensive bristle segment.

In a further particular embodiment, several, such as two or three extensive bristle segments which can have flexible zones in their intermediate spaces are provided. The flexible zones can be formed e.g. by way of webs in the bristle carrier or in the head part. The webs can be formed in combination with a soft component.

As mentioned above, a plurality of bristle segments can form a pattern in the bristle field in a plan view. The pattern can be regular or irregular.

However, one can also envisage the bristle segments being irregularity arranged and in particular not being aligned to one another.

According to a further development, a plurality of bristle segments in a plan view forms a pattern in the bristle field, said pattern depicting a message or information.

The pattern can depict a picture or symbol, such as e.g. an initial, a (company) logo emoticon or icon. Furthermore, the pattern can also depict a letter, a number or a combination of these, e.g. words.

According to a further development, one or more bristle segments in the bristle field and together with one or more oral hygiene members form an arrangement.

This arrangement can characterise itself by sub-structures which each represent a part of the bristle field.

An exemplary listing of possibilities for mentioned sub-structures:
one or more oral hygiene members encompass (enclose) one or more bristle segments;
one or more bristle segments encompass one or more oral hygiene members;
the oral hygiene member in its structure forms free spaces, in which in turn one or more bristle segments can be arranged; e.g. the oral hygiene member is wave-shaped and one or more bristle segments are attached in the wave troughs or the oral hygiene member is V-shaped and one or more bristle segments are arranged in the free space or the oral hygiene member is star-shaped and one or more bristle segments are arranged between the star corners;
several bristle segments form a structure with segment free spaces, in which one or more oral hygiene members can be arranged;
the oral hygiene member bears directly on the care bristle; the oral hygiene member contacts e.g. at least a part of the care bristles; the oral hygiene member e.g. as a support structure forms a jacket around the care bristle segment; the oral hygiene elements can thereby be half the height as the care bristles which are supported by the oral hygiene member;
the care bristles bear directly on the oral hygiene member, care bristles support the oral hygiene member;
a propeller-like structure is arranged around a point; for example bristle segments and oral hygiene members in an alternating manner, or another pattern of the arrangement such as several times bristle segments and once an oral hygiene member (e.g. antenna-shaped). The individual elements are then shaped in the manner of a propeller;
care bristles and oral hygiene members can alternate and e.g. form a concentric shape, i.e.

an oral hygiene member can be arranged in the centre, then care bristles and finally again oral hygiene members;
care bristles form a spiral shape and one or more oral hygiene members lie within the spiral or the arms;
oral hygiene elements can completely or partly encompass the edge of the bristle field.

The sub-structure per se can have specific arrangement characteristics. These for example can be:
symmetry (mirroring or point mirroring)
asymmetry (irregular shaping)
concentric arrangement

In the bristle field, several sub-structures can be combined into a bristle field. Examples of an arrangement of several sub-structures (can also be combined);
one after the other;
next to one another;
in different sizes in the same bristle field;
arranged symmetrically to the brush head;
arranged asymmetrically to the brush head.

If several identical or similar sub-structures are arranged, then these can differ in various characteristics. Examples of different characteristics concerning this are: colour, additives, component (material), material hardness (Shore hardness), material characteristics, size (diameter, length, width, height).

Further oral hygiene members or care bristles can be arranged between the sub-structures for the completion of the bristle field or for avoiding undesired gaps in the bristle field.

According to a further development, the brush head comprises at least one, preferably several care bristles which are arranged at the edge of the head part. The care bristles can also project beyond the edge.

In particular, the brush head comprises at least one bristle segment with at least one, in particular several care bristles which are arranged on the edge of the head part.

“At the edge” and “up to the edge” means that the respective care bristle is arranged directly adjacent to a termination edge or face edge of the head part and on this respectively. Thus for example a bristle segment can extend up to the edge or also on the edge of the head part. Accordingly, the bristle segment comprises care bristles up to the edge. The utilisation of the complete head part surface is a significant advantage of the care bristles compared to conventional care bristles and the cited bristling methods.

The outer edge of the bristle field or a part of this can therefore be formed by care bristles or parts thereof.

This is possible due to the fact that on injection moulding, in contrast e.g. to the stamping method, one does not need to keep free a holding edge for the fixation of the bristle tufts or the bristle bundles and also due to the fact that no edge is necessary for the holding in the stamping process. Moreover, neither does an edge need to be formed, in order to form e.g. blind holes or deepenings for the receiving of the bristle(s).

The injection moulding method furthermore also permits a large design freedom concerning the fashioning of the surface of the bristle carrier, from which the free lengths of the care bristles depart.

This surface can be dome-like or wavelike. The surface can also be inclined relative to the bristle longitudinal axes. This is achieved e.g. by a partition plane in the injection moulding tool, said partition plane being inclined with respect to the mould removal direction.

One can envisage the bristle segment forming a segment pedestal (stand), from which the free lengths of the care bristles of a bristle segment lead away. The segment pedestal can be part of the bristle carrier. The segment pedestal rises from a base surface which is formed by the bristle carrier, by a certain amount.

One can envisage the bristle segment being subjected to a forming (reshaping) step in the region of the bristle carrier or its segment base/pedestal, after or during the demoulding. A heating step can precede the forming step. The deformation can be carried out whilst still in the injection moulding tool or in a subsequent process.

Individual, several or all bristle segments can be reshaped. The reshaping or forming can be carried out in one or several steps.

The orientation and/or the arrangement of individual or all care bristles can be changed by way of the reshaping in the region of the bristle carrier or segment pedestal.

The forming or reshaping can also serve for the improved anchoring of the care bristles on the head part if this head part consists e.g. of a hard component.

Moreover, the reshaping can also serve for anchoring further oral hygiene members, in particular for anchoring conventional extruded care bristles.

The forming step can include a lateral or vertical upsetting of the bristle carrier in the region of the bristle segment or of the segment pedestal. In this manner, the bristle carrier can e.g. arch outwards in the region of the bristle segment or segment pedestal and form a hedgehog-like arrangement of the care bristles.

Furthermore, the bristle carrier can also be pressed from the rear (from rear side of the brush head) for deformation. Herein, the care bristles likewise reversely bunch out in a cone-like or hedgehog-like manner. Herein, a larger round bristle segment can be reshaped and brought into a funnel-like bristle arrangement. A deformation from the front side of the brush head is also conceivable.

It is essentially the shape of the bristle segment in the region of the deformation before the deformation which contributes to the final shape. Herein, it is particularly also care bristles in an annulus-shape arrangement, i.e. with a free space in the centre, which are of interest here, if these are deformed inwards or outwards. The shape therefore opens up and a ring of bristle ends arises, or a centring of the bristle ends towards a point results.

According to a further development, the bristle carrier or parts thereof are designed in an elastically compliant manner in a direction parallel to the bristle longitudinal direction, so that this or these yields/yield or give way on application of a contact pressure by the care bristles for the purpose of implementing a care step such as cleaning of the teeth or skin, and assumes/assume their original position again given the cessation of the contact pressure. I.e. the bristle field or its cleaning-effective surfaces yields or is deformed by way of the elastic yielding of the bristle carrier or parts thereof due to a bristle contact pressure.

The elastic compliance of the bristle carrier can be achieved by way of the bristle carrier having a suitably small height or thickness. For this, the bristle carrier can have a small height or thickness in a continuous manner.

For this, the head part or the bristle carrier can form a type of flexible membrane, on which the care bristles are arranged. The care bristles are injected onto the membrane. The membrane can be arched in a cushion-like or balloon-like manner in the direction of the free bristle end.

The membrane can consist only of the bristle component, of the bristle component and a soft component or of the bristle component and a hard component.

In particular, the flexible membrane is connected to an at least partly peripheral frame which forms the outer contour of the head parts or bristle carrier. In particular, the frame consists of a hard component.

In the case of a toothbrush, further oral hygiene members such as massage or cleaning elements, e.g. for the tongue, can be arranged on the membrane. The oral hygiene members are described in more detail further below.

The oral hygiene members can be assembled on the membrane or be injected onto this with another component or be formed with it as one piece from the same component as the care bristles.

If another component is used for the oral hygiene members, then this preferably does not connect to the bristle component (no material fit).

The oral hygiene members can be connected to the membrane via a positive-fit connection.

The oral hygiene members or also care bristles can hence be anchored in the membrane such that for example a holding element is injected directly onto or into the membrane (positively or materially). This ensures the connection. The function element (functional element) (care bristle or oral hygiene member) is subsequently formed on the holding elements itself, for example again by way of a positive fit or material fit.

The membrane can also be reduced to the extent that it is no longer an actual membrane, but a flexible, freely suspended plastic element is formed. This for example is a ring-like, arched formation which is formed between the care bristles and carries for example elements such as oral hygiene members or also care bristles. The formation is fixed with one or more ends of the arch to the head part or to the bristle carrier. The arch which lies between the e.g. anchored ends or the arch as a whole are arranged in a freely floating manner. In particular, the arch forms an intermediate space to the bristle carrier or to the head part.

The formation is resiliently shaped and therefore again obtain a flexibility. The element can be arranged centrally in the care bristles and be resilient in the bristle field in a pointwise manner due to the arched shape. The oral hygiene members or also the care bristles on the ring-like, arched formation can again form a topography. Of course, such a resilient element can be fixed to the bristle carrier or head part at one or more, such as two or three ends.

It is also possible for the bristle carrier to comprise a topography with a changing height or thickness of the bristle carrier. Herein, those regions of the bristle carrier with a lower height or thickness form structurally weak locations which then permit the elastic compliance or flexibility of the brush head.

The topography can also be an arching of the head part or of the bristle carrier which is convex considered from the cleaning side. The care bristles can also be arranged on the convex arching.

The topography can further be wave-like. The care bristles are arranged on the wave-like head part or bristle carrier.

As an alternative or additionally to a small height or thickness of the bristle carrier, the elastic compliance or flexibility of the brush head can also be achieved by way of a structural weakening of the bristle carrier. This weakening is achieved for example in the form of a groove or a hinge, which can optionally be filled with the bristle component and/or a soft component.

Thus for example at least one recess can be arranged in the head part or bristle carrier. In particular, several recesses can be arranged. The recess can be partial or complete, i.e. leading through the head part or bristle carrier.

The at least one recess in particular is an opening or through-hole in the head part or bristle carrier and therefore continuous between the front side and the rear side. The opening can be roundish, oval, polygonal or slot-like.

The at least one recess however can also be a deepening on the rear side and/or front side of the head part or of the bristle carrier.

Such a deepening can lead to a local weakening of the head part or of the bristle carrier in the region of the deepening due to the reduction of the thickness or height of the head part or of the bristle carrier.

The shape of the deepening can comprise e.g. a flute-shape, an arch shape or a wave shape. In particular, the deepening can be elongate, in particular groove-like. The deepening can run longitudinally relative to the longitudinal axis of the body care brush.

As is yet described hereinafter, again at least one opening or blind hole can be arranged in a deepening.

The care bristles are accordingly arranged on surface sections of the head part or of the bristle carrier, wherein the surface sections at least partly, in particular completely surround or frame the recess.

Moreover, it is possible for care bristles themselves to also be arranged in the deepenings. In particular, care bristles can also be attached directly up to the edge of the deepening or recess. The possibilities at the peripheral edge of the bristle carrier which have been mentioned above are hereby the case.

The at least one recess can be closed. In this case, the at least recess is completely surrounded by surface sections of the head part or of the bristle carrier.

The head part or the bristle carrier can comprise a plurality of closed recesses. These can be arranged e.g. in a regular pattern or can have a symmetry. For example bridge-like elements can be formed between the recesses in this manner.

The closed recess can for example be U-shaped and thus form a tongue in the head part. This tongue can be flexible or be rendered flexible by way of suitable adjustments to the head part (e.g. material weakening, deepening, recess).

The head part or the bristle carrier can thus be designed as a net-like or grid-like manner. For this, the head part can comprise a plurality of bristle strips or bristle webs which cross at an angle. The care bristles are accordingly arranged on the bristle strips. Recesses or free spaces exist at least partly between the bristle strips and are defined by the grid-like structure of the bristle carrier.

The in particular elastically compliant net or grid with the care bristles in particular is connected to an at least partly peripheral frame which forms the outer contour of the head part or of the bristle carrier.

This frame can be of a hard component. This frame can be of the component of the care bristle (bristle component). Massage/cleaning elements of a soft component can additionally be provided on the frame.

The grid-like bristle carrier can have topography. For example, it can be pre-bent and have an aching (to the top or bottom) or also a wave-like shape.

The frame can be designed in a flat manner, but it can also have a topography, thus for example be waved or arched. It can also have a bending, for example such that its bends upwards or downwards in a longitudinal or transverse manner.

The at least one recess can also be open. In this case, the at least one recess can be open towards the lateral edge and is consequently only partly encompassed by surface sections of the head part or bristle carrier.

The at least one recess can e.g. be slot-like. The at least one slot-like recess can be straight-lined or arcuate. The at least one slot-like recess can run longitudinally or at an angle, in particular transversely, to the longitudinal axis of the body care brush.

If for example several slot-like recesses, in particular openings, run parallel to the longitudinal axis of the body care brush, then the head part can be formed in a fork-like manner, wherein the care bristles are arranged on the “fork prongs”. As explained further below, the fork prongs can be designed in a freely deflecting manner.

The head part or the bristle carrier can now comprise a plurality of open recesses. The open recesses which e.g. are slot-like can delimit one or more surface sections on the head part which are arranged in a freely deflecting manner. Freely deflecting means that the surface sections are spring-elastically compliant on exerting a contact pressure when cleaning the teeth. The freely deflecting effect, apart from an ideal material selection, in particular is accomplished by way of the stiff connecting section between the surface section and the remaining head part being reduced by the recesses. If the recesses are openings, then even the surface sections are freely deflecting.

In particular, the head part or the bristle carrier can comprise lobe-like or leaf-like surface sections which are delimited by slot-like, in particular curved, open recesses.

The at least one slot-like recess, in particular opening, can also be arranged spirally in the head part and thus form a likewise spiral-shaped carrier section. The spiral-shaped carrier section can be led out of the second dimension into the third dimension in the direction of the cleaning side into the third dimension and thus form a tower-like or spiral-spring-shaped prominence on the front side of the head part. As with the other cases, the care bristles can again be formed directly on the spiral-shaped structure.

However, the aforementioned further developments with recesses in the head part or bristle carrier do not necessarily need to be combined with elastic characteristics of the head part or bristle carrier. This means that the recesses, in particular openings, do not necessarily need to be provided for the structural weakening of the head part.

The aforementioned further developments can also be applied for reasons of material saving or for anchoring oral hygiene members. The possibility of a through-rinsing of the brush head for the purpose of cleaning can also be a reason for the openings.

A structural weakening in the head part or bristle carrier can moreover also be accomplished by bridges or sections of a soft component in the head part or bristle carrier. Such a section can e.g. be annular. Herein, sections of a hard component can be connected to one another by way of a soft component.

In contrast to conventional manufacturing methods, the body care brushes according to this further development, which are characterised by a comparatively complex design, can be manufactured under economic conditions by way of injection moulding the care bristles together with the bristle carrier.

The head part can moreover comprise at least one sectionally peripheral shock absorber also called damper, buffer or bumper, which absorbs shocks on carrying out body care, such as cleaning the teeth. The shock absorber can be an elastically deformable element. The elastic deformability can be achieved by way of a suitable material and/or geometry.

The shock absorber can e.g. be a bead. In particular, the bead can comprise a cavity.

The shock absorber can e.g. be injected onto the head part.

The shock absorber can be manufactured completely or only partly of a soft component, or completely or only partly of the bristle component.

The shock absorber can also e.g. close or partly close the shaped, open recess, for example at the edge of the bristle carrier.

Generally, the recesses (closed or also open) can be covered or at least partly covered for example with a film of a soft component. Herewith, one succeeds in no skin parts or the like being pinched in the recess on application, given the movement of the projecting elements such as free ends, sharp elements or “fork prongs”.

According to a further development of the invention, the head part comprises an end section at the head end side (head-end-side end section) which is angled toward the bristle field in the longitudinal direction of the body care brush. However, the end section can also be angled away from the bristle field in the longitudinal direction of the body care brush.

The angled section forms at least one bristle segment with injected care bristles.

In particular, the angled section is peripherally injected with the bristle component.

According to a particular embodiment of this further development, the care bristles of the angled section are injected and the care bristles of the remaining bristle field are occupied by conventional, e.g. extended care bristles (for example by way of the stamping methods, AFT, PTt etc.).

The manufacture of such a body care brush can comprises the following manufacturing steps:
1. injection moulding the main body, wherein the bristle holes (recesses for conventional, extruded care bristles) in the head part and the head-end-side, angled head end section are moulded;
2. injection moulding the care bristles in the head end section, therein the head end section is peripherally injected with the bristle component;
3. occupying the remaining head part with conventional care bristles, e.g. by way of stamping, AFT etc.

The conventional stamping method has the advantage that the hole pins for forming the bristle holes as well as the injection moulding tool for manufacturing the injected care bristles do not mutually inhibit one another since these are inserted in different steps.

The angled section can be designed in a flexible, in particular freely deflectable manner. This permits the bending-away of the angled section with the injected care bristles for a subsequent stamping process.

The stamped, conventional care bristles in particular are perpendicular to the bristle carrier, but can also comprise inclinations along the longitudinal axis or the transverse axis of the toothbrush.

According to a further development, one can envisage the head part or the bristle carrier being subjected to a plastic reshaping (forming) step. The reshaping step can be effected during the injection moulding process e.g. between two injection moulding steps. The reshaping step/the deformation can also be effected subsequently to the injection moulding process, in particular during or after mould removal (demoulding) from the injection moulding tool.

The reshaping step during the injection moulding process entails a part of being able to be injected in a flat manner, and the angledness being achieved for example by way of a reshaping step before the next injection moulding step. The further injection moulding step occurs subsequently with the inserted reshaped part and peripherally injects this, in particular at least partly.

If the reshaping is effected after the injection moulding, then this entails various advantages. For example, a more complex product geometry can be achieved by way of implementing the additional reshaping step, without a complex injection moulding tool being necessary, for example if a part of the care bristles is inclined and another not.

The reshaping can include a bending, compression/upsetting or a stretching of the head part or bristle carrier, in the transverse direction and/or longitudinal direction.

The reshaping can be a bending or angling of sections of the head part or of the bristle carrier part downwards, to the rear side or upwards, to the front side, i.e. to the bristle side. Thus for example a front end section of the head part can be angled upwards, i.e. towards the front side or towards the bristle field, in a reshaping step. The front end section can form a so-called power tip in this manner.

The reshaping or forming step can also be envisaged during the anchoring of conventional, extruded care bristles, i.e. e.g. during a stamping method or AFT method, PTt method, etc.

The care bristles on the angled section of the head part or bristle carrier are accordingly at an angle with respect to the other care bristles of the bristle field.

According to a further development of the body care brush, the body care brush comprises a neck part which connects to the head part. The neck part is characterised by a section of the main body which is tapered with respect to the head part.

In a further development, one can now envisage injected care bristles of the embodiment described above, in particular at least one bristle segment with a plurality of care bristles, also being arranged on the neck part.

Thus in particular corresponding care bristles can be injected on in a front section of the neck part which is adjacent to the head part. The neck part therefore likewise forms a bristle carrier for injected care bristles.

This is possible due to the fact that the injection moulding does not demand a limitation with respect to the geometry of the bristle carrier, in contrast to the stamping method, and also due to the fact that no mechanical loading needs to be applied on attaching the care bristles.

The body, consisting of the head part with care bristles and the neck part, in particular can be manufactured from a single component, in particular from the bristle component.

Several bristles components of a different colour or Shore hardness can also be used.

In this embodiment, structures which act in a reinforcing manner can be formed in order to achieve the necessary stability. The structures can be of the bristle component.

Moreover, it is possible to inject this part of one component directly onto the grip part, for example at least in the carrier consisting of a hard component.

If the head part consists only of a bristle component, then this can be designed very thinly. Individual regions in the brush head consist only of the bristle components with care bristles which are fastened thereto. I.e. the bristle carrier is not supported by a core of a harder component.

According to a further development of a body care brush which is designed as a toothbrush, at least one oral hygiene member is arranged on the brush head. The oral hygiene member can consist of one or more hygiene elements. Such hygiene elements can be lamellae, pimples, rods or likewise care bristles.

The oral hygiene member can be a care member, a massage member or a cleaning member or a combination thereof.

The oral hygiene member can moreover be an active substance element with an active substance which is released/dissolved and is thus set free during the dental care, e.g. under the effect of a fluid such as water or saliva.

The activate substance element can consist of a carrier material and at least one active substance which is incorporated or embedded therein. The carrier material releases the active substance in a controlled manner, i.e. on contact with a fluid, such as water or saliva,

In particular, the active substance element can be assembled or injected on by way of an injection moulding method.

The carrier material in particular is present as a solid body, i.e. pill. The carrier material can be present as a gel-like or pasty body.

The active substance element can be a capsule or a so-called bead, i.e. mouthwash ball.

The activate substance can be arranged in a cavity of the active substance element as a separate component.

The active substance can be an integral part of the active substance element itself and be released from this i.e. by way of a dissolving process.

The active substance can comprise several phases with different active substances which can be released in a temporal sequence depending on the construction.

Herein, the following alternatives can be applied:
carrier material consisting of several shells or layers (decomposition of one shell after the other);
carrier material with a fluid or grainy core which is released after the decomposition of the shell.

The following types of active substances which, together with a suitable carrier material, form the active substance element can be differentiated as follows:
(a) Toothpaste-like effect which can render conventional pastes superfluous. The following ingredients are considered: sorbitol, aromas, hydrated silica, sodium lauryl sulphate, sodium monoflourophosphate, creatine, zinc sulphate, tricolsan, glycerine, sodium saccharine, propylene glycol, disodium phosphate, alumina, trisodium phosphate, sodium fluoride, betaine, titanium dioxide, cellulose gum, tetrasodium pyrophosphate, etc.;
(b) Antibacterial effect for the occasional cleaning of the brush head in the toothbrush glass before or after cleaning the teeth. The following ingredients are considered: sodium bicarbonate, citric acid, phosphoric acid, sodium carbonate, potassium carbonate, sodium perborate, sodium hexametaphosphate, sodium benzoate, sodium stearate, etc.
(c) Indicating the cleaning success e.g. by colouring the plaque on the tooth surface by way of colouring plaque residues.

The following ingredients are considered: glucose, maltodextrin, magnesium sterate, aroma, saccharin, microcrystalline cellulose, etc.;
(d) Additional active substances which do not occur in conventional pastes and which supplement or amplify their effect. Ingredients from (a-c).
(e) Ingredients for bleaching, e.g. with ingredients containing hydrogen peroxide.
(f) Two-component systems of active substance and toothpaste which is specially developed for this. A chemical or physical reaction arises when the active substances come together. This variant in particular is envisaged for active substances which cannot be integrated into a paste, since they would otherwise directly react with one another.

Biologically degradable substances based on starch or plastics which do not chemically react with the active substances are considered as a carrier material. A preferred carrier material is Polyox® from Dow Chemicals—a water-soluble artificial resin based on polyethylene oxide polymers which is suitable for forming a matrix or carrier for an active substance and moreover can be processed in various manners, e.g. injected, moulded or extruded, on account of its thermoplastic characteristics.

The active substance element can consist of a water-soluble, thermoplastic polymer, such as for example PVA (polyvinyl alcohol). Moreover, cellulose ethers such as hydroxypropylmethyl cellulose (HPMC) are also suitable.

Basically, the single use of the active substance element as well as the multiple use are possible. Concerning the single use, one use of the brush consumes an active substance element. The active substance element can be inserted afresh before each use or however also only be used occasionally. Concerning the multiple use, an application of the brush only consumes a part of the active substance element. The user recognises e.g. when the active substance is used up and can subsequently refill the brush by way of a new active substance element or replace it.

It is to be understood that the concentration or quantity of the active substance is set much lower in the case of an envisaged single use than with multiple use. With single use, the concentration corresponds roughly to the concentration of the active substances of conventional pastes. Concerning any multiple use, the respective concentration is increased by a multiple. Additionally to the concentration, the reach/use duration of the active substance element can also be influenced via the water solubility and water rinsing/water rinsing openings.

The oral hygiene member can e.g. be an oral cavity cleaner or tongue cleaner.

The oral hygiene member or its hygiene elements in particular can be of a soft-elastic plastic material (soft component).

The at least one oral hygiene member of a toothbrush can be arranged on the front side of the head part. The oral hygiene member can comprise hygiene elements which protrude from the head part, such as pimples, cones, needles, rods or lamellae.

An oral hygiene member which is arranged on the front side, accordingly a further development can project beyond the bristle field. Such an arrangement is possible if the care bristles are injected.

Specifically, injected care bristles, amongst other things are characterised in that these are already injected with the desired bristle end shape, as are described for example in this description. Consequently, the free bristle ends of injected care bristles no longer need to be subjected to further process/machining steps, in contrast to conventional care bristles.

Moreover, the free end of the oral hygiene member can lie at the same height as the bristle ends of the care bristles.

According to a further development, several oral hygiene members or oral hygiene elements of an oral hygiene member are arranged on the head part along the edge and are aligned towards the front side. The oral hygiene members or their hygiene elements can encompass the bristle field over part of the periphery or the whole periphery, e.g. in a ring-like (crown-like) manner. Here too, the oral hygiene members or their hygiene elements can project beyond the care bristles or end with these at the same height.

Moreover, these oral hygiene members can be arranged very close to the care bristles, since it is only the cavity wall of the injection moulding tool which acts in a limiting manner.

The at least one oral hygiene member can be arranged on the rear side of the head part.

The oral hygiene member can e.g. comprise a plurality of care bristles which are injected on at the rear side of the head part and which project from this. The care bristles are directed away from the head part, in particular counter to the care bristles which are arranged on the front side. The care bristles of the rear side and the care bristles of the front side in particular have parallel mould removal directions or longitudinal axes.

Analogously to the care bristles on the front side, the care bristles on the rear side can likewise form a bristle field. In particular, the care bristles are shorter, in particular half as short or shorter, than the care bristles on the front side.

The oral hygiene member which is arranged on the rear side of the head part can also comprise hygiene elements such as pimples, cones, needles, rods or lamellae, which project from the rear side of the head part.

The mentioned oral hygiene member in particular forms a tongue cleaner.

The at least one oral hygiene member can be arranged laterally on the head part.

The oral hygiene member can thus comprise a plurality of care bristles which are arranged on the side of the head part and protrude laterally outwards from this. The care bristles can form a bristle field. The care bristles of the rear side in particular are shorter, in particular are half as short or shorter, than the care bristles on the front side. The care bristles can be arranged peripherally around the head part.

The oral hygiene member which is arranged laterally on the head part can also comprise hygiene elements, such as pimples, cones, needles, rods or lamellae, which protrude laterally from the edge of the head part.

In particular, the mentioned oral hygiene member forms an oral cavity cleaner.

One can moreover also envisage the brush head on the front side comprising a bristle field with care bristles and on the rear side, as well as the side, as described above, a further bristle field, so that care bristles are arranged around the head part, e.g. in a hedgehog-like manner.

The lateral care bristles or the care bristles on the rear side of the head part can be manufactured of the bristle component of the care bristles in the same or in a separate working operation. The care bristles on the rear side can alternatively be manufactured from a soft component.

The oral hygiene member or its elements can be injected. The oral hygiene member or its hygiene elements can also be separately manufactured and subsequently fastened to the head part, e.g. via a mechanical connection, in particular positive connection.

The head part can consist of a single component. The head part can also comprise two components, specifically a core or a frame of a hard component and a jacket of a second component. The jacket can completely or only partly encompass (enclose) the core.

In particular, the second component is a soft component. The second component can be the bristle component of the oral hygiene member and/or also of the care bristles.

The head part can also comprise a third and fourth component, wherein these components are again a bristle component of the oral hygiene member and/or of the care bristles. These additional material components preferably differ in colour, Shore hardness or admixed additives.

The components, depending on the design of the bodies can also have no cleaning or care function, and thus merely serve for aesthetics or for the gripping function.

A stiffer or more flexible brush head can therefore arise in this manner, depending on the material selection of the hard component. The stiffness of the brush head can also be controlled by the geometry and the size conditions of the brush head.

An exemplary listing of different material combinations in connection with the method steps in the injection moulding process, relating only to the brush head:
a) Brush head with bristle field only of the bristle component.

Manufacturing steps:
1. Injection moulding complete brush
b) Brush head with bristle field, comprising an interface structure of a hard component and care bristles of the bristle component:

Manufacturing steps:
1. Injection moulding the hard component
2. Injection moulding the bristle component
c) Brush head with bristle field, comprising interface structure of a hard component and several different bristle components in the bristle field

Manufacturing steps
1. Injection moulding the hard component
2. Injection moulding the first care bristle component (first characteristics/colour/hardness etc.)
3. Injection moulding the second care bristle component (second characteristics/colour/ hardness etc.)
d) Brush head with bristle field, comprising an interface structure of a hard component and care bristles and oral hygiene members in the bristle field.

Manufacturing steps:
1. Injection moulding the hard component
2. Injection moulding the component for the oral hygiene member, in particular a soft component for massage/cleaning elements
3. Injection moulding bristle components for care bristles
e) Brush head with bristle field, comprising an interface structure of a hard component and care bristles and oral hygiene members in the bristle field

Manufacturing steps:
1 Injection moulding hard component
2. Injection moulding bristle components for care bristles
3. Injection moulding component for oral hygiene member, in particular soft component for massage elements/cleaning elements.
f) Brush head with bristle field, comprising an interface structure of a hard component and several different bristle components and an oral hygiene member in the bristle field

Manufacturing steps:
1 Injection moulding hard component
2. Injection moulding the first care bristle component (first characteristics/colour/hardness etc.)
3. Injection moulding the second care bristle component (second characteristics/colour/hardness etc.)
4. Injection moulding component for oral hygiene member in particular soft component for massage elements/cleaning elements
g) Brush head with bristle field, comprising an interface structure of a hard component and several different bristle components and oral hygiene member in the bristle field

Manufacturing steps:
1. Injection moulding the hard component
2. Injection moulding the first care bristle component (first characteristics/colour/hardness etc.)
3. Injection moulding the component for the oral hygiene member, in particular the soft component for the massage elements/cleaning elements
4. Injection moulding the second care bristle component (second characteristics/colour/ hardness etc.)

The oral hygiene member can moreover be designed spherically or hemispherically with hygiene elements such as care bristles, sharp cones, needles, pimples etc. which protrude therefrom. The oral hygiene member thus obtains a hedge-hog like fashion. The thus formed oral hygiene member can also be arranged directly on the head part.

The thus formed oral hygiene member can also be arranged on a care bristle or on a rod, in particular in its end section.

A bristle-like or rod-like hygiene element or oral hygiene member can moreover also be designed in a cactus-like manner by way of it comprising elements which protrude from the care bristle or rod on this.

A bristle-like or rod-like hygiene element or oral hygiene member can moreover comprise spherical or balloon-like function elements, e.g. in its free end section. The free end section can also be designed as a crown.

The spherical or balloon-like function element can have a roughness pattern or a surface structure.

The particular design of the end section also influences the cleaning effect.

Combinations of the oral hygiene members which are described above are likewise possible.

The oral hygiene member can also comprise a lamella skirt with a plurality of lamellae which are arranged e.g. in a row.

The hygiene elements of the oral hygiene member can have smaller distances to the care bristles compared to body care brushes with bristle fields with conventional care bristles. The distance at the base can be e.g. 0.1 mm to 0.8 mm, in particular 0.1 mm to 0.3 mm.

The oral hygiene members are preferably injected, i.e. injected on in a direct manner. However, it is also possible for these to be injected and subsequently assembled.

The separate manufacture can be advantageous particularly in the case of complicated mould removals (demouldings), since in this case no further limitations of further product elements are present.

The care bristles can have a bristle cross section which is different from being round or circular.

However, the care bristles can have a bristle cross section without corners. Such a bristle cross section in particular is roundish, such as oval or elliptical. The cross section can consist of circle segments, ellipse segments or arc segments.

The care bristles can have a bristle cross section with a maximal cross-sectional length and a cross-sectional width, wherein the cross-sectional length is longer than the cross-sectional width. The ratio of the cross-sectional length to the cross-sectional width can be 2:1 or larger. The ratio of cross-sectional length to cross-sectional width can moreover be 7:1 or smaller.

The bristle cross section consequently has a cross-section longitudinal axis which extends in the cross-sectional length.

If the care bristles are characterised by a large ratio of the cross-sectional length to cross-sectional width, then the care bristles can also have a lamella-like shape. In this context, the lamellae-like care bristle injected from the bristle component differs from a hygiene member above all by the component.

The care bristles now in particular have different mechanical characteristics, such as stiffness, in various directions. They affect the cleaning effect. The stiffness in the direction of the cross-sectional length is thus larger than in the direction of the cross-sectional width.

The cleaning effect of the care bristles can be adjusted or set by way of a targeted alignment of the cross-section longitudinal axis on the head part or on the bristle carrier.

The cross section longitudinal axis can be aligned e.g. at an angle of 90° (transversely) or 0° (parallel) to the longitudinal axis of the brush. An angle between 0° and 90° e.g. 45° is likewise possible.

It is possible for the cross section longitudinal axes of the care bristles to have the same orientation.

One can also envisage the cross section longitudinal axes of the care bristles having different orientations.

According to a further development, the care bristles can also have a polygonal bristle cross section. The bristle cross section can thus represent an n-sided polygon.

Here too, or generally, the care bristles can have different stiffnesses in directions transverse to the bristle longitudinal axis.

A polygonal shape can be: triangular, rectangular, such as square, rhombic, parallelogram-shaped, hexagonal or octagonal.

The corners of these shapes can be rounded.

In a particular embodiment, corners can essentially also be sharp-cornered, in order e.g. to deliberately increase the cleaning performance. Essentially sharp-edged corners can also be provided only over a certain length of the injected care bristles, for example on the upper end section. This for example can be the upper 5 mm to the upper end of the care bristles.

Concerning rhombic care bristles, the angles of the side surfaces which abut one another are unequal to 90° (angle degrees), in particular unequal to 85° to 95°.

The bristle cross section can comprise projecting corners or jags. The bristle cross section can also comprise inwardly pointing corners.

The bristle cross section can therefore also be serrated. Serrated cross-sectional shapes are characterised by jags which point radially outwards. The bristle cross section for example can be star-shaped.

The bristle cross section can moreover also comprise crossing cross-sectional arms. The arms of the bristle cross section can be arranged at an angle of 90° to one another and e.g. form a cross shape. The arms can be arranged at an angle to one another which is smaller or larger than 90° and e.g. represent an “X”.

The stiffness of the care bristle varies in different directions depending on the design and arrangement of the cross-sectional arms. The stiffness can therefore be influenced e.g. by the length of the arms and the angle between the crossing arms.

The care bristles can be designed in a straight-lined manner in the bristle longitudinal direction. The care bristles can also have a sharp bend or bendings, e.g. arched bends. Since these shapes are only manufacturable to a limited extent by way of injection moulding, the care bristles can also be processed or machined at a later stage. Possible methods or combinations of methods are mechanical forming (reshaping) (such as e.g. stretching, upsetting, bending, bending at a sharp angle), heat treatment, ultrasound, laser treatment etc.

Arched bendings can act as spring elements which absorb a bristle contact pressure. In this manner, the free bristle ends are mounted in an elastically complaint manner in the bristle longitudinal direction via the arched bendings.

The care bristles can form a solid cross section.

However, the care bristles can also be designed at least partly in a hollow manner and e.g. form a hollow channel, hereinafter called bristle channel, which runs in the bristle longitudinal direction. In particular, the care bristles can be tubular.

The care bristle according to this further development comprises in particular exactly one, e.g. centrically arranged hollow channel. The care bristle however can also comprise several hollow channels which e.g. run parallel next to one another.

Care bristles with a hollow channel can have a cross-sectional shape which is described above, wherein the cross-sectional shape in the particular embodiment relates to the outer contour of the care bristle.

The shape of the inner contour of the care bristle which forms the hollow channel can then correspond to the shape of the outer contour or also be different to this.

In the case of different contours (inner and outer), again variations in the stiffness can be achieved.

Accordingly, the wall thickness of the care bristle which is delimited by the outer and inner contour can be constant over the whole bristle cross section, or changing. The wall thickness can be e.g. 0.2 mm to 2 mm, in particular 0.5 mm to 1 mm.

The bristle cross section according to this further development can e.g. be annular. According to this embodiment, the cross-sectional shape of the outer contour of the care bristle can be round or circular, oval or elliptical. The cross-sectional shape of the inner contour can likewise be round or circular, oval or elliptical. However, the inner contour can also have a shape which differs from the outer contour.

The hollow channel can extend over the complete bristle length. The hollow channel can also extend only over a section of the bristle length. The hollow channel can thus extend towards the bristle end in an upper bristle length section. The care bristle can be designed as a solid body towards the bristle base in a lower bristle length section.

The stiffness of the care bristle can vary over its longitudinal extension by way of this.

Moreover, it is also possible for the hollow channel to be designed for the feed of a fluid, such as mouthwash, to the bristle end and for the delivery of the fluid at the bristle end. Accordingly, the hollow channel is connected in particular at the bristle base to a feed channel in the head part or bristle carrier.

Basically, an oral hygiene member can also be designed in the same manner as the care bristle with the hollow channel which has just been described above.

The hollow channel can basically also serve as a retaining element, e.g. for toothpaste or the like.

The care bristles can have a constant cross-sectional shape in the bristle longitudinal direction. The care bristles can also have a changing cross-sectional shape in the bristle longitudinal direction.

The care bristles can have a constant cross-sectional size in the bristle longitudinal direction. The care bristles can also have a changing cross-sectional size in the bristle longitudinal direction.

The care bristles can e.g. taper from the head part or from the bristle base towards the free bristle end. The tapering can run continuously or discontinuously, e.g. in a stepped manner. In particular, a continuous tapering can be conical.

The tapering of the type mentioned above however can also be the other way around, specifically effected from the free bristle end towards the head part or towards the bristle base. Such geometries are yet explained in more detail further below in connection with undercuts.

The care bristles, in particular their bristle end sections, at their outer contour can have a superimposed geometry which superimposes the cross-sectional shape which is mentioned above, without significantly influencing the character of the cross-sectional shape or of the geometry of the bristle end sections.

Such a superimposed geometry can e.g. be a regular or irregular roughness pattern. The roughness pattern can comprise micro-grooves. The roughness pattern can comprise crater structures.

Since such a superimposed geometry is or can be very small-scaled, one speaks of a structuring.

Such a structuring can be achieved by way of correspondingly structured walls of the bristle cavities in the injection moulding tool, wherein the structure of the walls of the bristle cavities is conferred upon the outer contour of the care bristles on injection moulding.

A structuring of the walls of the bristle cavities can be achieved by way of erosion methods such as micro-erosion methods.

A structured bristle surface can also be achieved by way of the application of an additional material, in particular tiny particles of sand or diamond, which are admixed to the bristle component. The tiny particles can also be deposited onto the bristle surface in a coating method.

A structured bristle surface can also be achieved by way of a post-treatment by way of mechanical machining (such as e.g. grinding, abrasion, reshaping (forming), pressing etc.) or by way of coating such as vapour deposition or spraying, with a second or further material.

A structured bristle surface can also be achieved by way of heating and a subsequent change of the bristle surface.

According to a further development, at least one, in particular several or all cavities of the care bristles in the injection moulding tool and therefore also the corresponding care bristle at least locally comprise a cross-sectional reduction considered from the free bristle end in the direction of the head part or bristle base.

The at least one cavity of the care bristle in the injection moulding tool according to this further development and thus also the respective care bristle in particular forms at least one undercut.

The geometry of such an undercut shaped element is characterised in that the cross section of the care bristle and accordingly also of the associated bristle cavity of the injection moulding tool locally undergoes a narrowing considered in the demoulding direction.

A cross-sectional narrowing considered in the demoulding direction or in the direction of the bristle base leads to an impediment of the mould removal process, since on mould removal of the care bristle a larger bristle cross section must be led through a smaller cross section of the associated bristle cavity. In this context, one also speaks of a “forced demoulding”.

A forced demoulding is also present if the direction course of the care bristle and accordingly of the channel-like bristle cavity differs significantly from the mould removal direction. This is the case e.g. if the care bristle comprises one or more bendings, sharp bends or angles. Thus for example a forced demoulding is present if the care bristle runs in a serpentine manner. The care bristle can of course likewise have the geometries which are mentioned above.

Undercuts or cross-sectional narrowings are avoided wherever possible when designing the bristle geometry, since these render the demoulding impossible or lead to a permanent deformation or damage of the care bristles during the demoulding.

However, surprisingly, it has been found that the targeted application of undercuts can be used to bring about a deliberate deformation of the care bristles on demoulding the care bristles out of the injection moulding tool. This means that the tool cavity does not define the desired final shape. This final shape is not achieved until in a subsequent reshaping step, in particular in the form of a stretching, during the mould removal.

The care bristles are demoulded in the longitudinal direction of the channel-like bristle cavity, i.e. in the longitudinal direction of the care bristles. An undercut or generally a cross-sectional narrowing considered in the demoulding direction leads to the related bristle section with the larger cross section getting caught in the bristle cavity. This can now be changed by way of a plastic deformation, such that the mentioned bristle section fits through the narrower cavity section of the bristle cavity. The deformation for example can be a squeezing of the care bristle in the radial direction or a stretching of the care bristle parallel to the demoulding direction.

The care bristle is therefore pulled or stretched into length by way of plastic deformation due to the aforementioned effect of the undercut or of the cross-sectional narrowing. By way of this, one the one hand the bristle length increases and on the other hand the cross-sectional size and thus the diameter of the care bristle reduce.

As a result, the diameter of the injected care bristle is reduced and its length is increased, relative to the bristle cavity, due to the additional plastic deformation.

This effect is of particular interest inasmuch as the manufacture and the operation of an injection moulding tool with a plurality of channel-like bristle cavities with very small channel diameters represents a large technical challenge. The smaller the cavity diameter, the more complex is the manufacture as well as the operation of such an injection moulding tool.

Thus for example the rejection rate on manufacturing injection moulding tools increases considerably since faulty bristle cavities lead to unsatisfactory injection moulding results.

Moreover, the rejection rate of injected bristle fields also increases on operation of the injection moulding tool.

The plastic deformation which is described above and which can be achieved by a targeted undercut or cross-sectional narrowing now permits for example the application of channel-like bristle cavities of a larger diameter and reduced length. The manufacturing effort of the injection moulding tool as well as the operating expense can be reduced by way of this.

The mentioned plastic deformation also permits the manufacture of care bristles with bristle diameters and bristle lengths which are no longer economically manufacturable with conventional injection moulding tools.

Herein, the demoulding procedure is usefully controlled such that the care bristle on demoulding is only solidified to the extent that this on the one hand still permits a plastic deformation by way of the acting demoulding forces and on the other hand has a shape retention which ensures that the care bristle retains its final shape subsequent to the demoulding procedure given the cessation of demoulding forces.

According to a further development, undercuts can also be applied in the bristle cavity or on the care bristle for fashioning the bristle end section. Thus one can envisage the bristle end section of a care bristle being plastically deformed on demoulding, in particular pulled into length, by way of at least one aforementioned undercut.

By way of this, a bristle end section can for example be pointed, i.e. brought into a conical shape, during the demoulding.

A large design freedom on fashioning the bristle end sections is opened up due to the injection moulding of the care bristles, in contrast to the conventional care bristles.

What is meant by bristle end section is the free end section of the care bristle which terminates at the bristle end. The bristle end section extends over less than half, in particular less than a third and very particularly less than a quarter of the total length of the care bristle. The bristle end section can also extend over less than a sixth of the total length of the care bristle.

The bristle end section is of particular significance on cleaning the teeth.

The particular design of the bristle end section of the care bristle can therefore serve for fulfilling certain functional requirements, e.g. in connection with the cleaning procedure, in particular the cleaning of teeth or teeth interstices.

The bristle end section for example can be designed in a rounded manner and have a rounded bristle end.

The bristle end section can therefore be cap-like. In particular, the rounding can be essentially hemispherical or calotte-shaped or ellipsoidal.

However, the rounded bristle end section can also be conical towards the bristle end and form a rounded bristle end. The bristle end can thus for example be projectile-shaped. Should the care bristle not have a circular cross section, then a bristle end section which results essentially from the intersection between a bristle cross section and a hemisphere, calotte or ellipsoid lends itself.

Alternatively, the bristle end section can also be pointed, in particular into a drawn out, more conical tip and end in a pointed (sharp) bristle end. Such a bristle end section can likewise be conical or projectile-shaped. The pointing can also be asymmetrical.

According to a further embodiment, the bristle end of the bristle end sections is designed in a flattened manner. This means that the bristle end forms a flat face side. The transition into the flattening can be rounded.

The surface of the face side can be perpendicular to the bristle longitudinal axis or inclined with respect to this. This means that the surface encloses an angle of smaller or equal to 90° to the bristle longitudinal axis.

It is also possible to change the geometry of the bristle section in a post-treatment step. This post-treatment step can include a mechanical machining (e.g. rounding, cutting, grinding etc.) and/or a heating (thermal deforming) and/or a subsequent plastic deforming of the bristle end section.

Thus according to a further embodiment, the end section can have a spherical or mushroom-shaped widening towards the bristle end, before the end section ends in a flattening or in a rounded face surface in the bristle end.

The mushroom-shaped widening which in particular thus forms a bristle head can be achieved by way of an upsetting of the heated bristle end section. For this, a post-heating can be provided subsequently to the demoulding.

A plastic deformation of the still warm bristle end section, in particular an upsetting, carried out directly after or during the demoulding, is however likewise possible.

According to a further embodiment, the bristle end section comprises a plurality of bristle ends which in particular form a bristle tuft or bristle bundle. The bristles ends of the care bristle merge into a bristle stem towards the head part. In particular, the bristles ends and the bristle stem are integrally injected.

Accordingly to a further development, the surface of the bristle end section is structured by at least one, in particular by a plurality of deepenings.

The deepening or deepenings can be a structured surface with indentations, countersunk holes, slots, grooves or an unstructured rough surface etc..

According to an embodiment, a deepening is formed in the face end surface of the bristle end. In particular, the deepening is arranged centrally in the bristle end. The deepening can be crater-like. In particular, the deepening is delimited by a closed peripheral bristle edge. The mentioned face end surface of the bristle end section can be designed in a rounded or flattened manner as described above.

According to a further embodiment, the bristle end section or the face end surface of the bristle end comprises a fluting. The fluting comprises elongate deepenings and prominences which are arranged in an alternating manner. In particular, the fluting runs perpendicularly to the longitudinal axis of the care bristle. The fluting can form a wave-like cross-sectional structure.

According to a further embodiment, a plurality of flutes which lead radially away from the bristle end is arranged around the complete periphery of the bristle end section. The flutes accordingly run to one another in a star-like manner towards the bristle end in the bristle end section. The bristle end section can be rounded as described above. The grooves preferably have a symmetry.

According to a further embodiment, a plurality of pimple-like dimples is arranged over the complete periphery of the bristle end section. The dimples can be arranged in a geometric pattern. The bristle end section can be rounded as described above.

However, as already mentioned, it is also possible for the bristle ends or the bristle end sections to obtain their final shape by way of post-machining steps subsequently to the demoulding. The bristle ends can hence form a plane face surface which is brought into another shape by way of material removal in a post-machining step.

The post-machining step can be a mechanical machining (processing) of the bristle end or of the bristle end section. Such a post-machining step can include a mechanical rounding or pointing of the bristle end of the injected care bristle. The rounding of the bristle ends can be effected in the same manner as is already known with conventional care bristles.

Accordingly, the technical possibilities such as e.g. the mechanical displacement of individual care bristles can also be used for the post-machining step. Moreover, the rounding procedure can happen in several steps as with conventional, anchor-stamped care bristles.

If the bristle end or the bristle end section is shaped in a post-machining step, then this permits a comparatively simple design of the injected bristle ends. The injection moulding tool or the associated tool inserts can also be designed more simply by way of this.

The post-machining (post-processing) of the bristle ends or of the bristle end sections of the injected care bristles in particular lends itself in those variants, concerning which the injected care bristles are combined with conventional, extruded care bristles which in the case of anchor stamping as a rule demand such a post-machining step.

According to a further development, several care bristles can be grouped together into a bristle bundle which is characterised in that the care bristles run into bristle stem towards the bristle base.

The care bristles are arranged on the head part or the bristle carrier via the bristle stem. The care bristles, bristle stem and head part or bristle carrier can be integrally injected.

The length of the bristle stem can comprise up to half the total length of the care bristle which includes the bristle stem.

The total length of the care bristle in particular corresponds to the conventional bristle length of body care bristles. This particularly also relates to the other embodiments of care bristles which are disclosed in this application text.

The variation of the bristle lengths in a bristle field with injected care bristles can be more pronounced and multifaceted than with conventional toothbrushes. The length differences can be applied in a more varied manner, in particular due to the injection moulding of the care bristles. In particular, directly adjacent care bristles can have large length differences.

The bristle stem can have a length of 0.5 mm to 8 mm, in particular of 3 mm to 6 mm. The length of the bristle stem of the care bristles within the body care brush can be the same or variable. The height of the bristle stem also influences the stiffness of the care bristles.

According to a further development, the bristle stem or also the complete bristle bundle or bristle segment can be arranged on the head part or on the bristle carrier via a pedestal. In this case, the pedestal can have a length of 0.2 mm to 1.5 mm.

Basically, the pedestal is to be understood as a very short bristle stem.

In particular, the pedestal is integrally injected as one part with the bristle stem, care bristles and head part or bristle carrier.

A high creative freedom results with regard to the design of the head part due to the injection moulding of the care bristles. This is due to the fact that no special regions for anchoring the conventional care bristles and for the corresponding anchoring methods (stamping, AFT, etc.) need to be formed in the region of the head part.

The high design freedom in particular also relates to the thickness or height of the head part. The head part can therefore be designed comparatively thinly or very thinly i.e. be of a low height or very low height, in comparison to conventional body care brushes. The head part in particular consists of a hard component, in order, despite this, to obtain the necessary stiffness.

The lower limits with regard to the height of the head part are not limited by the anchoring method of the conventional care bristles, but by the injection moulding method of the head part.

The head part can e.g. have a height of 2 mm to 5 mm, in particular 2.5 mm to 3.5 mm. The head part can reach heights below 1 mm, in particular between 0.5 mm-1 mm, in very thin zones (e.g. for material weakening).

The layer thickness of the bristle material to the total height of the head part is e.g. between 1.0 mm to 3.0 mm, in particular 1.2 mm to 2.0 mm.

The thickness or the height of the head part can reduce from the neck part towards the free end of the head part. Furthermore, it is also possible to vary the thickness over the length, so that the flexible or more flexible locations arise at the thin locations.

Moreover, it is also possible to additionally provide the head part with stiffening structures, such as stiffening ribs. Stiffening structures can be provided in the longitudinal direction, in the transverse direction or in a combination thereof. Stiffening structures can also improve the connection between the hard component of the head part and the bristle component which as a rule do not assume a material fit. A positive fit then arises between the hard component of the head part (if present) and the bristle component.

The large scope of design freedom moreover also relates to the rear side of the head part.

Thus for example it is possible to fashion the rear side and possibly also the lateral periphery of the head part with a soft component over part of the surface or over the complete surface. This is due to the fact that no demands concerning support locations for the further processing or machining are present in the case of completely injection moulded brushes.

It is possible for elements of a hard component which project through the bristle component and which are subsequently covered with a soft component to be created for the fixation of the soft component to the head part.

The hard component of the head part and the soft component connect by way of a material fit and by way of this it is ensured that the soft component sticks to the brush head by way of the material fit. However, the soft component can also connect to the hard component of the head part and to the bristle component.

The rear side and/or the lateral periphery of the head part can be designed in a flat or unstructured manner as is known. A structured rear side and/or the lateral periphery, e.g. with a roughness patter or with an organised topography, e.g. with pimples, flutes or the other protruding structures, is likewise possible. The surface structure can be effected with a bristle component, a hard component or soft component or further components. The surface structure can be effected by a single component or by way of a combination of two, three or more components. In particular, the surface structure can be formed with a soft component and a hard component or with a bristle component, a soft component or a hard component

Thus one or more oral hygiene members such as tongue cleaners can be provided on the rear side over part of the surface or over the whole surface, as already mentioned further above. The oral hygiene member or oral hygiene members arc characterised by specific material characteristics and/or a structuring.

The high design freedom also relates to the front side of the head part.

The same material combinations as on the head rear side can therefore be used on the head front side.

The front side of the head part can likewise be designed in a flat manner as is known. However, a structured front side, e.g. with a roughness pattern or with a topography is likewise possible. The front side can therefore comprise prominences and deepenings. The prominences for example can be hemispherical. A wave-like topography on the front side is likewise possible. Continuous or non-continuous topographies are therefore possible. Non-continuous topographies are characterised by jumps such as steps.

The front side can form surface sections which are offset in height relative to one another. Thus for example an inner-lying surface section can be raised or deepened with respect to surrounding surface sections.

The front side of the head part can also form surfaces sections which are inclined differently to one another.

According to a further development, a movable element or part is arranged on the head part. The moving part can be injected on or be attached onto the head part by way of assembly.

If the movable part is injected on, then the components of the movable part and of the head part in particular do not connect by way of a material fit. This happens e.g. because of the different shrinkage behaviour of the components or because of specifically matched components which do not connect by way of a material fit. Joint connections or sliding guides can be formed in this manner. In particular, the connection can be a positive connection.

Thus e.g. according to a further development, a positive connection can be achieved between a first and a second component, by way of a second component, i.e. the component of the movable part, being injected through a cavity of the first component and thereby forming at least one undercut.

The moving parts can e.g. execute rotatory or translatory movements with respect to the head part. Combinations of rotatory and translatory movements are also possible.

The care bristles in particular are injected on the movable parts. The movable part can be manufactured exclusively or at least partly of the bristle component.

The movable part can form a bristle segment. The movable part can also form several bristle segments.

If the movable part is assembled on the head part as a separate component, then the movable part in particular forms a holder for fastening to the head part. The holder and the care bristles in particular are integrally injected with the movable part.

The movable part can e.g. be plate-shaped and be fastened to the head part in a flexible, complaint manner via a suitable holder.

According to a further development, sensor means for detecting certain parameters are provided in the head part. The sensor means can e.g. be:
odour sensor for detecting oral odour;
pressure sensor for detecting a pressing pressure.

The sensor means can be inserted into the cavity of the injection moulding tool as inserts and be peripherally injected by the plastic components. If all care bristles are likewise injected, then the mechanical loads which are applied onto the head part by way of the anchoring procedure with conventional methods (stamping, AFT, etc) and which would render the accommodation of sensor means in the head part impossible, do not arise.

At least one, in particular several channels which are filled with the bristle component can lead through the head part which consists of a first hard component. The channels end in the care bristles. They correspond to the feed runners (feed channels) or distribution channels (distribution runners) in the injection moulding tool, via which channels the bristle components are led into the bristle channels.

The channels can be designed in a light-conductive manner, so that light can be led from the mains body via the channels into the care bristles. A light source can therefore be arranged e.g. in the main body, in particular in the head part or grip part. The light source therefore illuminates the bristle field or individual care bristles.

The light source can be peripherally injected as an inlay part in the injection moulding method on manufacturing the body care brush or be assembled after the injection moulding procedure. The bristle component is light-conductive for this. The bristle compensate is usefully transparent. The bristle component can be selected such that this acts as a fibre-optic by way of reflection and leads the light in the channel or in the care bristle. Coatings can be supplementarily or assistingly provided in the body part, the grip body and/or the care bristles and these coatings form a boundary surface, at which the light is reflected.

The light reflection can also be achieved by way of a suitable surface design at the boundary surface.

According to a further development of the body care brush, in particular of the toothbrush, the main body can moreover form a grip part which connects onto the neck part. Herein, the neck part is arranged between the head part and the grip part. The neck part is characterised by a section of the main body which is tapered with respect to the head part and the grip part.

The grip part serves for holding the body care brush, in particular toothbrush, during the body care, in particular tooth cleaning.

The body care brush can be a disposable brush such as a disposable toothbrush, or a reusable brush such as a reusable toothbrush.

Such disposable toothbrushes are marketed for example under the trade name “Wisp” by the company Colgate.

The body care brush can be a brush from the field of cosmetics or oral hygiene.

A body care brush from the field of cosmetics can be an applicator for cosmetic products, for example mascara or a hair dye or nail varnish brush.

The body care brush can moreover be a facial brush, a hairbrush or a wet-shaving brush with injected care bristles and possibly massage pimples.

The body care brush, in particular as a disposable brush, can be designed as a finger brush. This is stuck onto the finger via a fingerstall, e.g. of rubber.

The body care brush, in particular as a disposable brush, can moreover be an interdental cleaner with injected care bristles.

The body care brush, in particular as a disposable brush, can moreover be a tongue cleaner with injected care bristles.

Basically, brushes with injected care bristles according to the present invention can also be applied as household brushes, such as washing-up brushes, floor wipers, dustpan brushes, scrubbers, painting brushes, toilet brushes, bottle cleaners, nail brushes etc.

Brushes with injected care bristles according to the present invention can also be used for application of fluids in the field of medical products.

As already mentioned, the body care brush in particular is a toothbrush

If the toothbrush comprises a grip part, then this e.g. can be a hand toothbrush with or without a motorically driven bristle movement.

According to a further development of the body care brush, in particular toothbrush, the body care brush can also be designed as an assembly part, in particular as an exchange part, for assembly on a grip body.

The assembly part in particular is a stick-on part for sticking onto a grip body.

The main body for this in particular comprises a neck part, via which the body care brush can be assembled on the grip body. Such a body care brush can be e.g. an electrical toothbrush, concerning which the bristle movement is motorically driven.

The electrical toothbrush can effect oscillating, pivoting or translatory movements of the bristle field. The electrical toothbrush can be a vibration toothbrush or sonic toothbrush. Electrical toothbrushes with combined movements are likewise possible.

If the injected care bristles are less hardy than the conventional, extruded bristles, then the injected bristles can only be subjected to limited movements or speeds, in order to optimise the service life. Whereas common electric toothbrushes can oscillate significantly above 300 Hz, a speed of below 300 Hz, preferably below 250 Hz, particular preferably below 200 Hz can be applied for injected care bristles.

Electronics components of the electric toothbrush can be peripherally injected with a plastic component.

The electrical toothbrushes which oscillate or rotate to and fro are characterised as follows. The bristle carrier with the injected care bristles is connected to a carrier part or coupling part in manner rotatable to and fro about a rotation axis D, said carrier part and coupling part being able to be stuck onto the hand device. A suitable drive is present in the hand device.

On operation, a preferred maximum rotation angle a is achieved. The injected care bristles are arranged on the bristle carrier in a manner such that the following applies to the maximal distance rₘₐₓ of their exit points on the bristle carrier to the rotation axis D: rₘₐₓ=dₘₐₓ*180°:(πα), wherein dₘₐₓ is the initially mentioned maximum path. Approximated (distance of the reversal points instead of the length of the arc), then rₘₐₓ=dₘₐₓ:(2 sin(α/2)) is the case. Preferably dₘₐₓ=3 mm.

At present, devices with rotation angles of up to 70° are on the market. The diameter of the brush head as a rule is less than 20 mm. The movements of the tips of the injected care bristles increases with the radius or the distance to the rotation axis. The following table specifies a few values for the path which was computed in dependence on the rotation angle and the radius. The stored path specifications belong to value pairs radius/rotation angle (dₘₐₓ=distance of the reversal points) which are permissible according to the invention for dₘₐₓ=3.

| Radius | α = | | | | | | |
|---|---|---|---|---|---|---|---|
| (mm) | 10° | α = 20° | α = 30° | α = 40° | α = 50° | α = 60° | α = 70° |
| 1 | 0.2 | 0.3 | 0.5 | 0.7 | 0.8 | 1.0 | 1.1 |
| 2 | 0.3 | 0.7 | 1.0 | 1.4 | 1.7 | 2.0 | 2.3 |
| 3 | 0.5 | 1.0 | 1.6 | 2.1 | 2.5 | 3.0 | 3.4 |
| 4 | 0.7 | 1.4 | 2.1 | 2.7 | 3.4 | 4.0 | 4.6 |
| 5 | 0.9 | 1.7 | 2.6 | 3.4 | 4.2 | 5.0 | 5.7 |
| 6 | 1.0 | 2.1 | 3.1 | 4.1 | 5.1 | 6.0 | 6.9 |
| 7 | 1.2 | 2.4 | 3.6 | 4.8 | 5.9 | 7.0 | 8.0 |
| 8 | 1.4 | 2.8 | 4.1 | 5.5 | 6.8 | 8.0 | 9.2 |
| 9 | 1.6 | 3.1 | 4.7 | 6.2 | 7.6 | 9.0 | 10.3 |
| 10 | 1.7 | 3.5 | 5.2 | 6.8 | 8.5 | 10.0 | 11.5 |

The table shows that with smaller rotation angles, basically the complete brush head can be occupied with injected care bristles and that with greater rotation angles only a central segment should be occupied by injected care bristles.

Pivoting toothbrushes are characterised as follows. On operation, the brush head is pivoted about its longitudinal axis L, so that the brush head executes a rocking sideward movement. The brush head thereby sweeps an angle of β. For the maximal distance lₘₐₓ of the tips of the injected care bristles to the pivot axis L, lₘₐₓ=dₘₐₓ*'180:(πβ) or lₘₐₓ=dₘₐₓ:(2 sin(β/2)) (distance of the reversal points), wherein dₘₐₓ is the initially mentioned maximal path. Preferably, dₘₐₓ=3 mm.

With this movement, the maximally covered path of the tips should likewise be smaller than 3 mm. The rotation angle can therefore be determined from the following table in dependence on the distance of the tips of the care bristles to the pivot axis. The stored path details relate to the value pairs distance/pivot angle which are permissible according to the invention for dₘₐₓ=3 mm. Given an average distance of 12 mm, the rotation angle of the brush head should not be selected larger than 15°.

| distance (mm) | β = 10° | β = 15° | β = 20° | β = 25° | β = 30° | β = 35° |
|---|---|---|---|---|---|---|
| 9 | 1.6 | 2.3 | 3.1 | 3.9 | 4.7 | 5.4 |
| 10 | 1.7 | 2.6 | 3.5 | 4.3 | 5.2 | 6.0 |
| 11 | 1.9 | 2.9 | 3.8 | 4.8 | 5.7 | 6.6 |
| 12 | 2.1 | 3.1 | 4.2 | 5.2 | 6.2 | 7.2 |
| 13 | 2.3 | 3.4 | 4.5 | 5.6 | 6.7 | 7.8 |
| 14 | 2.4 | 3.7 | 4.9 | 6.1 | 7.2 | 8.4 |
| 15 | 2.6 | 3.9 | 5.2 | 6.5 | 7.8 | 9.0 |

One can envisage the exchange part consisting of the bristle component. The associated interface can be formed from the bristle component.

Furthermore, touch pens for touchscreens can be manufactured as mentioned. The pens are constructed in a paintbrush-like manner and permit the operation of the touch screen with them instead of with the fingers. The grip in turn comprises a main body, and the bristles are the function element. The bristles are arranged in the longitudinal direction of the pin. The bristles are manufactured as the care bristles.

Alternative products without a grip part, but with bristles which are manufactured just as the care bristles can for example be golf tees. A tee is used in the sport of golf and is an element which is stuck into the lawn, in order to place the golf ball thereon for teeing off. Certain products herein have no continuous surface for the support of the golf ball, but have bristles which are directed in the longitudinal direction of the golf tee which permit the support of the ball. These are fastened to an element which is stuck in the ground. This again is similar to the grip part.

One can envisage the grip body being of a hard component which differs from the bristle component. The associated interface can be formed in the hard component.

One can moreover envisage the exchange part being designed such that a carrier body comprises the interface structure and this body is formed from a hard component. The bristle component is accordingly injected onto the carrier body. In this manner, the complete interface structure on both parts can be formed from a hard component, as is already common nowadays with exchangeable toothbrushes.

One can envisage the main body comprising at least one predetermined breakage location. This permits the user to shorten the body care brush to a desired length.

Thus for example one or more predetermined breakage locations which permit the shortening of the grip part can be provided in the grip part.

Thus for example one or more predetermined breakage locations which permit the shortening of the head part can be provided in the head part.

The care bristles can consist of a single component. The care bristles can be coloured. The care bristles can be transparent.

The care bristles can also consist of two different components.

What is meant by different or varying components in particular are different plastic materials or plastic substances, plastic Shore hardnesses or also different colours.

The care bristles can consist of more than two different components.

Thus the cross section of the care bristle can consist of two different components. The cross section of the care bristle can also consist of more than two different components.

The care bristle can comprise for example a bristle core of a first component and a bristle jacket of a second component.

Alternatively or additionally, one can also envisage the care bristle comprising two different components in the longitudinal direction. The care bristle can also comprise more than two different components in the longitudinal direction.

The bristle end section can consist for example of a different component than the remaining bristle section.

Generally, different components in particular are different plastic materials.

According to a further development, different components can also be components with different colours (including transparent, white and black). The different components can also comprise different plastic materials as well as different colours.

Thus for example in the case of a two-component or multi-component bristle cross section, the bristle jacket can be designed in a transparent and the bristle core in a coloured manner or vice versa.

In the case of a care bristle which is of two or more components in the longitudinal direction, the bristle end section can have a different colour than the remaining bristle section. I.e. one of the two bristle sections can also be designed transparently and the other in a coloured manner.

Concerning the mechanical characteristics, in the case of a two-component or multi-component bristle cross section, the bristle jacket can consist of a hard component and the bristle core of a soft component or vice versa.

In the case of a care bristle which is of two or more components in the longitudinal direction, the bristle end section can consist of a soft component and the remaining bristle section of a hard component or vice versa.

A multi-component care bristle, in particular a two-component care bristle can be manufactured in a so-called co-injection injection moulding method. This method is characterised in that the different components are successively injected in a tool cavity, specifically in a bristle cavity. The injecting can be effected via a common or via different injection points (injection gates). Special components (or material) and/or colour combinations can thus be achieved.

Such a method is described for example in WO-A-2013/020 237 in the context of the manufacture of a main body.

One can moreover envisage the bristle field comprising care bristles of different components. The care bristles can have e.g. different colours. Bristle segments with care bristles of different components can therefore be manufactured in a co-injection method as is described above.

One can also envisage the bristle field comprising bristle segments of different components, wherein the care bristles within a bristle segment in particular consist of the same component or of the same components.

In particular, it is possible to inject the so-called power-tip, i.e. the frontmost bristle segments in the bristle field (at the free end of the brush head) from a different bristle component than the remainder of the bristle field. Herewith, one can succeed in different functions being fulfilled by the care bristles.

According to a further development, what is meant here by the different components are components with different colours (including transparent, white and black). The different components can moreover also comprise different plastic materials, different Shore harnesses as well as different colours.

Care bristles with different colours can be arranged within a bristle segment.

Moreover, bristle segments with different colours can be arranged within a bristle field.

The main body can be of a single component. The main body can also consist of several components.

The main body can be transparent. Thus a foil with a picture or lettering which is peripherally injected with the transparent component can be inserted in the brush head. The foil is back-injected in the injection moulding process for this.

Thus e.g. further function elements such as a thumb rest or generally grip rests or regions which in the grip part fill recesses in the hard component, in order to generate flexible zones of one or more soft components can be provided in the grip part. The further component in particular is a soft component or a bristle component.

The same soft components can be used for the function elements in the grip parts as for the oral hygiene member in the brush head. Oral hygiene members and function elements can be injected through the same injection point in the same working operation. Oral hygiene members and function elements can form a continuous material region. These are then preferably connected via a material connection channel. Oral hygiene members and function elements can be injected through the same injection point in each case in a separate working operation (cascade). The soft component preferably assumes a material fit with the hard component.

The same bristle components can be used for the function elements in the grip parts as for the care bristles in the brush head. The care bristles and function elements can be injected from the same injection point in the same working operation. The care bristles and the function elements can form a continuous material region. Preferably, these are then connected via a material connection channel. The care bristles and function elements can be injected through the same injection point in each case in a separate working operation (cascade). The bristle component can then assume a material fit with the hard component. Should the bristle component not assume a material fit with the hard component, then geometry elements (e.g. openings, recesses, undercuts, wrapping geometries etc.) are provided in the hard component and these permit a positive fit between the bristle component and the hard component.

A further function of such a function element can be the reproduction of information. Thus an inscription with letters, numbers, symbols and/or characters can be carried out by way of different components in the main body and in particular in the grip part. The main body or the grip part can thus comprise recesses which reproduce the inscription picture. One or more components are then injected into the recesses and these fill out the cavity of the recess and thus render the inscription readable. The components can have different colours for this.

The care bristles with the associated bristle carrier can consist of a different component than the main body, in particular than its head part. The two components cannot connect to one another, for example on injection moulding. In this case, the connection between the bristle carrier and the main body in particular is mechanical as described above, e.g. via a positive and/or non-positive connection. The mechanical connection can already be created during the injection moulding within the framework of a multi-component injection moulding method. Thus for example a second component, e.g. for manufacturing the bristle carrier with care bristles can be injected into an undercut of a component, e.g. a head part, of a first component.

As already mentioned further above, the shrinkage behaviour of the components can also be utilised for creating the mechanical connection.

Moreover, a component can be injected as a coating onto the non-connecting components. This component for example connects to the carrier component and thus creates the securing of the non-connecting components.

It is also possible for the main body, in particular its head part, and the care bristles with the bristle carrier, consist of or at least comprise the same components.

In this context, the stiffness of the main body or of the head part under certain circumstances must be achieved by way of a suitable geometric design of the main body or head part. This for example can be stiffening structures in the head part as already mentioned.

According to a further development, the body care brush comprises three (plastic) components or consists of these. The main body is formed with a first component. This component can e.g. be a hard component, in particular a polypropylene (PP). The care bristles are formed from a second component which is the bristle component. The main body further comprises function elements such as a grip rest, of a third component, e.g. in the grip part and/or head part. The third component is e.g. a soft component, in particular a thermoplastic elastomer (TPE).

One can moreover envisage the grip part, the grip part and the neck part or the complete main body with the head part at least partly consisting of a material other than plastic. This material can be: wood, stone, (natural stone), glass, metal such as spring steel, or ceramic.

The care bristles can then be injected onto these materials, in particular via a carrier body of the bristle component, wherein again connecting technologies must be used since the materials in particular do not connect.

The hard component which is mentioned in this description and from which e.g. the main body can be manufactured, in particular is a thermoplastic plastic. The hard component can be for example one of the following thermoplastic plastics:
styrene polymerisates, such a styrene acrylonitrile (SAN), polystyrene (PS), acrylonitrile butadiene styrene (ABS), styrene methyl methacrylate (SMMA) or styrene butadiene (S B);
polyolefins, such as polypropylene (P) or polyethylene (PE) for example also in the forms of high density polyethylene (HDPE) or low density polyethylene (LDPE)
polyesters, such as polyethylene terephthalate (PET) in the form of acid-modified polyethylene terephthalate (PETA) or glycol-modified polyethylene terephthalate (PETG), polybutylene terephthalate (PBT), acid-modified polycyclohexylene dimethylene terephthalate (PCT-A) or glycol-modified polycyclohexylene dimethylene terephthalate (PCT-G);
cellulose derivatives such as cellulose acetate (CA), cellulose acetobutyrate (CAB), cellulose propionate (CP), cellulose acetate phthalate (CAP) or cellulose butyrate (CB);
polyamides (PA) such a PA 6.6, PA 6.10 or PA 6.12;
polymethyl methacrylate (PMMA);
polycarbonate (PC);
polyoxymethylene (POM);
polyvinyl chloride (PVC) or a
polyurethane (PUR).

The soft component which is mentioned in this description, from which e.g. soft-elastic oral hygiene members, such as massage elements can be manufactured, in particular is a thermoplastic elastomer (TPE). The soft component for example can be one of the following plastics:
thermoplastic polyurethane elastomers (TPE-U);
thermoplastic styrene elastomers (TPE-S), such as for example a styrene ethylene butylene styrene copolmer (SEBS) or styrene butadiene styrene copolymer (SBS):
thermoplastic polyamide elastomers (TPE-A);
thermoplastic polyolefin elastomers (TPE-O)
thermoplastic polyester elastomers (TPE-E).

The thermoplasts polyethylene (PE) and polyurethane (PU) as mentioned can thus be applied as a hard component as well as a soft component, in a suitable modification.

Polypropylene is particularly suitable as a hard component. Mostly suitable is a polypropylene with a modulus of elasticity of 1000-2400 N/mm², preferably 1300-1800 N/mm².

A TPE-S is particularly suitable as a soft component. The Shore A hardness of the soft component in particular can lie below 90 Shore A, preferably below 50 Shore A, particularly preferably below 30 Shore A.

The soft components can form a material fit with the hard component by way of over-injecting in the two-component or multi-component injection moulding method.

Thus e.g. rubber-elastic oral hygiene members can be of a soft component.

Conventional, in particular extruded care bristles (e.g. pointed or cylindrical) which are attached to the head part via a standard anchoring process (stamping, AFT, etc.), in particular are manufactured from polyamide (PA) or polyester (PBT).

So-called bio-plastics, i.e. plastics which are manufactured from renewable raw materials can likewise be applied.

The demands which are placed upon a plastic material for injection moulding the care bristles are very high. The plastic material should be as pure as possible in order to avoid a blocking of the comparatively fine bristle cavities in the injection moulding tool. This means that the raw material should have few as possible contaminations. Problems in the injection moulding tool, such as e.g. blockages can otherwise occur.

A plastic material for care bristles (bristle component) can be a modified thermoplastic polyurethane elastomer (TPU). This material is characterised by good flow characteristics. This means that the material has a high melt flow index (MFI). The MFI for example lies at 50-100.

Herein, it is an object to be able to realise for example several different Shore hardnesses from the same material with the same MFI.

Furthermore, the material is characterised by its very rapid solidification. This means that the molecule chains already connect at high temperatures, which effects a rapid crystallisation. The associated granulate can be manufactured for example in a reaction method.

A suitable TPU is marketed for example under the trademark name Elastollan® of the company BASF. This TPU can be injection moulded at a pressure for example of up to 1200 bar.

A further suitable TPU is marketed for example under the trademark name Desmopan® by the company BAYER. This TPU can be injection moulded at a pressure for example of up to 1000 bar.

A further suitable material for the injected care bristles (bristle component) is a polyamide elastomer. Such a material is marketed under the trade name Grilflex ELG 5930 by the company Ems-Chemie AG.

A further suitable material for injected care bristles (bristle component) is a polyester elastomer. Such a material is marketed for example under the trade name Riteflex 672 RF Nat or Riteflex RKX 193 RF Nat of the company Ticona polymers or under the trade name Hytrel 7248 of the company DuPont.

The plastic material, from which the bristle component consist, is heated for example to an injection moulding temperature (processing temperature) of 200° C. to 240° C. (Celsius). This is the temperature which the plastic material has in the injection moulding cylinder and in the hot runner.

The injection moulding tool in particular is temperature-regulated to a lower temperature of e.g. 50° C. to 80 ° C. A shock-like solidification of the injected plastic component is avoided by way of this, and this of utmost significance for the mould removal which is to say demoulding.

The processing pressure (injection pressure) lies of example at 800 to 1400 bar in the case of a single-cavity tool. With multiple-cavity tools, the processing pressure is higher depending on the multiple. The processing pressure can thus lie at 1600 to 1700 bar given an 8-cavity tool.

One succeeds in the filling of the cavities with multiple-cavity tools being effected as equally quickly as with a single-cavity tool by way of the higher processing pressure. Herewith, it is ensured that the same material characteristics are achieved over all cavities with multiple-cavity tools as with a single-cavity tool.

The plastic component for care bristles (bristle component) has a Shore hardness of for example 20-80 Shore D, in particular of 40-70 Shore D. A preferred range lies at 50-60 Shore D.

Extensive tests with probands have found that toothbrushes with injected care bristles of bristle material with Shore harnesses D 40-70 cover the ISO harnesses “hard”, “medium” and “soft” of common toothbrushes with conventional, extruded care bristles quite well.

A soft component can also be applied as a bristle component. This above all serves for applicators for cosmetic products, but can also be used for other sensitive applications.

The plastic material (bristle component) can be coloured, as already explained further above. It can also be transparent. Thus for example the starting material can already be present in the respective colour. However, it is also possible for the colour not to be admixed until on preparation of the material for the injection moulding process.

If the starting material is already in the necessary colour, then an improved mixing or a more homogeneous mass is achieved on injecting. The homogeneity also entails a more stable process with reduced problems.

The plastic material for the injected care bristles (bristle component) can contain an abrasively acting additive such as chalk or diamond dust. The additive is to improve the care effect, in particular the cleaning effect of the body care brush.

Further substances which improve/change the care effect and which can be added to the plastic material are carbons (active carbon/charcoal) or also bamboo.

The plastic material for the injected care bristles (bristle component) can comprise an anti-grip or anti-static addition, such as antistatics, Teflon or silicon. This additive is to improve the demoulding in the injection moulding tool. Moreover, this additive should also act against the adherence of toothpaste or dust or dirt particles to the care bristles or to the bristle carrier. A special, dirt-repellent surface structure can also be created at the bristle material (e.g. lotus blossom effect) for the same intention.

The plastic material (bristle component) can moreover comprise an active substance. The care bristle which consists of the plastic material, here forms the carrier material for the active sub stance.

The active substance can serve for extending the durability of the toothbrush on use. The active substance can serve for assisting the dental care. For this, the active substance is released in particular on cleaning the teeth.

For example, the active substance can have anti-bacterial characteristics. These characteristics can counteract a bacterial contamination of the body care brush, in particular toothbrush and thus extend its service life or durability.

The antibacterial characteristics of the active substance can moreover assist the care of the teeth or oral cavity, particularly when this is released.

The active substance which is contained or incorporated in the bristle component can be soluble for example due to fluid such as water or saliva and thus develop its effect. I.e., the active substance is released, in particular in a controlled manner, on contact with a fluid.

The care bristle can also comprise several phases with different active substances which can be released in a temporal sequence depending on the construction.

Possible active substances are described for example in the published document WO-A-2006/032367. The active substances which are described in this publication document are therefore valid as part of the disclosure concerning the present invention.

Further examples of active substances are also specified further above in connection with oral hygiene members (see listing (a) to (e)).

One can envisage the carrier material, thus the care bristles, being increasingly decomposed due to the delivery (release) of an active substance, e.g. due to the advancing dissolving of the carrier material. I.e., the bristle field is increasingly broken down over the period of use of the toothbrush. The reservoir of active substance is also reduced with the increasing decomposition of the bristle field. The condition of the bristle field therefore serves as an indicator for an exchange of brush to the user.

Thus, the bristle component can be a degradable plastic component.

In particular, the brush head can be constructed in a multi-layered manner. The main body as the lowermost plane can be superimposed in this region with further geometric elements, for example with a further parallel surface which is connected to the main body via film-hinge-like structures. Hereby, the structure can be shaped as a parallelogram which yields given pressure, i.e. by way of the upper layer lowering. The complete cleaning elements can thereby be fastened to the upper layer or they can also be partly fastened on the lower layer.

The appliance for manufacturing body care brushes according to the invention, in particular toothbrushes, comprises an injection moulding tool for manufacturing injected care bristles. The injection moulding tool is characterised by its modular construction.

The present injection moulding method and the associated injection moulding tool are based on the manufacturing method which is described in WO-A-2012/093085, as well as on the injection moulding tool which is disclosed therein. The content of WO-A-2012/093085 with regard to the features of the manufacturing method and the design features of the injection moulding tool is therefore considered as part of this disclosure by way of present reference. A repetition of the common method steps and design features is therefore omitted here.

In particular, details concerning the construction of the injection moulding tool according to FIGS. 46 to 53 and the associated description are herewith valid as part of this disclosure.

The injection moulding tool comprises a carrier cavity which is designed to form a bristle carrier. The carrier cavity can comprise distribution channels, via which the bristle component is fed to the bristle cavities.

According to a further development, the injection moulding tool comprises a carrier plate which forms the carrier cavity. The carrier plate in particular is an insertable tool part.

The injection moulding tool moreover comprises at least one, in particular several tool inserts which are designed to form bristle segments with at least one, in particular several care bristles. This means that a tool insert forms a bristle segment in each case.

The tool insert or inserts each form at least one, in particular several bristle cavities. As mentioned, the bristle cavities in particular are channel-shaped.

Several bristle cavities form a bristle cavity segment. The bristle cavity segment defines a base surface, hereafter called cavity segment base surface. The cavity segment base surface corresponds to the cross-sectional outer contour of bristle cavities at their base which faces the carrier cavity.

The cavity segment base surface corresponds to the segment base surface of the bristle segment which is manufactured therefrom. Accordingly, the same characteristics as have been disclosed in connection with the segment base surface of the bristle segment apply to the geometry of the cavity segment base surface or to the arrangement of the bristle cavities in the bristle cavity segment.

The bristle cavities of the tool inserts are flow-connected to the carrier cavity, i.e. they connect to this, so that a material flow can take place between the carrier cavity and the bristle cavities.

The injection moulding tool for manufacturing a bristle field with several bristle segments consequently comprises a plurality of tool inserts.

According to a further development, the at least one tool insert is designed in a multi-part, in particular two-part manner. The tool insert can comprise a first tool part-insert and a second tool part-insert.

The first tool part-insert is provided with at least one continuous first bristle cavity for forming the bristle base body. In particular, the first bristle cavity is channel-shaped.

The second tool part-insert serves for forming the used-side or free bristle end or bristle end section of the injected care bristle. The second tool part-insert in particular forms a closed second bristle cavity which is only open towards the continuous first bristle cavity of the first tool part-insert. The second bristle cavity can be cap-shaped. The second bristle cavity can be designed in the form of a blind hole.

The second tool part-insert however can also merely form a termination without bristle cavities for the bristle cavities of the first tool part-insert.

The care bristle is consequently injected in the continuous first bristle cavity of the first tool part-insert and the closed second bristle cavity of the second tool part-insert. The two bristle cavities are accordingly aligned to one another and fixed for carrying out the injection moulding procedure. Accordingly, the first and second tool part-insert sealingly bear on one another, on injection moulding the care bristles. The tool part-inserts at their contact surface accordingly form a mould partition plane.

According to a further development of the invention, the bristle cavities of the first tool part-inserts each have the same length.

The second bristle cavities of the second tool part-inserts each have different lengths for varying the bristle length.

This permits multi-shaped bristle lengths, e.g. of 9 mm, 10 mm, and 11 mm.

Since both bristle cavities have a very small diameter, the first and the second tool part-insert must be aligned to one another very precisely. This is achieved for example by way of a tool carrier body which comprises a guide recess for the common receiving of the first and second tool part-insert. This means that the guide recess receives a complete tool insert. The tool inserts can therefore be inserted into the guide recesses of the tool carrier body.

A further possibility for regulating the bristle length lies in the first part-insert being designed shorter and therefore contributing more to the length design.

Different lengths of the first part-insert can be therefore be fashioned in the same tool and with this a distribution of bristle lengths can be achieved.

The total length of the two inserts remains the same and the length of the cavity in the second part-insert likewise, and so it is therefore solely the length of the second part-insert which is thus varied and adapted to the length of the first part-insert. More “empty volume” is therefore created in the second part-insert.

The mutual alignment of the two tool part-inserts is effected via a cross-sectional contour of the tool part-inserts, hereinafter called insert cross section, said contour ensuring a rotationally fixed receiving of the tool part-inserts in the tool carrier body. The guide receivers of the tool carrier body for the tool inserts for this in particular comprise equal but opposite cross-sectional receiving contours. The insert cross section in particular can be a polygonal contour.

It can be necessary for certain contours which ensure an unambiguous orientation of the inserts to be created for the rotation lock.

The tool carrier body amongst other things therefore has the function of a holder which holds the tool inserts. The tool inserts can be fastenable in the injection moulding tool via the tool carrier body.

The modularity of the present injection moulding tool is characterised in that tool inserts with an identical insert cross section have different arrangements of bristle cavities, i.e. different bristle cavity segments. Tool inserts with different bristle cavity segments are now exchangeable amongst one another thanks to the identical insert cross sections. I.e., a base structure/carrier structure is defined.

It is further possible to provide different insert cross sections for one bristle field. A modularity results herewith. This however is fixed within a certain framework. I.e., due to the different insert cross sections, it is no longer the case that all bristle cavity segments of a bristle field are universally exchangeable.

The injection moulding tool according to the invention permits the manufacture of body care brushes with different bristle segments or with different bristle fields by way of a single injection moulding tool and a plurality of different tool inserts with an identical insert cross section but with different bristle cavity segments or cavity segment base surfaces.

The cavity segment base surfaces of the tool inserts are consequently equally large or smaller than their insert cross sections. If the cavity segment base surface is smaller than the insert cross section of the tool insert, then a larger distance is formed between two adjacent bristle segments in the bristle field. The cavity segment base surface and the insert cross section are preferably equally large.

The insert cross sections are recessed in the injection moulding tool and in particular are distanced to one another, so that the tool inserts can be optimally integrated and held.

In a variation, it is also possible to position at least two tool inserts in a manner in which they bear directly on one another. Herein, it is particularly also possible to form an oral hygiene member which engages over two adjacent tool inserts. I.e. the oral hygiene member engages over the contact surfaces of the adjacent tool inserts.

Thus for example a first part of the cavity of the oral hygiene member lies in a first tool insert and a second part of the cavity in a second tool insert. The oral hygiene member can e.g. be a lamella.

The variability in an injection moulding tool with regard to the design of the bristle field can be further increased in this manner.

The modular construction of the injection moulding tool with the tool inserts permits the design of body care brushes with differently formed bristle fields. The bristle fields can differ from one another by way of differently shaped bristle segments and segment arrangements.

Not only can the bristle fields or bristle segments differ from one another by way of different bristle arrangements, but also by way of different bristle geometries which e.g. also include the bristle length and the bristle cross section as well as the design of the bristle end. Moreover, the number of care bristles can also vary. These variations can be implemented in a single injection moulding tool.

The geometry or base surface of the bristle carrier can be identical despite differently designed bristle fields.

If the carrier cavity is formed by a separate carrier plate, then one can envisage carrier plates with different geometries, such as cross-sectional contours also being able to be used in the injection moulding tool in a mutually exchangeable manner in the context of the modular concept. Carrier bodies or head parts with different geometries can be manufactured by way of one injection moulding tool by way of this.

The modular construction of the injection moulding tool with a plurality of individual tool inserts moreover has advantages on manufacturing the tool itself.

The manufacture of the fine bristle channels of the injection moulding tool is a technically extremely challenging procedure. Accordingly, one has to reckon with a high rejection rate on manufacturing the bristle channels. This means that the bristle channels can have deficiencies which are inherent of manufacture and which can render this unsuitable for injecting care bristles. This for example can be undesired undercuts which render impossible a demoulding of the care bristle.

A faulty bristle cavity therefore means that the respective injection moulding tool with a plurality of intact bristle cavities cannot be used. The more bristle cavities such an injection moulding tool now obtains, the greater is the danger of a faulty bristle cavity.

This problem is alleviated by way of the modular construction of the injection moulding tool with a plurality of tool inserts. This is due to the fact that only one individual tool insert and not a complete injection moulding tool is affected given a faulty bristle cavity.

The tool carrier body can moreover serve for the temperature regulation of the tool insert. Thus heat can be fed or dissipated via the tool carrier body.

For this, the tool carrier body is of special steel such as Amco steel. The special steel is characterised by its very good thermal conductivity. This permits a more efficient cooling and by way of this a more rapid solidification of the injection moulded body. The cooling process can also be more precisely controlled on account of shorter reaction times thanks to the good thermal conductivity.

The injection moulding tool can comprise one or more, in particular two cooling circuits, in which a cooling fluid circulates. Thus for example a separate cooling circuit can be provided for cooling the tool insert, i.e. of the care bristles.

Moreover, the cooling circuits can be designed such that each individual cavity can be individually cooled. This means that the cooling temperature can be individually set/adjusted for each cavity, basically independently of the cooling of the other cavities.

One can envisage the surfaces of the tool inserts being polished towards the carrier cavity, so that a smooth surface which counteracts the undesirable sticking of toothpaste residue is formed on the bristle carrier between the care bristles.

On manufacture of the care bristles, the smooth surfaces of the cavities are formed most optimally if the plastic mass solidifies slowly. The temperatures of the tool wall therefore tend to be set somewhat higher.

As already mentioned, the first tool part-insert in particular comprises several first bristle cavities and the second tool part-insert several second bristle cavities. The number of bristle cavities in particular corresponds to the number of injected care bristles of a bristle segment.

The largest diameter of the injected care bristle and accordingly also of the bristle cavity at the end at the bristle cavity side in particular is 0.5 to 1 mm, in particular 0.75 mm to 0.9 mm.

According to a variant, the exposed length of the care bristles begins with their exit out of the bristle carrier. A bristle base, at which the injected care bristles are integrally connected to the bristle carrier, is formed on the bristle carrier

Alternatively, the bristle carrier can also form a bristle stem, so that the bristle base is designed projecting beyond the surface of the bristle carrier. This leads to the exposed length of the injected care bristles only beginning at a distance to the surface of the bristle carrier. This distance can be up to 6 mm. The hardness/elasticity of the injected care bristles can likewise be adjusted in this manner.

If the bristle carrier in an integral part of the head part of a base body, then the bristle carrier is injected in particular together with the main body or its head part.

If the bristle carrier and care bristles are of different components, then the bristle carrier is injected in a first step and the care bristles in a second step.

Function elements, optical elements or oral hygiene members, e.g. of a soft component are possibly yet injected in a third injection moulding cycle or step.

Furthermore, further care bristles can be manufactured in a third step. This is the case if otherwise is not possible for reasons of manufacturing technology, or if the further care bristles are manufactured of a different component than the first care bristles.

If the bristle carrier is a carrier body which is inserted into a head part at a later stage, then the bristle carrier is injected together with the care bristles as a separate product part and is brought together with the head part of the main body in a subsequent working step.

Herein, as specified, it is possible to manufacture the carrier body and the care bristles from one component in one step. Further injection moulding steps with further components are possible. Apart from this, it is also possible to firstly inject the carrier body and to inject the further components such as e.g. bristle components and oral hygiene members or soft components onto the carrier body in subsequent injection moulding steps.

The oral hygiene members, such as massage elements or tongue cleaners, e.g. of a soft component can be injected in separate steps.

If the bristle carrier is a separate carrier body, then differently designed bristle carriers or brush heads can be combined with differently designed main bodies.

Different embodiments of brush heads in particular relate to differently designed bristle fields.

The variability of body care brushes is increased by way of this, without the manufacturing method having to thereby become unbearably complicated. However, this assumes that the carrier body and the main body are compatible with one another.

As already mentioned, one can envisage further care bristles being arranged onto the bristle carrier in the conventional manner (stamping, AFT, etc.) in a further working operation subsequently to the injection moulding process. The attachment can be effected on the head part of the main body which forms the bristle carrier or onto the carrier body, depending on the embodiment type.

The fastening of the convention care bristles can be effected in different manners.

For example, the anchor free tufting (AFT) method can be used. Concerning the AFT method (anchor free tufting), the conventional, cylindrical or pointed care bristles or the bristle bundles are fastened to the carrier body without the help of an anchor. The rounded care bristles are thereby profiled in a bundled manner and are led with their end which lies opposite the free used end through passages in the bristle carrier, so that an end region of the bristle bundles projects beyond the lower side or rear side of the bristle carrier. The care bristles are fastened with this end region of the care bristles which projects beyond the rear side of the carrier body by way of melting, binding or welding to the bristle carrier. The carrier body with the conventional care bristles which are fastened therein is subsequently anchored in the recess of the head part of the body care brush, for example by way of ultrasound welding. The recess in the head part is herein specially adapted to the geometry of the carrier body. Apart from the conventional care bristles, the carrier body or also the head part of the body care brush can comprise soft-elastic massage elements and cleaning elements.

The so-called PTt method can be used for example. Concerning the PTt method, the conventional, cylindrical or pointed care bristles or the bristle bundles are fastened to the carrier body without the help of an anchor. The rounded or pointed care bristles are thereby profiled in bundles and are led with their end which lies opposite the free used end through passages of a holding/pressing device. The bundles are subsequently melted bundlewise, in each case at their end which is finally anchored in the carrier body.

Parallel to this, the bristle carrier is heated at least partly to the glass transition temperature. The melted bristle bundles are then introduced into the blind holes or recesses in the carrier body by way of the holding device/pressing device. The bristle bundles are fixed in the blind holes or recesses by the holding device/pressing device amid the application of pressure.

According to a variant, the conventional care bristles can also be arranged, in particular stamped, onto the bristle carrier before or after the injection moulding of the care bristles.

Concerning conventional stamping, blind holes which serve for receiving the bristle bundles are formed in the carrier body or in the main body. In the method, the conventional care bristles are then stamped into the bristle holes by way of anchor platelets and thus fixed in the body. Herein, the steps of profiling (creating a profile) and of rounding the bristle ends are yet necessary thereafter.

If additional conventional care bristles are provided in the brush head in combination with injected care bristles, then here too, the limitations of the convention bristling technology still apply. Thus for example certain bristle hole depths and distances between the bristle holes must be kept to. The advantages of the injected care bristles are therefore not used or realised in the respective region of the bristle field.

If the bristle carrier and care bristles consist of the same component, then the bristle carrier and care bristles are injected in a common injection moulding cycle or step and, as mentioned, also injected from the same component. Function elements, optical elements or oral hygiene members, e.g. of a soft component, can yet possibly be injected in a subsequent injection moulding cycle or step.

Retaining geometries might possibly have to be created, so that a sufficient connection between the first carrier component and the second bristle component is created. This is the case if the two components are incompatible, i.e. are not connectable to one another or only form an insufficient material fit.

In particular, retaining geometries can comprise undercuts. Retaining geometries can also be designed as wrapping geometries. Parts of the main body can thus be wrapped by the bristle component.

It is moreover also possible to create geometries, concerning which a first component is completely or partly wrapped by a second component and a retention is thus formed.

The retention subject can be dealt with in the same manner in connection with the manufacture of the main body, if several components which are not compatible with one another are injected.

As mentioned further above, the manufacture of an injection moulding tool or of an associated tool insert for manufacturing injected care bristles is very complicated and therefore accordingly costly.

It has now been found that due to the smaller cross sections or geometries, the manufacture of injected care bristles takes up significantly less time than the manufacture of an associated main body with a grip part which has larger cross sections or geometries. The reason on the one hand lies in the longer injection moulding times, since more material must be injected given larger geometries. On the other hand, larger geometries or cross sections require longer cooling times.

Thus for example the cycle time for manufacturing an injected bristle field is about 15 s to 20 s (seconds). In contrast, the manufacture of a main body with a grip part lasting about 40 s has a significantly larger cycle time. Thus on manufacturing in the same injection moulding tool, cavities for a manufacturing cycle with a smaller cycle time are well utilised, which is to say to a high capacity, whereas cavities for a manufacturing cycle with a longer cycle time are poorly utilised.

According to a further aspect of the invention of the present patent applications, it is therefore suggested to manufacture the main body, in particular consisting of a hard component and possibly function elements of a soft component, as well as care bristles with the bristle carrier, by way of injection moulding in separate method steps. The care bristles are therefore manufactured as one piece together with the bristle carrier in a separate injection moulding step.

In particular, the injection moulding steps are independent of one another to the extent that the main body and the care bristles with the bristle carrier can be produced in different cycle times.

The main body is thereby demoulded before the connecting to the bristle carrier and to the care bristles which are arranged on this. The main body can be completely cooled before the care bristles are injected on.

One or more oral hygiene members can already be injected on the head part of the main body before care bristles are injected on in a further injection moulding step.

Several components can be processed in several stations or working steps in a multi-component tool on manufacturing the injected care bristles from the bristle component. On manufacturing the care bristles of the bristle component, apart from the care bristles, oral hygiene members can also be injected on the head part in a further injection moulding step. Here too, a multi-component injection moulding tool can be used.

The oral hygiene members can be injected before the injection moulding of the care bristles or also in separate step after the injection moulding of the care bristles. This can be effected in the same injection moulding tool or in a separate injection moulding tool.

According to a first variant, the main body, after its manufacture, is transferred into a further injection moulding tool or into a further injection moulding tool cavity. In particular, the main body is relocated or inserted into the injection moulding tool and into the injection moulding tool cavity respectively.

The bristle carrier with the care bristles is injection moulded onto the main body, in particular the head part of this, in this injection moulding tool or injection moulding tool cavity. In this step, the bristle carrier with the care bristles is connected to the main body via a material fit and/or positive fit.

The main body does not need to be completely inserted into the further injection moulding tool in this manufacturing step. It is sufficient if e.g. only the head part and possibly also parts of the neck part which is peripherally injected with the bristle carrier are inserted.

The main body and the bristle carrier are demoulded together after this injection moulding step.

The main body and the bristle carrier can be connected via a positive fit and/or material fit connection or a combination thereof.

The main body, in particular its head part, can comprise an interface structure which is integrally injection moulded with the main body. The interface structure can be designed for the peripheral injection of the main body or head part with the bristle carrier. In particular, the interface structure can be designed for the finger-like or strip-like peripheral injection of the head part from the front side towards the rear side by way of the bristle component.

The interface structure can also comprise positive-fit elements for the positive-fit receiving of the bristle carrier. Positive-fit elements can comprise undercuts or openings.

In particular, the interface structure is standardised, so that various combinations of the main body and bristle carrier with care bristles are possible.

Such combination can be e.g.:
different grip parts with the same bristle carriers/bristle fields;
different bristle carriers/bristle fields with the same grip parts.

This opens up a large variety of variants for body care brushes with comparatively low additional effort.

The interface structure can comprise one or more of the following elements:
positioning support locations: In particular, positioning support locations of a hard component are provided in the interface structure. In the end product, these are arranged on the surface. The purpose of the positioning support locations is for these to position the main body or the head part in an exactly defined manner during the injection moulding of the further components. Thus for example one should avoid the head part being pressed onto the cavity wall and finally a hard component which should really be covered becoming visible in the end product.
Positioning blind holes: The positioning blind holes serve for exactly positioning the main body in the cavity.
Openings or alternative wrapping geometries. The mentioned geometries are positive-fit geometries. These are to permit non-connecting component to be held together despite this, i.e. the bristle field remains connected to the main body.
Injection point: The injection point is integrated in the interface structure.

Positioning blind holes are blind holes which can be formed in the interface geometry. These serve for positioning the main body in an exact manner on insertion into the injection moulding cavity

The positioning blind holes can moreover also be of significance as holding or aligning means also on relocating the main body between two injection moulding cavities.

In particular, at least two positioning blind holes are necessary for this. Pins are advanced into the positioning blind holes before and during the closing of the cavity. These pins are retracted again after the closing of the cavity and before or during the injection procedure, since the body is exactly positioned after the closure of the cavity and is held in position by elements of the main body such as neck part or grip part.

Herewith, one succeeds in the positioning blind holes being filled with bristle material and no hole arising in the bristle carpet.

It is also possible to fashion undercuts in the positioning blind holes or the openings, and these lead to an improved retention of the bristle material.

Through-holes or through-openings can be arranged in different manners.

If the head part on its front side and/or rear side comprises recesses, as described further above, then the through-holes can be arranged in a deepening.

At least one through-hole can be arranged in an intermediate section of the deepening.

“In an intermediate section” is to be understood in that plastic material can flow further in the deepening at several sides of the at least one through-hole. The plastic material can flow in the recess transversely to the longitudinal axis of the through-hole.

At least one through-hole can also be arranged at the end of a deepening.

“At the end” is to be understood in that the plastic material flows into a “blind alley” of the deepening which at its end is provided with a through-hole.

The transition from the neck part to the receiving bed in the head part with the care bristles is formed on the front side in particular in a U-shaped manner. The U-shaped design serves for giving the body an improved stability, this being in contrast to a straight-lined shaping.

At least one opening or blind-hole which comprises at least one undercut can also be provided in the head part.

Several openings and/or blind-holes can also be provided, and the longitudinal axis of these run at an angle to one another of more than 0° (angle degrees), in particular more than 5°. A retention is likewise achieved by way of this. This retention is larger, the closer the openings or blind holes lie to one another.

According to a further development of the invention, at least one injection point is arranged on the main body in a manner such that on injecting the plastic into the cavity of the injection moulding tool, the plastic is not injected into the bristle channels or bristle cavities of the injection moulding tool in a direct manner, i.e. in a straight lined.

The fluid plastic can be deflected or diverted at least once between the at least one injecting point and the bristle cavities by way of elements of the cavity.

The fluid plastic can be deflected or diverted at least once between the at least one injecting point and the bristle cavities by way of elements of the main body or of the head part.

The elements for example can be walls of the cavity or of the main body or of the head part.

This means that the plastic material flows into the bristle cavity only after at least one deflection or diversion.

The at least one injection point and accordingly also the associated injection nozzle or distribution channel (i.e. the related opening) can be arranged in the transition from the neck part to the head part.

The at least one injection point can be arranged on the rear side, which is to say on the side of the main body, in particular of the head part or neck part, said side lying opposite the bristle field.

Accordingly, the associated injection nozzle or a feeding distribution channel of the injection moulding tool can be arranged towards the rear side of the main body, in particular of the head part or neck part, which is inserted into the tool cavity.

The main body can comprise a through-hole which guides or leads at least a part of the plastic of the care bristles from the at least one injection point or from the associated injection nozzle or distribution channel, through the main body, onto the front side. At least one deflection or diversion is achieved in this manner.

The through-hole can be arranged in the transition from the neck part to the head part.

The at least one injection point or the associated injection nozzle or distribution channel and the through-hole in particular are aligned to one another or correspond with one another.

The injecting pressure before entry of the bristle component into the bristle cavities can be reduced thanks to the deflection or diversion of the injected bristle component, which has been described above. This leads to an improved flowing and filling behaviour.

According to a further development of the invention, the injection nozzle of the injection moulding tool is designed such that the distance between the injection nozzle and the cavity, i.e. the flow path of the fluid plastic without active heating is between 1 mm and 4 mm, preferably between 1.5 mm and 3 mm. With this, one succeeds in the material components in the injection moulding procedure during the cycle reaching a solidity which is such that the material does not get stuck on the injection nozzle or the needle of the injection nozzle.

The transition location which represents the separation of the tool inserts for manufacturing the head part with the interface with respect to the part-tool, comprising the cavity for the manufacture of the grip part, in particular can be arranged in the neck part. An optimal sealing of the injection moulding tool can be achieved by way of this.

The interface structure can consequently be formed from the head part to into the neck part for reasons of manufacturing technology. As a result, apart from the head part, it also encompasses at least a section of the neck part.

The interface structure of the head part in particular is manufactured from a hard component. A combination with a soft component however is possible, in particular if for example further function elements such as e.g. lamellae of a soft component in the bristle field or a tongue cleaner of a soft component are already to be moulded with the main body. It lends itself to already realise further elements on the main body, in particular if the bristle field is to be manufactured of one component.

According to a second variant, the main body, in particular its head part, after its demoulding, is connected to the already manufactured, i.e. injection moulded bristle carrier with care bristles.

Hereby, the bristle carrier is designed as a carrier body which subsequently to the injection moulding and in a separation connecting step is connected to the main body, in particular its head part.

One or more oral hygiene members can already be injected on the head part of the main body before the carrier body is connected to the main body, in particular its head part.

Concerning the manufacturing step of the injected care bristles of bristle components, several components can be injected on the carrier body in several stations or working steps in a multi-component tool. Concerning the manufacturing step of the care bristles of bristle components, oral hygiene members can also be injected on the carrier body amongst the care bristles in a further step. Here too, a multi-component injection moulding tool would be used.

The main body as well as the bristle carrier with care bristles is demoulded, in particular from the injection moulding tool, before the connecting step.

The main body and the carrier body can be connected to one another via a positive, non-positive or material-fit connection or a combination of several connection types. A positive-fit connection can be a clip connection or snap connection. A material-fit connection can be a weld connection. The weld connection can be manufactured by way of ultrasound.

The brush head is consequently composed of the injected head part and the separately injected bristle carrier with care bristles.

In particular, the components of the main body and the components of the bristle carrier with care bristles are different.

The main body according to the present aspect of the invention in particular comprises a grip part which in particular is connected to the head part via a neck part.

The main body, in particular its head part, can comprise an interface structure which is integrally injection moulded with the main body. The interface structure is designed for connection of the carrier body or bristle carrier to the main body or to its head part. The interface structure in particular comprises retaining geometries as described above.

The interface structure can comprise a receiver or a receiving bed for receiving the carrier body or the bristle carrier.

The interface structure can comprise positive fit elements for the positive receiving of the carrier body or bristle carrier. Positive-fit elements can comprise undercuts or openings.

In particular, the interface structure is standardised, so that different combinations of main body and bristle carriers with care bristles are possible.

Such combinations can be e.g.:
different grip parts with the same bristle carriers/bristle fields;
different bristle carriers/bristle fields with the same grip parts.

This opens up a large variant variety for body care brushes with comparatively little additional effort.

In particular, the interface structure is arranged in the head part, as already mentioned.

The mentioned positive fit elements can be applied to the first as well as to the second variant. According to the first variant, the positive-fit elements serve as a retaining geometry which is peripherally injected with the component of the bristle carrier, and thus form a positive connection.

The bristle carrier can likewise comprise an interface structure which is injection moulded with the bristle carrier as one part.

In particular, the main body and the bristle carrier with the care bristles are manufactured in separate injection moulding tools or injection moulding cavities. In particular, these are operated independently of one another.

The variability which can be implemented in the injection moulding tool in particular is due to the fact that certain regions in the head part of the body care brush need to be specially designed. For example, tool inserts for forming the head parts are designed in an exchangeable manner, so that different shapes of the brush head can be realised.

Different variants can thus be realised:
mould cavities for an injected bristle field according to variant 1 from above
mould cavities for an injected bristle field according to variant 2 from above
mould cavities for an AFT bristle field (can correspond to the preceding variant)
mould cavities for an anchor-stamped bristle field.

In this context, a further aspect of the invention relates to an injection moulding tool for manufacturing a main body for a body care brush. The injection moulding tool comprises a first part-tool with a tool cavity for forming the grip part of the main body and a second part-tool which is designed as a tool insert, for forming the head part of the main body. The tool insert is separable from the first part-tool.

In particular, the tool insert comprises a part-moulding-cavity.

The separation between the two part-tools in particular is arranged in the neck part of the main body to be manufactured.

A further development of this aspect of the invention comprises an injection moulding tool kit with an aforementioned injection moulding tool, comprising several tool inserts for injection moulding the head part.

In particular, the tool inserts have an identical insert cross section but different head part cavities, so that main bodies with an identical grip part but with different head parts can be manufactured in the same injection moulding tool by way of an exchange of tool inserts. In particular, the head part can thus form different interface structures.

The independent manufacture of the bristle carrier with care bristles and of the main body permits the use of a lower number of tool components with corresponding cavities for manufacturing the bristle fields, in comparison to the number of tool components with corresponding cavities for manufacturing the main body. This imbalance concerning the tool capacities is compensated by the different cycle times which are inherent of the manufacture. I.e. although lower tool capacities are present for the manufacture of the bristle fields, one can achieve the same output of bristle fields and main bodies by way of smaller cycle times.

Thus for example a 16-fold main body tool with a cycle time of 40s can have the same output as an 8-fold bristle carrier tool with a cycle time of 20s.

The separation of the two process steps also entails advantages with regard to the stability of the process. The manufacture of the care bristles thus takes place in an individual process framework, in which smaller injection moulding tools are used. This simplifies the handling as well as the maintenance of the injection moulding tools. This is of significance in that the manufacture of the injected care bristles is a significantly more demanding process which is more susceptible to faults than the manufacture of the main body.

The separate manufacture of the bristle field and the main body moreover permits the autonomous optimisation of cycle times of the two manufacturing steps, without these having to be matched to one another

According to a further development, the two process courses however are linked to one another with regard to process technology. Thus a transfer device which brings the main body together with the bristle carrier can be provided. The bringing-together can be the transfer of the main body into a further injection moulding tool, in which the bristle carrier with the care bristles is injection moulded. The bringing-together can also be the bringing-together of the already injection moulded main body and of the already injection-moulded bristle carrier with care bristles for the purpose of creating the connection.

In particular, such a concept is provided if the main body, the bristle carrier with care bristles and consequently the body care brush are manufactured inline. A buffering device which buffers the manufactured main bodies until it is processed further can possibly be provided.

Since the transfer of the main body is automated in inline operation, the inline operation requires a coordination of the material flow between the individual manufacturing steps despite independent cycle times. This can be effected via a superordinate facility control.

However, one can also envisage the two manufacturing steps being operated independently of one another, in particular offline. This means that the manufactured main bodies are not processed immediately into body care brushes. The further manufacturing steps can temporally and spatially lie part in an arbitrary manner. Accordingly, the main bodies however need to be stored. This method is particularly applied if different brush heads are to be combined with the same main bodies.

The associated injection moulding facility can be a single-component, two-component or very generally a multi-component injection moulding facility.

Basically, further function elements or oral hygiene members can be injected in integrated or additional separate injection moulding steps in connection with the method which is described above. Further method steps are likewise possible.

If the body care brush is manufactured in a tool, then the subsequently specified examples of injection moulding facilities with a respective transfer device are particularly suitable.

An injection moulding facility for manufacturing a body care brush can generally comprise several, in particular four stations. The body care brushes are herein transferred, in particular relocated between the individual stations by way of a transfer device. In particular, the body care brushes can be held on the main body such as neck part or grip part for this.

The main body can be injected from a first component at a first station. A further component which for example forms function elements or optical elements on the main body can be injected at a second and third station. Moreover, oral hygiene members can also be injected from the second component. The component can be a soft component.

Furthermore, the care bristles are injected at the second or third station.

In particular, the second station can also be designed as a cooling station. This means that the already arisen body is not processed further in this station, but is actively or passively cooled. Active cooling in this context means for example via a ventilation device or other cooling devices. Passive cooling means that the body is cooled by the surrounding air.

An injection moulding step is again accordingly effected in the third station.

Basically, also several components can be processed in one cycle, i.e. at one station. However, this necessitates the respective associated cavities in the injection moulding tool with the inserted main body being completely separated from one another.

The body care brush is removed from the mould at a fourth station.

The injection moulding facility can comprise a helicopter tool. This is characterised by the individual stations lying in a tool plane. The relocations of the plastic parts or premoulds is effected by way of a relocating robot which form a kind of rotor blades. Cavities are formed on the rotor blades. The premoulds are held in the cavities on the rotor blades and in this manner are moved to the next station on relocating. The rotor blades are rotated about a rotor axis for this.

The injection moulding facility in particular is constructed such that a rotor blade is arranged in each case outside the injection moulding tool and the manufactured parts can therefore be removed parallel to the injection moulding process.

Such an injection moulding facility is described for example in the published document EP 1 088 641.

The injection moulding facility can also comprise a cube tool. The cube tool is characterised in that this comprises four stations which are arranged in several planes. Different method steps are carried out in each station. The planes of the stations are thereby aligned vertically.

The published document DE 101 21 691 for example describes a cube tool with a chain pull. The published documents WO 2007/082394, EP 1 782 936 and WO 2007/085063 each describe a cube tool with a transfer system.

The care bristles complete with the bristle carrier can be manufactured of one component in one step.

As already mentioned further above, the care bristles can also be manufactured of several components, in particular of two components, in several steps or injection moulding cycles.

Thus for example in a first step, the (bristle) carrier cavity cannot be completely filled with a first component, wherein the carrier cavity is filled with the second component in a second step. Thus for example a core of the carrier cavity can be injected with a first component in a first step. A jacket of a second component is injected around the core in a second step.

One can also envisage only certain bristle cavities being filled with a first component in a first step and further bristle cavities, which are not filled with the first component, being filled with a second component until in a subsequent step.

The selective filling of the bristle cavities with a component can be effected for example by way of closing the bristle cavities. Moreover, it is also possible for only certain feed channels of the bristle cavities in the carrier cavity to be charged with a component.

One can also envisage different components being simultaneously injected via different injection points. Special colour courses in the bristle field can be achieved by this. It is particularly two-colour care bristles which can thus be injected.

One can envisage information such as a date code or an identification code, e.g. of a production lot, for the retraceability, being deposited onto the body care brush, e.g. onto the main body, during the injection moulding. The code can be a number.

In particular, the code is deposited parallel to the injection moulding or during the cooling, before the cavity is opened again. In particular, the code is deposited in the region of the grip part or of the neck part.

If the care bristles are manufactured in a separate injection moulding tool, then the grip part and possibly partly also the neck part are not inserted into an exactly fitting mould or cavity. The parts are accordingly accessible. An embossing tool can now emboss the date code into the grip part or neck part, for example by way of extending out. This is preferably effected on the rear side of the body care brush, i.e. on that side which is opposite to the bristle field. It can be necessary to support the grip part or neck part for this, so that the pressure for embossing can be exerted upon the grip part or neck part.

According to a further development, the injection moulding tool or the body care brush, in particular the toothbrush, which is to be manufactured are designed such that the main body is injected in a first step. This is relocated (transferred) into a further cavity. One or more, such as two further components are subsequently injection moulded in parallel. Hereby, the requirement is such that the main body together with the second cavity is designed such that several cavities which are separated from one another are formed when a main body is inserted into the cavity.

These cavities can be filled with plastic material in parallel via separate injection nozzles or via distribution channels by way of this. “Parallel” means in the same injection moulding cycle in the same cavity, without relocating and in particular also at the same time. A body care brush, in particular a toothbrush can be manufactured from several, in particular three components in two steps or in two cavities in this manner.

According to a further development, for relocating the main body, it is possible to design this with certain undercuts in the grip part, said undercuts permitting a relocating between the different cavities of the injection moulding tool. Such geometries are preferably formed on the rear side of the body care brush, in particular toothbrush, preferably closer to the free end region.

The body care brush, in particular the toothbrush, can consist e.g. of four components.

Thus the main body can comprise a main element of a hard component such as a styrene polymerisate (e.g. styrene acrylonitrile (SAN)). The grip part of the main body can now be constructed of the main element as well as an attachment part of a polyolefin such as polypropylene (PP), as a second component. The attachment part e.g. does not connect to the main element but is connected to the main element via positive fit or non-positive fit.

Furthermore, a soft component such as a thermoplastic elastomer (TPE) can be integrated in parts of the grip part and/or of the neck part and/or of the head part or of the bristle field as a third component.

A bristle component for moulding out the bristles can be integrated as a fourth component.

One can envisage all shaping steps, including the manufacture of the packaging of the body care brush being effected via an injection moulding method. I.e. the packaging is likewise injected.

The packaging can thus be injected as an envelope and be pulled over the body care brush to be packaged in subsequent working step. If the packaging envelope consists of a soft component, then this can be pushed over the body care brush. If the packaging consists of a hard component, then this can be folded over the body care brush.

It is also possible for the packaging to be injected over the body care brush as a covering in one step. For this, the brush head can be mounted in a gel-like protective mass which does not connect to the care bristles and any possibly present oral hygiene members. The gel-like protective mass which can likewise be injected either serves directly as an end packaging or further plastic components can be injected over it, for example in the injection moulding method. Herein, the protective mass can be removed from the package again before use, e.g. by way of washing out.

The subject-matter of the invention is hereinafter explained in more detail by way of special embodiments which are represented in the accompanying drawings. Shown schematically in each case are:

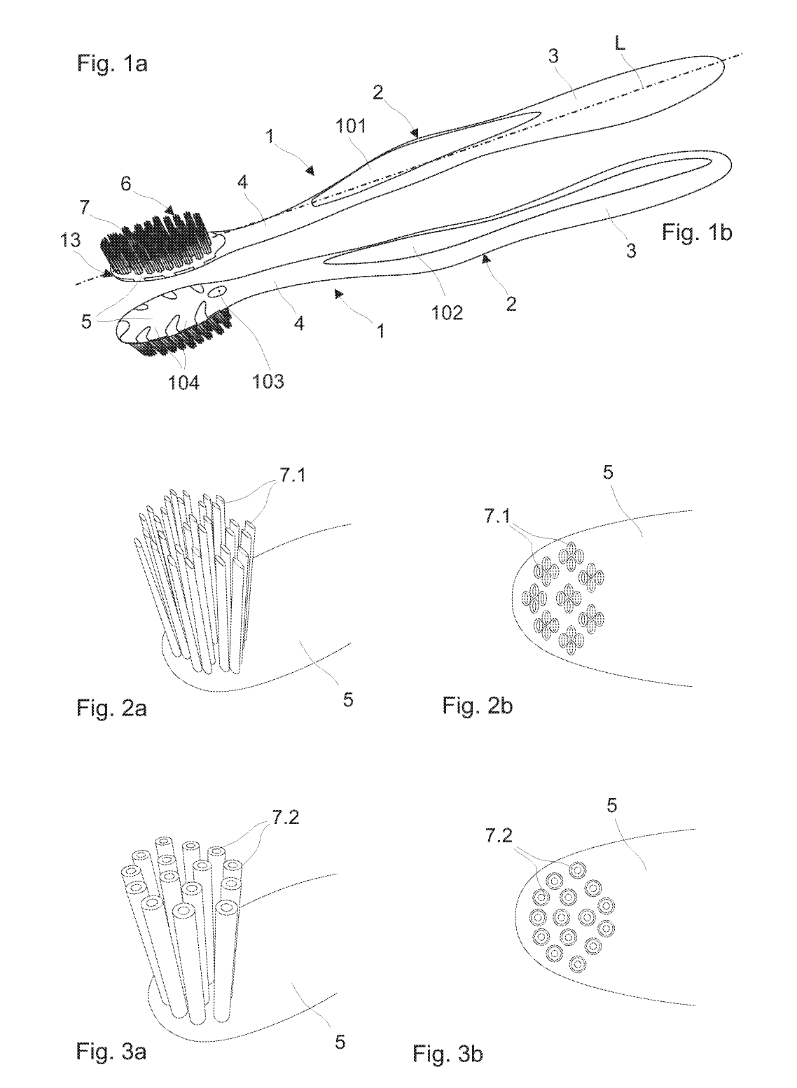

FIG. 1a: a perspective view of a toothbrush with injected care bristles, obliquely from above;

FIG. 1b: a perspective view of the toothbrush according to FIG. 1a, obliquely from below;

FIG. 2a: a perspective view of the front region of the brush head of a toothbrush according to a first embodiment;

FIG. 2b: a plan view of the front region of the brush head according to FIG. 2a;

FIG. 3a: a perspective view of the front region of the brush head of a toothbrush according to a second embodiment;

FIG. 3b: a plan view of the front region of the brush head according to FIG. 3a;

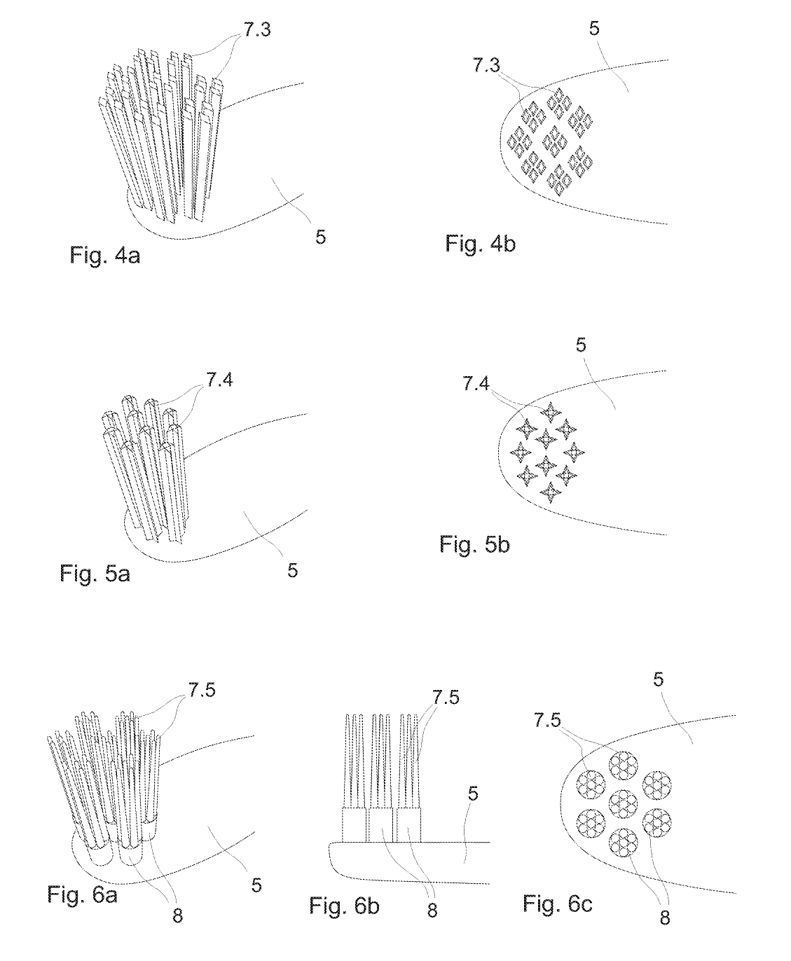

FIG. 4a: a perspective view of the front region of the brush head of a toothbrush according to a third embodiment;

FIG. 4b: a plan view of the front region of the brush head according to FIG. 4a;

FIG. 5a a perspective view of the front region of the brush head of a toothbrush according to a fourth embodiment;

FIG. 5b a plan view of the front region of the brush head according to FIG. 5a;

FIG. 6a: a perspective view of the front region of the brush head of a toothbrush according to a fifth embodiment;

FIG. 6b: a lateral view of the front region of the brush head according to FIG. 6a;

FIG. 6c: a plan view of the front region of the brush head according to FIG. 6a;

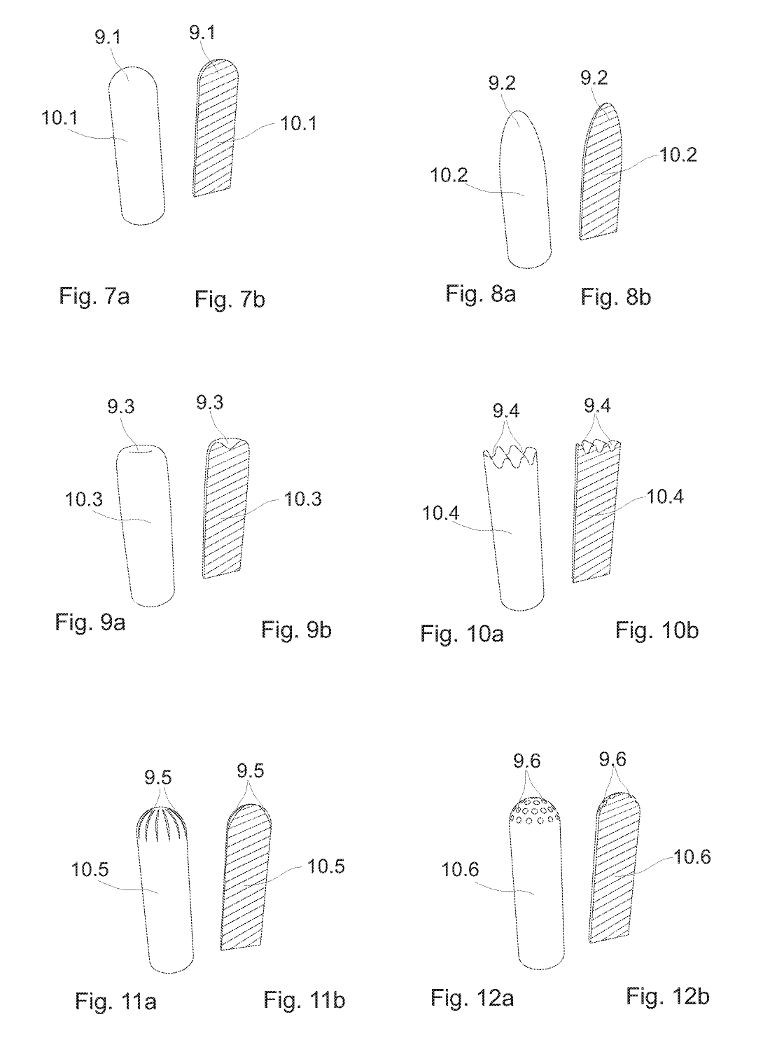

FIG. 7a: a perspective view of an injected care bristle according to a first embodiment;

FIG. 7b: a cross-sectional view of the care bristle according to FIG. 7a along its middle longitudinal plane;

FIG. 8a: a perspective view of an injected care bristle according to a second embodiment;

FIG. 8b: a cross-sectional view of the care bristle according to FIG. 8a along its middle longitudinal plane;

FIG. 9a: a perspective view of an injected care bristle according to a third embodiment;

FIG. 9b: a cross-sectional view of the care bristle according to FIG. 9a along its middle longitudinal plane;

FIG. 10a: a perspective view of an injected care bristle according to a fourth embodiment;

FIG. 10b: a cross-sectional view of the care bristle according to FIG. 10a along its middle longitudinal plane;

FIG. 11a: a perspective view of an injected care bristle according to a fifth embodiment;

FIG. 11b: a cross-sectional view of the care bristle according to FIG. 11a along its middle longitudinal plane;

FIG. 12a: a perspective view of an injected care bristle according to a sixth embodiment;

FIG. 12b: a cross-sectional view of the care bristle according to FIG. 12a along its middle longitudinal plane;

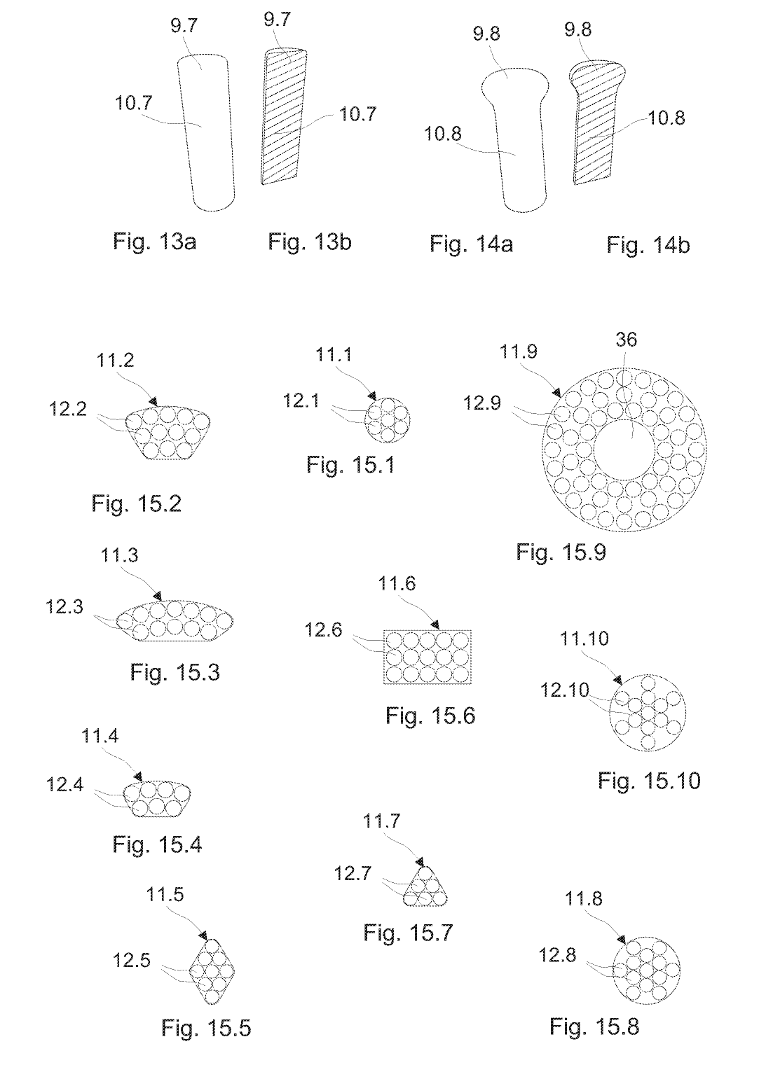

FIG. 13a a perspective view of an injected care bristle according to a seventh embodiment;

FIG. 13b a cross-sectional view of the care bristle according to FIG. 13a along its middle longitudinal plane;

FIG. 14a a perspective view of an injected care bristle according to an eighth embodiment;

FIG. 14b: a cross-sectional view of the care bristle according to FIG. 14a along its middle longitudinal plane;

FIG. 15.1-15.22 plan views of different embodiments of bristle segments for forming the bristle field of a toothbrush;

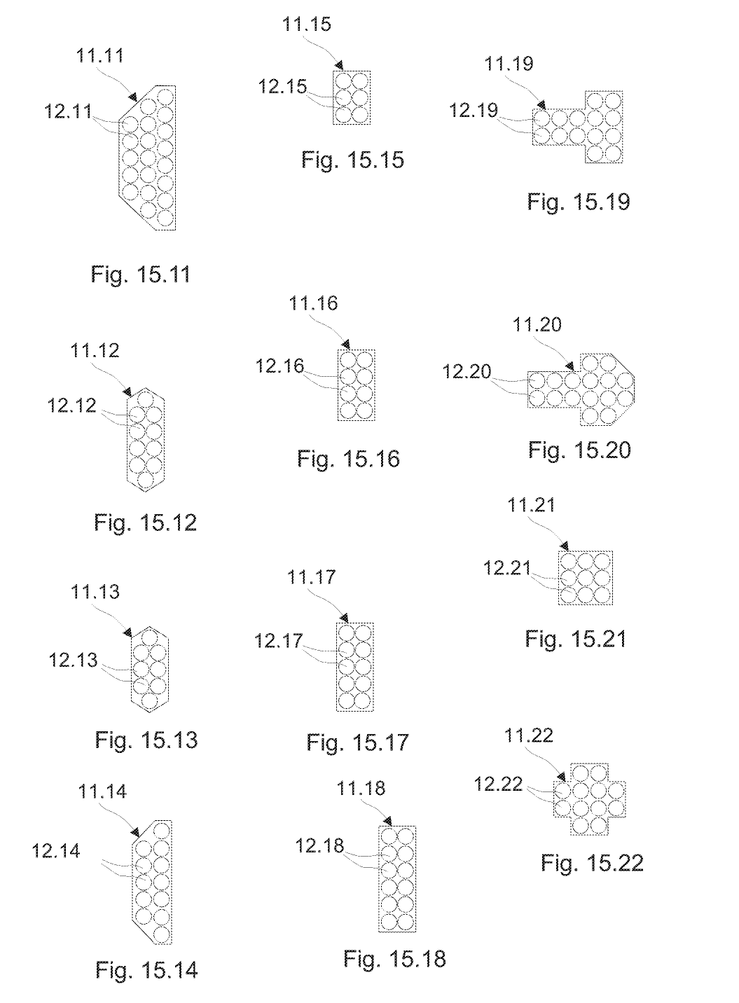

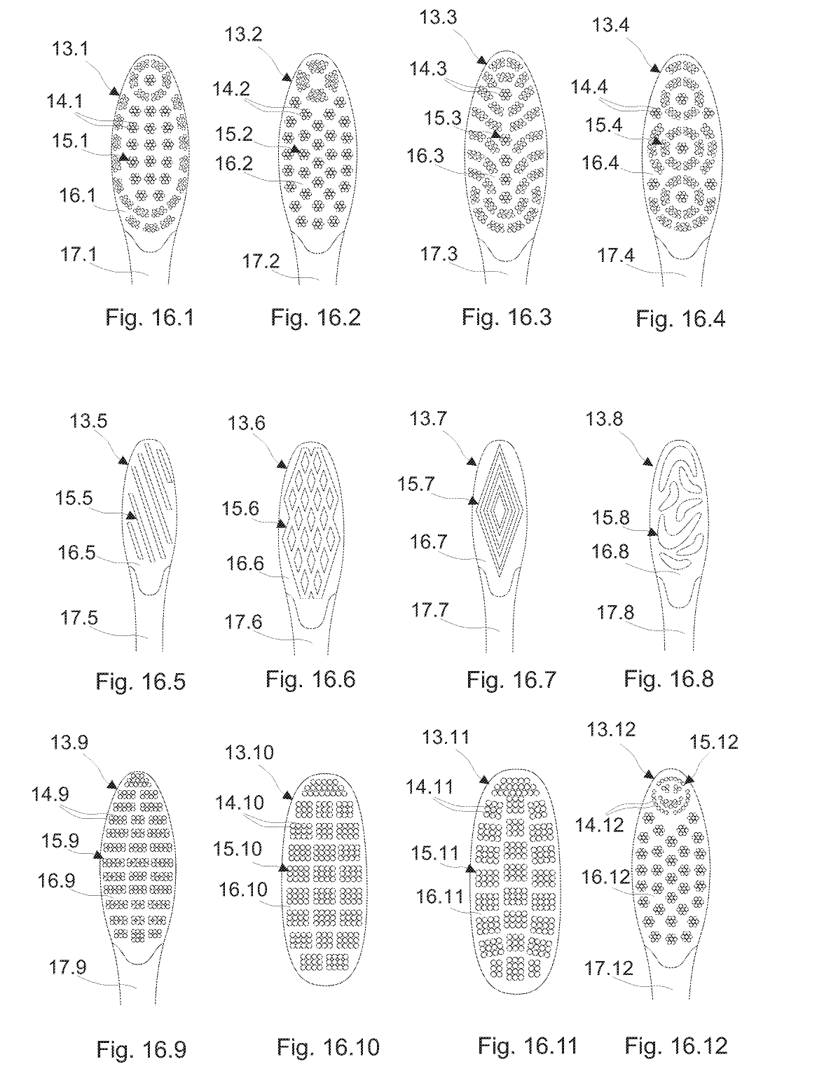

FIG. 16.1-16.12 plan views of different embodiments of brush heads;

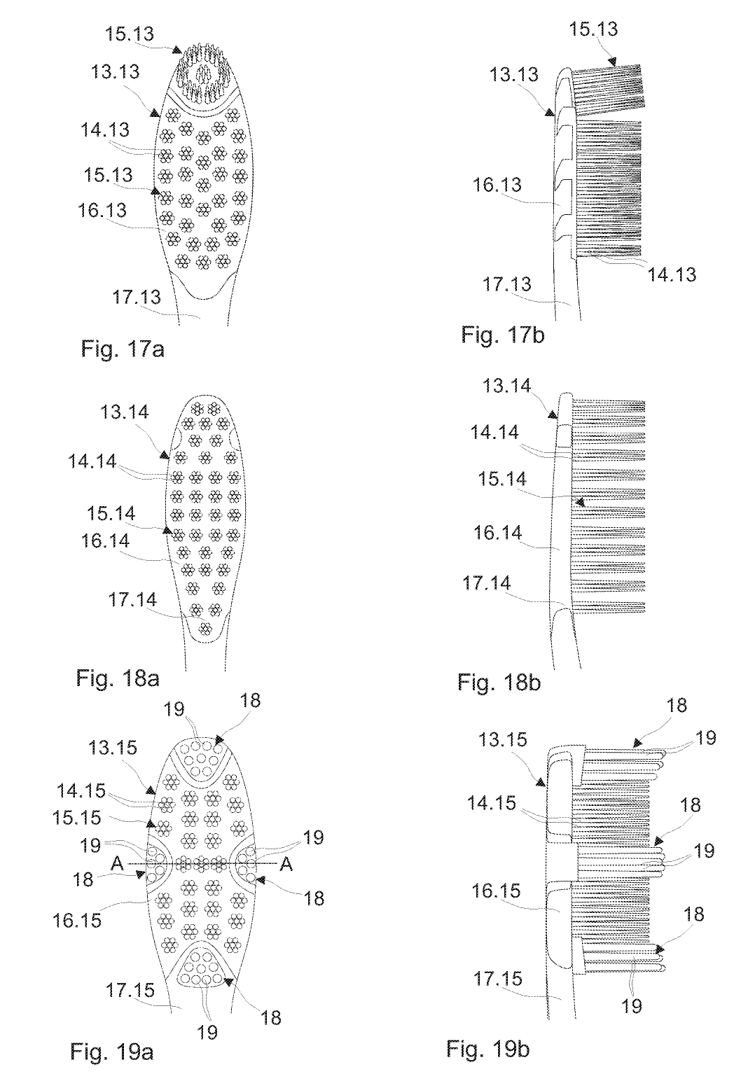

FIG. 17a: a plan view of a brush head according to a further embodiment;

FIG. 17b: a lateral view of the brush head according to FIG. 17a;

FIG. 18a: a plan view of a brush head according to a further embodiment;

FIG. 18b: a lateral view of the brush head according to FIG. 18a;

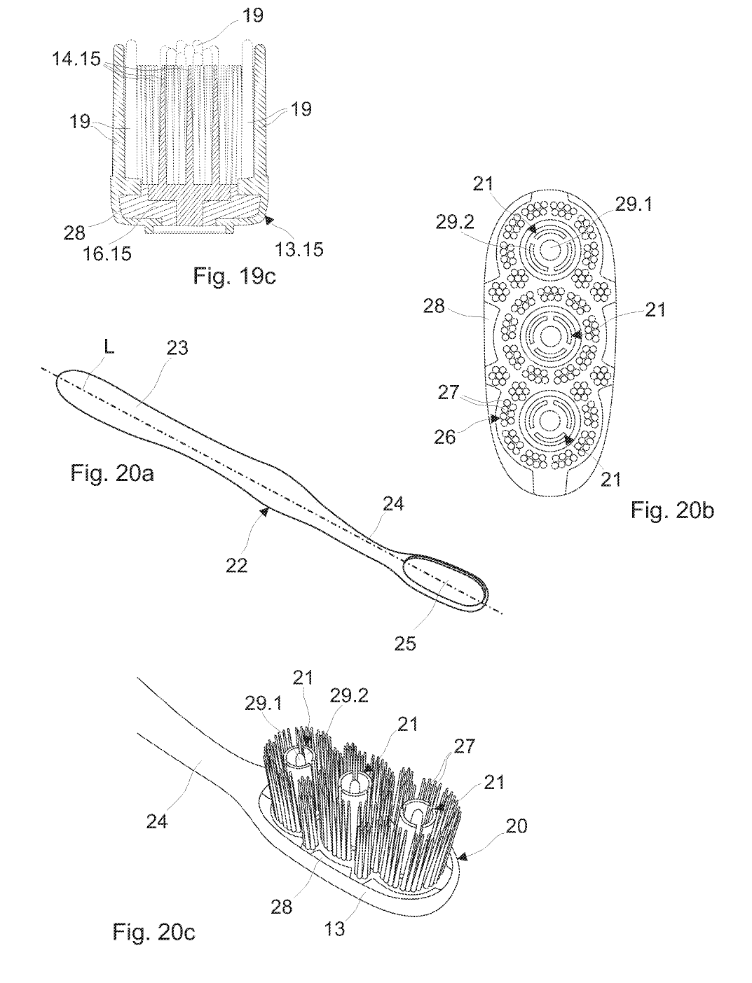

FIG. 19a: a plan view of a brush head according to a further embodiment;

FIG. 19b: a lateral view of the brush head according to FIG. 19a;

FIG. 19c: a cross-sectional view of the brush head according to FIG. 19a, through the care bristles and massage elements/cleaning elements;

FIG. 20a: a perspective view of a main body of a toothbrush according to a further embodiment;

FIG. 20b: a plan view of a carrier body with bristling for a main body according to FIG. 20a;

FIG. 20c: a perspective view of a brush head of a toothbrush which is composed of the main body according to FIG. 20a and the carrier body with the bristling according to FIG. 20b;

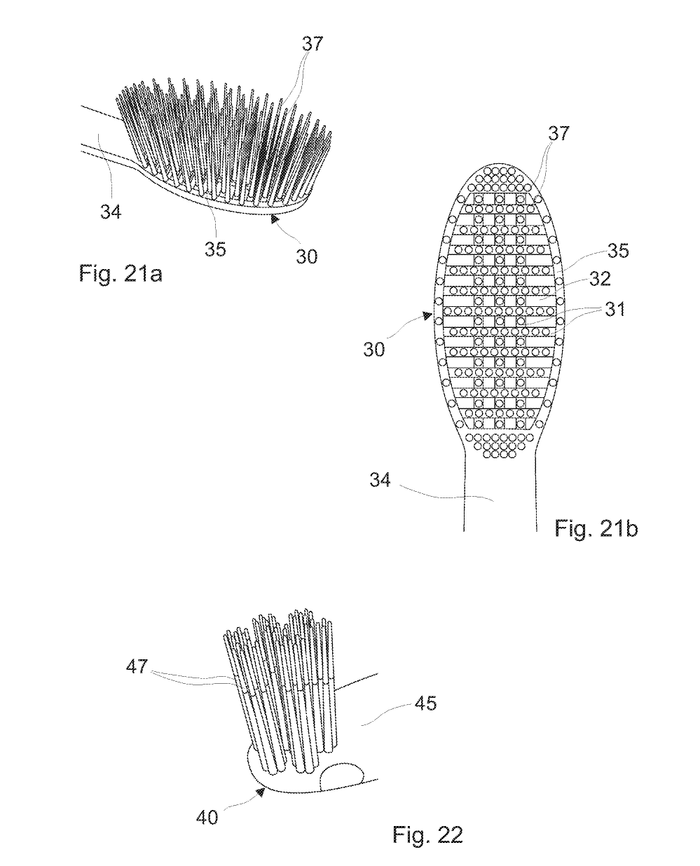

FIG. 21a: a perspective view of a brush head of a toothbrush according to a further embodiment;

FIG. 21b: a plan view of the brush head according to FIG. 21a;

FIG. 22: a perspective view of the front region of a brush head of a toothbrush according to a further embodiment;

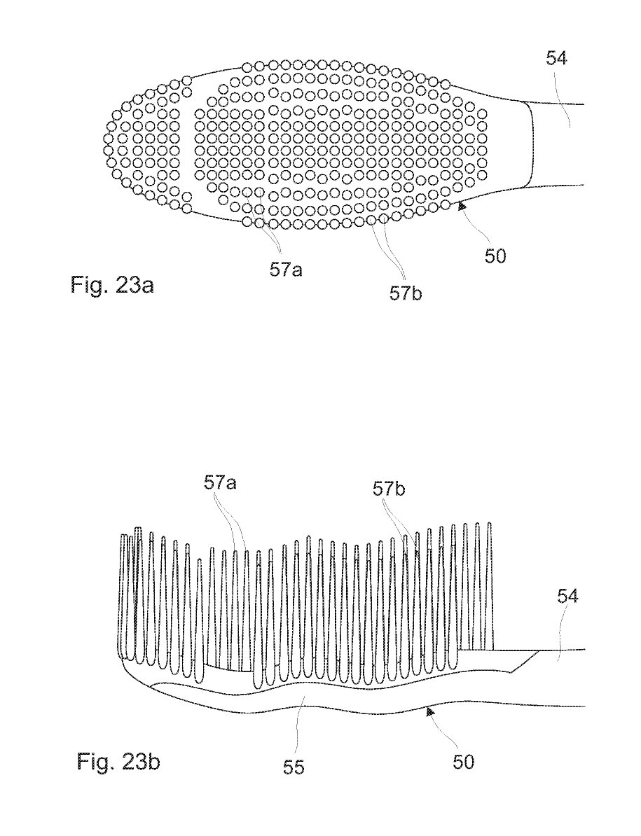

FIG. 23a: a plan view of a brush head of a toothbrush according to a further embodiment;

FIG. 23b: a lateral view of the brush head according to FIG. 23a;

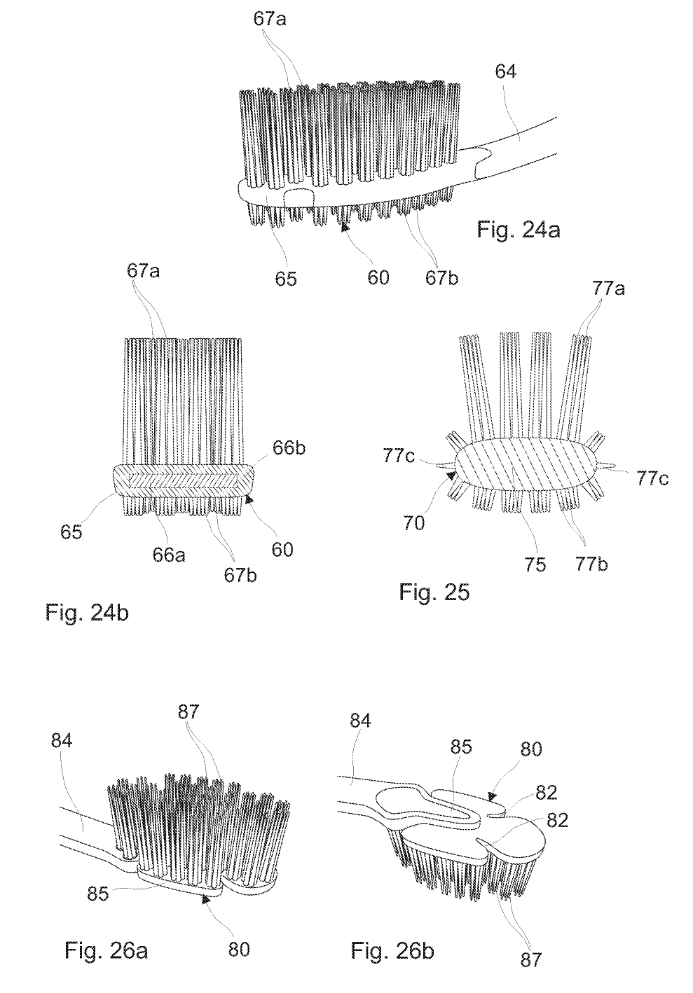

FIG. 24a: a perspective view of the brush head of a toothbrush according to a further embodiment;

FIG. 24b: a cross-sectional view of the brush head according to FIG. 24a;

FIG. 25: a cross-sectional view of a brush head of a toothbrush according to a further embodiment;

FIG. 26a: a perspective view of the brush head of a toothbrush obliquely from above, according to a further embodiment;

FIG. 26b: a perspective view of the brush head according to FIG. 26a obliquely from below;

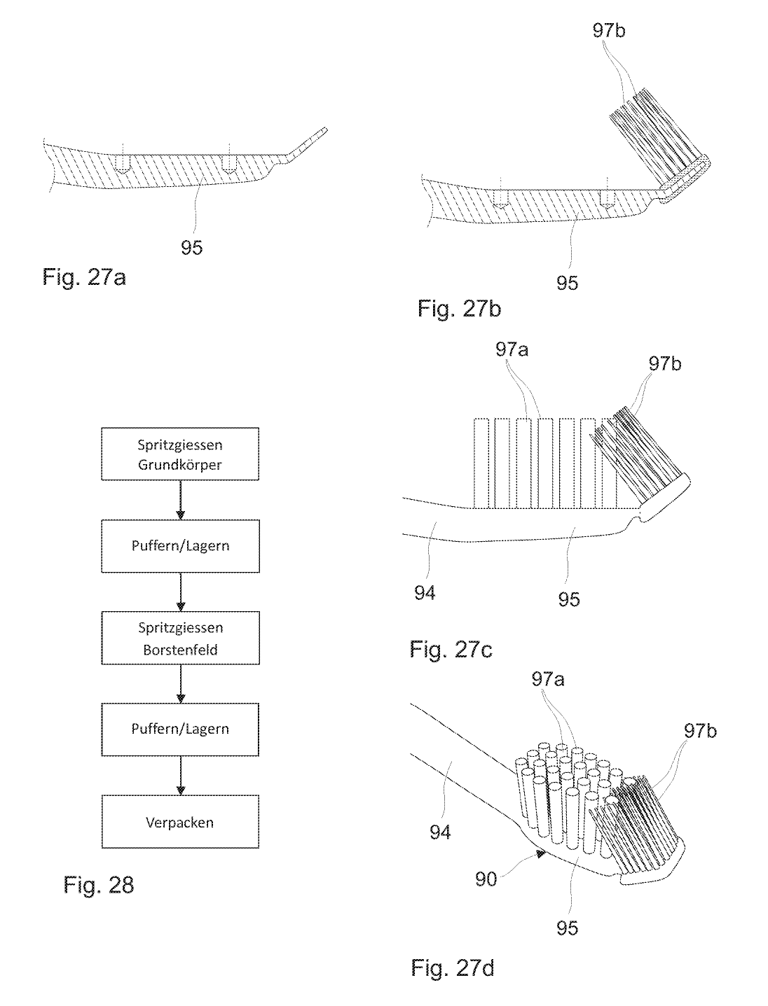

FIG. 27a: a longitudinal sectioned view through the main body of a toothbrush in the region of the head part, according to a further embodiment;

FIG. 27b: a longitudinal sectioned view through the main body according to FIG. 27a with an obliquely set head-end bristle field;

FIG. 27c: a lateral view of a brush head with a main body according to FIG. 27a and with an obliquely set bristle head-end bristle field according to FIG. 27b, as well as further bristle field elements;

FIG. 27d: a perspective view of the brush head according to FIG. 27c obliquely from above;

FIG. 28: a process sequence;

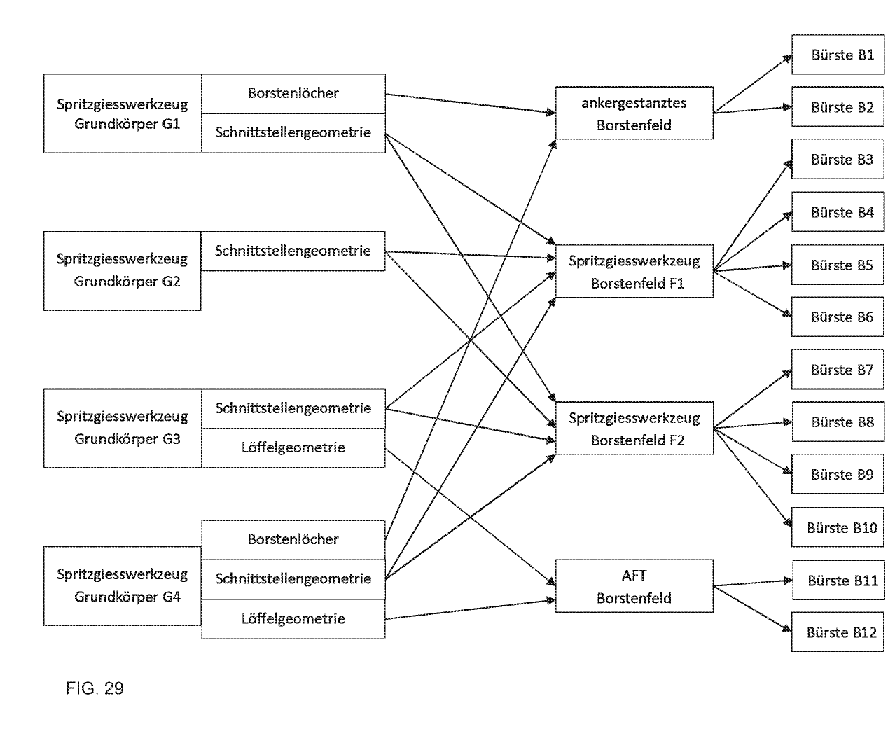

FIG. 29: a representation of the combination possibilities on manufacturing a toothbrush with different care bristle fastening possibilities;

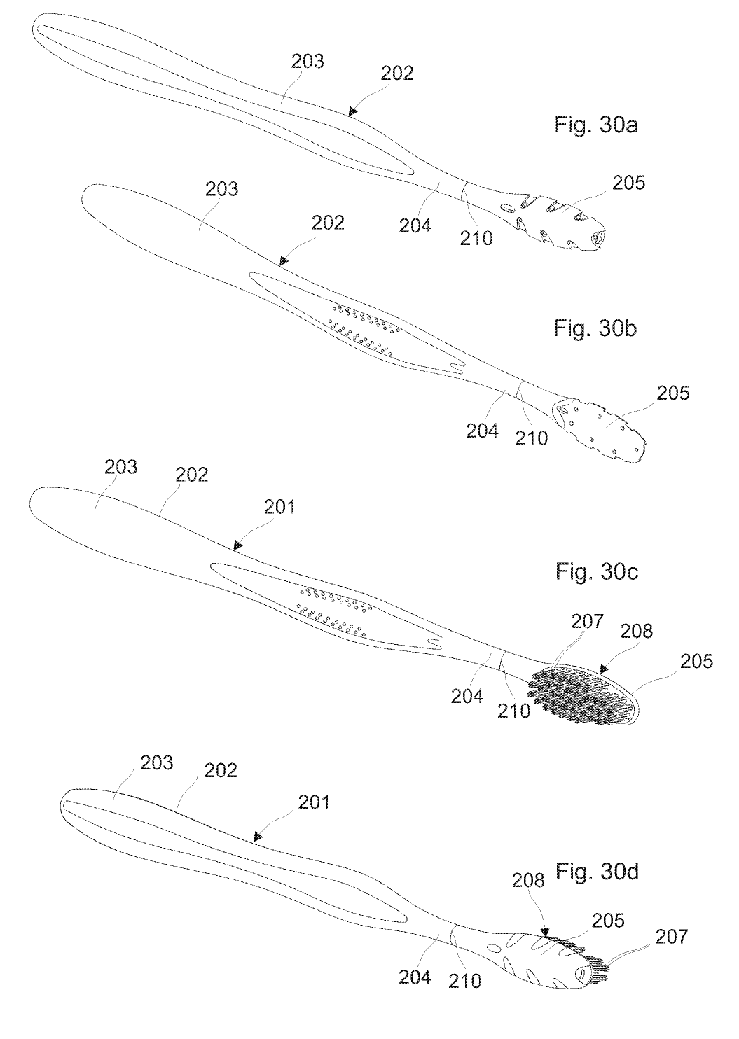

FIG. 30a: a perspective view of the main body of a toothbrush from the rear side with an interface structure for injecting on tooth care bristles;

FIG. 30b: a perspective view of the main body according to FIG. 30a from the front side;

FIG. 30c: a perspective view of the toothbrush from the front side with a main body according to FIGS. 30a and 30b with injected tooth care bristles;

FIG. 30d: a perspective view of the toothbrush according to FIG. 30c from the rear side;

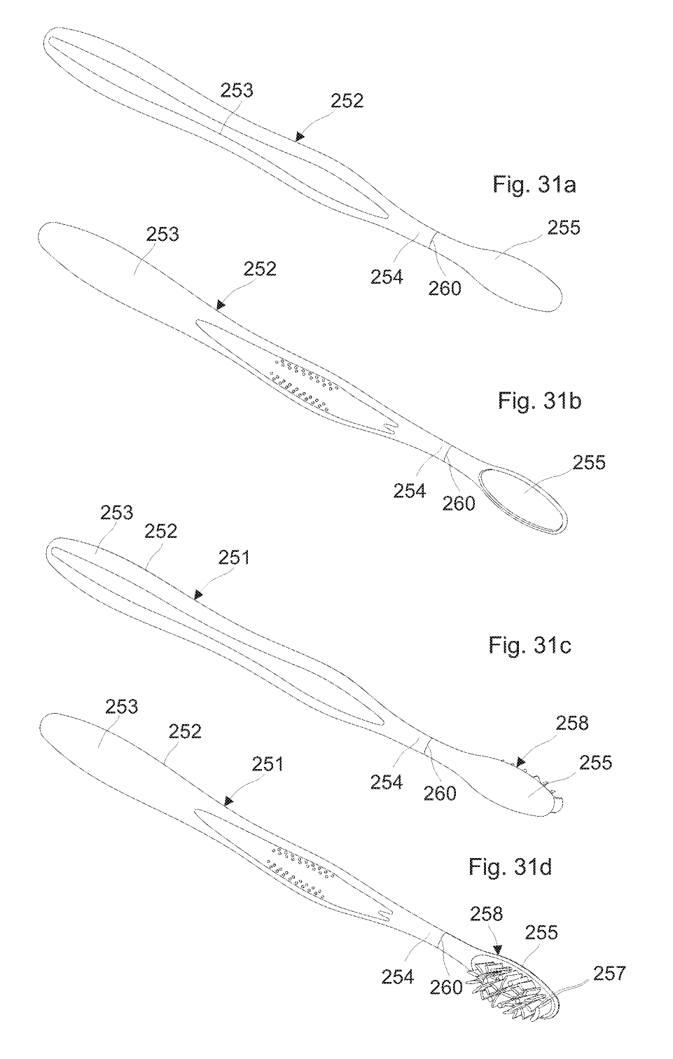

FIG. 31a: a perspective view of the main body of a toothbrush from the rear side with an interface structure for attaching a carrier platelet with tooth care bristles;

FIG. 31b: a perspective view of the main body according to FIG. 31a from the front side;

FIG. 31c a perspective view of the toothbrush from the rear side with a main body according to FIGS. 31a and 31b with attached carrier platelet with tooth care bristles which are fixed in the AFT method;

FIG. 31d: a perspective view of the toothbrush according to FIG. 31c from the front side;

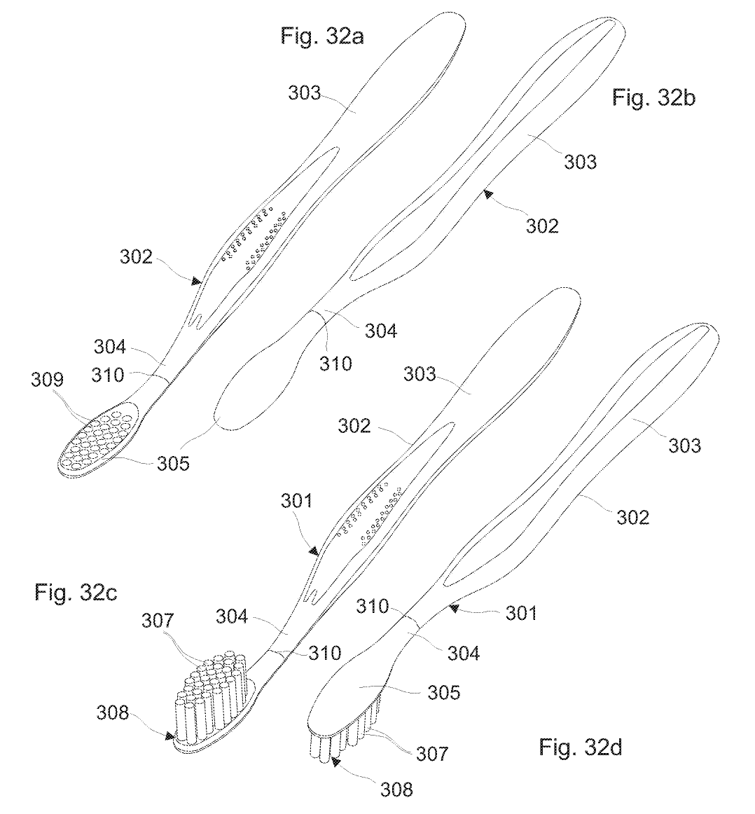

FIG. 32a: a perspective view of the main body of the toothbrush from the front side with an interface structure for the attachment of tooth care bristles in the anchor stamping method;

FIG. 32b: a perspective view of the toothbrush according to FIG. 32a from the rear side;

FIG. 32c: a perspective view of the toothbrush from the front side with a main body according to FIGS. 32a and 32b, with tooth care bristles which are attached in the anchor stamping method;

FIG. 32d: a perspective view of the toothbrush of FIG. 32c from the rear side;

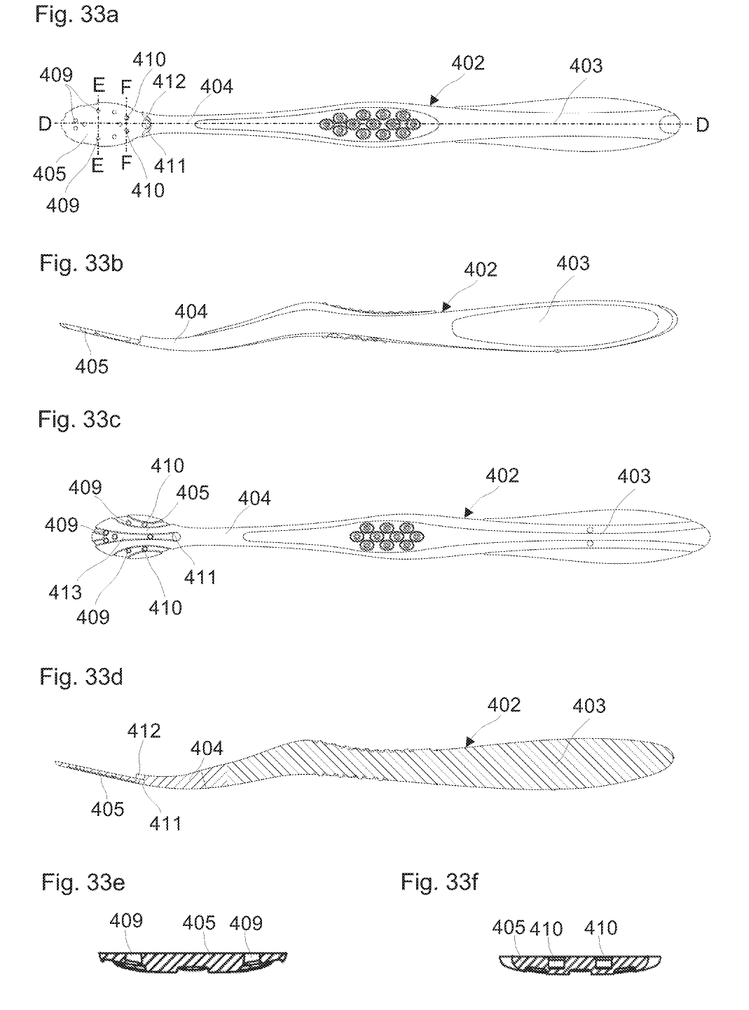

FIG. 33a: a plan view of a main body of a toothbrush according to a further embodiment;

FIG. 33b: a lateral view of the main body according to FIG. 33a:

FIG. 33c: a plan view of the rear side of the main body according to FIG. 33a;

FIG. 33d: a longitudinal section through the main body according to FIG. 33a along the line D-D;

FIG. 33e: a first cross section through the brush head of the main body according to FIG. 33a along the line E-E;

FIG. 33f: a second cross section through the brush head of the main body according to FIG. 33a along the line F-F;

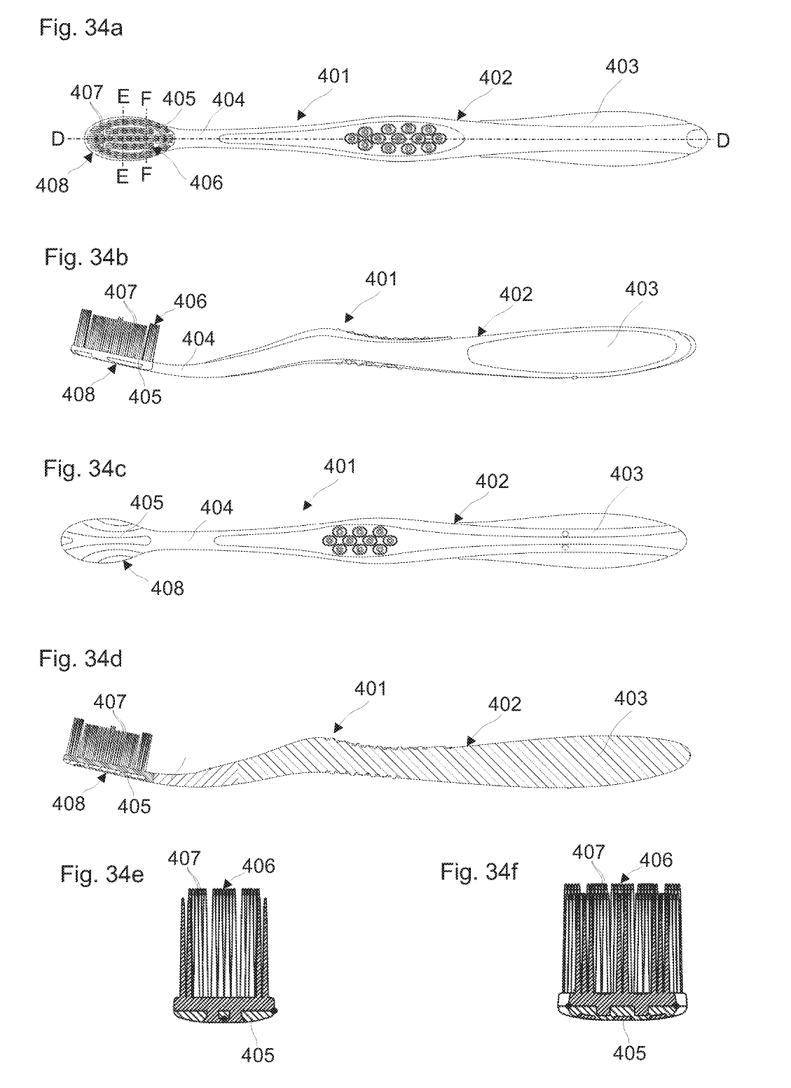

FIG. 34a: a plan view of a toothbrush with a main body according to FIG. 33a;

FIG. 34b: a lateral view of the toothbrush according to FIG. 34a;

FIG. 34c: a plan view upon the rear side of the toothbrush according to FIG. 34a;

FIG. 34d: a longitudinal section through the toothbrush according to FIG. 34a along the line D-D;

FIG. 34e: a first cross section through the brush head of the toothbrush according to FIG. 34a along the line E-E;

FIG. 34f: a second cross section through the brush head of the toothbrush according to FIG. 34a along the line F-F.

The present invention is not limited to the embodiments or design variants which are represented in the figures. Basically, the same parts are provided with the same reference numerals in the figures.

The subsequently represented embodiments of toothbrushes are characterised in that at least a part, in particular all tooth cleaning bristles are injected.

The toothbrush 1 which is represented in FIG. 1a and 1b comprises a main body 2 with a grip part 3, a head part 5 and with a neck part 4 which connects the head part 5 to the grip part 3.

The grip part 3 corresponds to that part of the toothbrush 1 which forms a rear end section and on which the toothbrush 1 is held by the hand.

The grip part 3 consists of a hard component. Moreover, the grip part 3 on its front side forms a first grip zone 101 with a thumb rest as well as a second grip zone 102 which lies opposite the first grip zone 101. The two grip zones 101, 102 are designed in an island-like manner. The two grip zones 101 102 consist of a further component, which e.g. can be a soft component.

The head part 5 corresponds to a front end section of the toothbrush 1, on which tooth cleaning bristles 7 are arranged. This end of the toothbrush 1 is indicated as a brush head 13. The head part 5 in particular is designed ovally. The head part 5 forms a front side and a rear side which lies opposite the front side. The tooth cleaning bristles 7 are arranged on the front side of the head part 5.

The front and the rear end section of the toothbrush 1 are arranged opposite one another.

In particular, the neck part 4 represents a transition section between the head part 5 and the grip part 3. The diameter of the neck part 4 in particular is reduced with respect to the grip part 3 and the head part 5. I.e. the neck part 4 forms a cross-sectional narrowing or tapering between the head part 5 and the grip part 3.

The injected tooth cleaning bristles 7 on the front side of the head part 5 form a bristle field 6. The head part 5 and the bristle field 6 form the brush head 13 of the toothbrush 1.

The brush head 13 from the front side to into the rear side of the toothbrush 1 forms sections which consist of the bristle component, from which the tooth cleaning bristles 7 are also injected. These sections are led in a finger-like manner around the sides of the brush head towards the rear side.

The head part 5 forms support sections 104 at the rear side between the finger-like sections of the bristle component, said support sections in particular consisting of a hard component.

The injection point 103 of the bristle component is also located on the rear side.

The injection point 103 is arranged on the toothbrush 1 such that on injecting the plastic into the cavity of the injection moulding tool, the plastic is not injected into the bristle cavities directly, i.e. in a straight line. I.e. the fluid plastic for example first contacts other elements or walls before it flows into the bristle cavity.

The longitudinal axis L of the toothbrush 1 is specified for orientation.

FIGS. 2a, 2b; 3a, 3b; 4a, 4b; 5a, 5b and 6a, 6b, 6c show different embodiments of tooth cleaning bristles 7.1-7.5 which essentially differ from one another by different bristle cross sections. What is shown in each case is a part of the bristle field. The tooth cleaning bristles 7.1-7.5 are schematically represented on a head part 5 in the figures. The FIGS. 2b; 3b; 4b; 5b and 6c show the tooth cleaning bristles 7.1-7.5 in each case in a plan view. What is clearly evident in the plan view is the conical construction of the tooth cleaning bristles 7.1-7.5 in the longitudinal direction of the tooth cleaning bristles, said construction being necessary for the demoulding which is to say mould removal from the injection moulding tool.

The tooth cleaning bristles 7.1 according to FIGS. 2a and 2b have an oval cross section. The tooth cleaning bristles 7.1 form a solid cross section. However, the tooth cleaning bristles 7.1 can also be designed in a hollow, thus tubular manner. The bristle field which is formed by the tooth cleaning bristles 7.1 comprises bristle segments each with four tooth cleaning bristles 7.1.

The tooth cleaning bristles 7.2 according to FIGS. 3a and 3b have a circular cross section. The tooth cleaning bristles 7.2 are designed in a hollow manner, thus in a tubular manner. The tooth cleaning bristles 7.2 however can also form a solid cross section.

The tooth cleaning bristles 7.3 according to FIGS. 4a and 4b have a rhombic cross section. The tooth cleaning bristles 7.3 form a solid cross section. The tooth cleaning bristles 7.3 however can also be designed in a hollow, thus tubular manner. The bristle field which is formed by the tooth cleaning bristles 7.3 comprises bristle segments each with four tooth cleaning bristles 7.3.

The tooth cleaning bristles 7.4 according to FIGS. 5a and 5b comprise a cross-like or star-like cross section. The tooth cleaning bristles 7.4 form a solid cross section. The tooth cleaning bristles 7.4 however can also be designed in a hollow, thus tubular manner.

The tooth cleaning bristles 7.5 according to FIGS. 6a, 6b and 6c have a circular cross section which tapers conically towards the free bristle end. The tooth cleaning bristles 7.5 form a solid cross section. The tooth cleaning bristles 7.5 however can also be designed in a hollow, thus tubular manner. A group of several tooth cleaning bristles 7.5 are grouped together towards the head part 5 via a bristle stem 8 into a bristle bundle which simultaneously corresponds to a bristle segment.

FIGS. 7a, 7b; 8a, 8b; 9a, 9b; 10a, 10b; 11a, 11b; 12a, 12b; 13a, 13b; 14a, 14b show different embodiments of tooth cleaning bristles 10.1-10.8 with differently designed bristle end sections.

The bristle end sections according to FIGS. 7a, 7b and 8a, 8b are designed in a rounded manner. The rounding 9.1 according to the embodiment according to FIGS. 7a and 7b corresponds to a spherical calotte or hemisphere. The rounding 9.2 according to the embodiment according to FIGS. 8a and 8b is projectile-shaped or pointed.

The bristle end section according to FIGS. 9a and 9b is likewise rounded. However, a central recess 9.3 which is delimited by a closed peripheral bristle edge is incorporated in the bristle end.

The bristle end section according to the FIGS. 10a and 10b is designed in a fluted/corrugated manner and comprises elongate recesses 9.4 and prominences which alternate.

The bristle end section according to Figures Ila and 1 lb is designed in a rounded manner analogously to FIGS. 7a and 7b. A plurality of flutes 9.5 which leads radially away from the bristle end (or the bristle longitudinal axis) is arranged around the complete periphery of the rounded end section. The flutes 9.5 accordingly run to one another in a star-like manner towards the bristle end over the rounded bristle section.

The bristle end section according to the FIGS. 12a and 12b is likewise designed in a rounded manner analogously to FIGS. 7a and 7b. A plurality of pimple-like deepenings (dimples/micro-craters) 9.6 is arranged around the complete periphery of the rounded end section.

The bristle end section according to the FIGS. 13a and 13b is flattened towards the bristle end 9.7. The transition into the flattening is however rounded.

The bristle end section according to FIGS. 14a and 14b comprises a mushroom-shaped widening 9.8 towards the bristle end, before the bristle end section ends in a flattening in the bristle end. The bristle end section can be shaped for example from care bristles which in the initial shape have a bristle end section according to the FIG. 7a, 7b or 13a, 13b. One arrives at the mushroom-shaped widening according to the FIGS. 14a, 14b by way of heating and a subsequent upsetting (compression) of the bristle end sections.

FIGS. 15.1 to 15.22 show different embodiments of bristle cavity segment inserts in a plan view. The bristle cavity segment inserts amongst other things are characterised in that these each comprise a plurality of cavities for tooth cleaning bristles 12.1-12.22.

The shown bristle cavity segment inserts according to the FIGS. 15.1 to 15.22 inversely represent individual bristle segments of a bristle field. Accordingly, the cavities for tooth cleaning bristles 12.1-12.22 according to the FIGS. 15.1 to 15.22 inversely represent individual bristles of a bristle segment.

FIG. 15.1 shows a circular bristle cavity segment insert 11.1. This segment shape is also applied with stamped, conventional care bristles.

FIGS. 15.2 to 15.4 show different embodiments of ring-sector-shaped bristle cavity segment inserts 11.2-11.4 of a different size. Whereas the bristle cavity segment insert 11.2 according to FIG. 15.2 are three-rowed, the bristle cavity segment inserts 11.3 and 11.4 according to 15.3 and 15.4 are only of two rows.

Ring-sector-shaped bristle cavity segment inserts 11.2-11.4 can be combined for example into ring-shaped, wave-like or curved bristle patterns.

FIG. 15.5 shows a rhombic bristle cavity segment insert 11.5.

FIGS. 15.6 as well as 15.15-15.18 show rectangular bristle cavity segment inserts 11.6, 11.15-11.18.

FIG. 15.7 shows a triangular bristle cavity segment insert 11.7.

FIG. 15.8 shows a roundish bristle cavity segment insert 11.8.

FIG. 15.9 show an annular bristle cavity segment insert 11.9. The annular bristle cavity segment insert 11.9 forms a segment free space 36 in the centre.

FIG. 15.10 shows a star-shaped bristle cavity segment insert 11.10.

FIGS. 15.11 and 15.14 show different embodiments of truncated-pyramid-shaped or trapezoidal bristle cavity segment inserts 11.11, 11.14.

FIGS. 15.12 and 15.13 show further preferred embodiments of bristle cavity segment inserts 11.12, 11.13, in each case having a rectangular base shape with pointed rectangular ends.

FIG. 15.19 shows a T-shaped bristle cavity segment insert 11.19.

FIG. 15.20 shows an arrow-like bristle cavity segment insert 11.20.

FIG. 15.21 shows a square bristle cavity segment insert 11.21.

FIG. 15.22 shows a cross-shaped bristle cavity segment insert 11.2.

FIGS. 16.1 to 16.12 as well as the FIGS. 17a, 17b; 18a, 18b and 19a, 19b show different embodiments of brush heads 13.1-13.15 or bristle fields. The brush head 13.1-13.15 each comprises a head part 16.1-16.15 and a bristle field which is arranged on this. A neck part 17.1-17-15 connects to the brush head 13.1-13.15. The neck part 17.1-17.15 however is not represented in all embodiments.

The bristle field is formed from a plurality of bristle segments 15.1-15.15. The bristle segments 15.1-15.15 again each have a plurality of tooth cleaning bristles 14.1-14.15.

The bristle field of the brush head 13.1-13.4 according to FIGS. 16.1-16.4 is composed of a plurality of bristle segments 15.1-15.4 of a different geometry. A first group of bristle segments 15.1-15.24 is annulus-sector-shaped. A second group of bristle segments 15.1-15.4 is circular.

Combinations of bristle segments 15.1-15.4 of the first or second groups form part-fields with special geometric shapes such as circles, ovals, ring sectors, curvy strips, etc.

Thus e.g. according to FIG. 16.1, bristle segments 15.1 of the first group are arranged peripherally on the brush head and form an oval part-field. Further bristle segments 15.1 of the first group are arranged at the head end and form an annular part-field which shapes the so-called power tip. Bristle segments 15.1 of the second group are arranged within the bristle segments 15.1 of the first group and thus form an inner lying part-field.

According to FIG. 16.3, bristle segments 15.3 of the first group form a fishbone pattern. Herein, bristle segments 15.3 are arranged in a propagating geometry, in particular laterally in the direction of the longitudinal axis L of the toothbrush.

According to FIG. 16.4, bristle segments 15.4 of the first group, put together, form a plurality of annuluses or annulus segments.

Only the outer edges of at least partly put-together bristle segments 15.5-5.8 are represented in FIGS. 16.5-16.8, but not the care bristles themselves, for the purpose of a better overview.

The outer edges of the put-together bristle segments 15.5 according to FIG. 16.5 are designed in a strip-like manner and are arranged into a hatching-like strip pattern in the brush head 13.5. The bristle strips are aligned obliquely to the longitudinal direction of the toothbrush.

The outer edges of the put-together bristle segments 15.6 according to FIG. 16.6 are designed as a rhombic pattern. Various segment free spaces are arranged within the pattern.

The outer edges of the put-together bristles segments 15.7 according to 16.7 are designed as rhombuses which are arranged nested within one another.

The outer edges of the bristle segments 15.8 according to FIG. 16.8 have free shapes of geometries which are curved in a rounded manner.

The bristle segments 15.9, 15.10 according to FIGS. 16.9 and 16.10 for the most part are designed rectangularly and are aligned parallel to one another.

The bristle segments 15.11 according to FIG. 16.11 are likewise formed for the most part in a rectangular manner. However, the peripheral bristles segments 15.11 are arranged angled with respect to the central bristle segments and have a slight arched course. A T-shaped bristle segment 15.11 is arranged in the region of the power tip.

The design freedom concerning the fashioning of the bristle segments also permits the formation of patterns in the bristle field, said patterns comprising information or messages. Thus for example FIG. 16.12 in the head end (in the region of the power tip) shows a smiley.

As already mentioned further above, the bristle segments can also be shaped and arranged in the head end in a manner such that these from a so-called power tip (see FIG. 16.1). Power tips are characterised by their structures which set back from the remaining bristle field, so as to better reach the rearmost teeth.

The brush head 13.13 according to FIGS. 17a and 17b comprises a bristle field with a plurality of round bristle segments 15.13 which are arranged on the head part 16.13 in a regular pattern. Further bristle segments 15.13 are arranged at the head end of the brush head 13.13. These form an annulus-shaped structure with a further bristle segment 15.13 in the segment free space. These bristle segments together form a so-called power-tip. The care bristles of these bristle segments are angled away from the remaining bristle field to the front in the longitudinal direction of the toothbrush. The power tip amongst other things serves for an improved cleaning of the rearmost teeth.

The power tip can also be manufactured from another component than the remainder of the bristle field.

The bristle segments 15.14 according to FIGS. 18a and 18b are designed in a roundish manner. The bristle field is led to into the neck part 17.14. Accordingly, bristle segments 15.14 are likewise arranged in that region of the neck part 17.14 which directly connects onto the brush head 13.14.

According to the embodiment example according to FIGS. 19a to 19c, additional oral hygiene members 18 which serve for massage or cleaning purposes are arranged on the edge of the bristle filed. The oral hygiene members 18 each comprise a plurality of rod-like massage or cleaning elements 19 of a soft-elastic material. The massage or cleaning elements 19 project beyond the bristle field of tooth cleaning bristles 14.15.

A first oral hygiene member 18 is arranged in the head end of the brush head 13.15. A second oral hygiene member 18 is arranged in the neck part 17.15. An oral hygiene member 18 is yet arranged laterally on the brush head 13.15 in each case. The oral hygiene members 18 therefore at least partly encompass the bristle field at the edge side. The massage or cleaning elements 19 of the oral hygiene members 18 are likewise injected.

The oral hygiene members 18, the tooth cleaning bristles 14.15 as well as the head part 16.15 are each manufactured of a different component in various injection moulding steps. The head part consists of a hard component, the tooth cleaning bristles 14.15 of a bristle component and the oral hygiene member 18 with the care bristles 19 of a soft component.

It is particularly well evident in the cross-sectional view along the line A-A (FIG. 19a) according to FIG. 19c, as to how the three applied components are arranged relative to one another within the cross section. Moreover, it is well evident that the massage and cleaning elements 19 stand taller than the bristle segments 14.15.

The toothbrush which is represented in FIGS. 20a, 20b and 20c comprises a main body 22 with a grip part 23, with a neck part 24 and with a head part 25 (see also FIG. 20a). The tooth cleaning bristles 27 in the present embodiment however are not injected directly onto the head part 25 of the main body 22, but rather onto a carrier body 28 in the form of a carrier platelet. The carrier platelet 28 with the bristle field is inserted into a recess in the head part 25 and is connected to the head part 25.

The toothbrush moreover comprises three oral hygiene members 21 which are likewise injected onto the carrier platelet 28. The oral hygiene members 21 form a circle structure and are arranged one after the other along the longitudinal axis L of the toothbrush and at a distance to one another, on the head part 25 or on the carrier platelet 28. The oral hygiene members 21 each comprise a central, rod-like massage element as well as massage lamellae 29.2 which are arranged circularly around the rod-like massage element 29.1.

Bristle segments 26 are arranged around the oral hygiene members 21 in a circular arrangement. The bristle segments 26 each comprise a plurality of tooth cleaning bristles 27. A plurality of bristles segments has the shape of an annulus sector.

The embodiment of a brush head 30 according to FIGS. 21a and 21b is characterised by a head part 35 which is designed in a grid-like manner and which comprises a plurality of bristle strips 31 which cross at a right angle. The crossing bristle strips 31 each enclose rectangular openings 32.

The bristle strip which frames the head part 35 is designed in an oval manner. Accordingly, the head part 35 together with the neck part 34 which connects to this has the shape of a tennis racket.

The tooth cleaning bristles 37 are now arranged in rows or columns on the bristle strips 31 as well as on the frame strip.

The bristle field has a compliance on applying a pressing pressure, thanks to the openings 32 or the grid-like formation of the head part 35.

Moreover, the frame strip in the core is manufactured of a hard component. It forms a stable frame in this manner. The grid of the bristle strips 31 in the inside is formed from a softer component, e.g. of the bristle component. A flexibility is achieved by way of this.

The brush head 40 according to FIG. 22 comprises a plurality of tooth cleaning bristles 47 which are injected on the head part 45 and which are arranged into bristle segments in a sheaf-like (tuft-like) manner. The tooth cleaning bristles 47 are manufactured of several components/colours. The end of the tooth cleaning bristles 47 on the surface consist of a different component or a different colour than the surface of the base. The care bristles are manufactured in the co-injection method.

The brush head 50 according to FIGS. 23a and 23b which connects onto the neck part 54 comprises a multitude of tooth cleaning bristles 57a, 57b which are injected on the head part 55. The brush head 50 as a speciality also comprises tooth cleaning bristles 57b which are injected laterally on the head part 55 and which are arranged parallel to the remaining tooth cleaning bristles 57a.

The brush head 60 according to FIGS. 24a and 24b, which connects onto the neck part 64, on the front side comprises a plurality of tooth cleaning bristles 67a and on the rear side of the head part 65 comprises a plurality of tongue cleaning bristles 67b. The tooth cleaning bristles 67a and the tongue cleaning bristles 67b are arranged opposite one another.

The cleaning bristles 67a, 67b are injected on the front side and the rear side onto the head part 65. The cleaning bristles 67a, 67b are organised in bristle segments.

The tongue cleaning bristles 67b are designed shorter than the tooth cleaning bristles 67a.

The head part 65 comprises a core 66a of a first component and a jacket 66b of a second component. The jacket 66b is thereby manufactured from the bristle component and corresponds to the bristle carrier.

The brush head 70 according to FIG. 25, analogously to the embodiment according to FIGS. 24a and 24b, on the front side comprises a plurality of tooth cleaning bristles 77a and on the rear side of the head part 75 a plurality of tongue cleaning bristles 77b. The cleaning bristles 77a, 77b are likewise each injected onto the head part 65.

Furthermore, further care bristles 77c of an oral hygiene member which can likewise serve as cleaning elements or as massage elements can be injected laterally on the head part 75. The care bristles 77c which are likewise designed shorter than the tooth cleaning bristles 77a project laterally outwards from the head part 75.

In contrast to the embodiment according to FIGS. 24a and 24b, apart from the arrangement of the care bristles, the body construction is also different. The brush head is thus only manufactured from one component, the bristle component. I.e., all regions of the brush head are formed from the bristle component.

The brush head 80 according to FIGS. 26a and 26b, which connects to the neck part 84, comprises a plurality of tooth cleaning bristles 87 on the front side. The tooth cleaning bristles 87 are injected onto the head part 85 at the front side. The tooth cleaning bristles 87 are organised in bristle segments.

The head part 85 is ordered into several leaf-like surface sections which are each delimited from one another by slot-like openings 82 which are led from the outside towards the centre of the head part 85. The head part 85 thus comprises a clover-leaf-shaped organisation into three surface sections.

The individual surface sections thus have a limited connecting section to the main body. Accordingly, the surface sections are elastically movable relative to the main body.

Furthermore, at least a part of the leaf-like surface sections can be created from only the bristle component, in order to expand the flexible possibilities.

The brush head 90 according to FIG. 27a -27d comprises tooth cleaning bristles 97a, 97b which are arranged on the front side of the head part 95 and form a bristle field of two bristle types.

The head part 95 comprises a main section and section at the head end side, said head-end-side section being angled with respect to the main section towards the front side of the head part 95 or the neck part 94.

A first bristle field with stamped, conventional care bristles 97a is arranged on the main section. A second bristle field with injected care bristles 97b is arranged on the end section.

The tooth cleaning bristles 97b which are arranged on the angled end section are likewise angled and are directed towards the tooth cleaning bristles 97a of the main section. The tooth cleaning bristles 97a, 97b of the bristle part-fields which are formed in this manner intersect or cross.

The injected tooth cleaning bristles 97b are injected onto the end section of the head part 95 via a bristle carrier. The tooth cleaning bristles 97b are injected onto the head part 95 in a separate injection moulding step for this.

However, the tooth cleaning bristles 97a of the main section can likewise be injected.

A possible method sequence for the manufacture of a body care brush with care bristles which are manufactured in the injection moulding method is represented in FIG. 28. The particularity of the shown sequence is the fact that the injection moulding of the main body with the head part and the injection moulding of the bristle field are separate procedures.

The main body with the head part is manufactured in the injection moulding method in a first injection moulding step. After completion of the main body, this is intermediately stored in a buffering device or stored in another manner. A buffering is applied if the process steps are directly linked in an inline manner. A conventional storage is applied if the injection moulding of the main body and the injection moulding of the bristle field are not effected inline but temporally independently of one another.

The bristle field is manufactured subsequently to the main body in the injection moulding method in a second injection moulding step. With the application of a uniform interface structure in the head part, one can envisage different geometries of bristle fields being able to be injected. This means that the appearance of the functional part of the brush, specifically of the brush head, does not differ until in the further injection moulding step. Different bristle fields can therefore be injection moulded on the head part at a predefined interface structure.

As a variant, first soft components as parts of the brush head, for example soft-elastic massage or cleaning elements can already be injected in the first injection moulding step on injecting moulding the main body, due to the applied material components and the construction of the main body.

The body care brush can again be buffered via a buffering device or stored, depending on the linking of the process steps, subsequently to the manufacture. Regarding the buffering or storing it is referred to the description above.

The finished body care brush is packaged in a subsequent process step which is subsequent to a possible buffering or storage.

The process sequence according to FIG. 28 provides the manufacturer with a large product variability amid the application of as few as possible tool changes.

The concept of the variability of the bristle fields on manufacturing care brushes according to the process sequence described in FIG. 28 is represented in FIG. 29.

The injection moulding tools for manufacturing four different main body designs (main body G1 to main body G4) are specified schematically on the left side in a column. Each of the four injection moulding tools has a differently designed tool section for manufacturing the head part. The mentioned tool section comprises tool inserts for this.

Accordingly, the different injection moulding tools open up various possibilities concerning the fashioning of the brush head on the head part.

Standardised interface structures can be applied due to the exchange inserts for manufacturing the head part. Herein, it is possible to realise several, in the present case at least three different interface structures in an injection moulding tool. However, not necessarily all interface structures need to be able to be realised for each main body design:
1. Interface structure “bristle holes”
   Interface structure for the attachment of anchor-stamped, conventional extruded care bristles
2. Interface structure “retaining geometry”
   Interface structure for injected care bristles
3. Interface structure “spoon geometry”
   Interface structure for attaching care bristles on a carrier platelet. The carrier platelet with the care bristles is thereby inserted into the spoon-like deepening of the head part and is connected to the head part. Hereby, carrier platelets with injected care bristles or also carrier platelets with convention, extruded care bristles can be used, for example AFT bristle fields.

One to three interface structures can be realised in the head part with one main body design in this manner, depending on the design.

Different bristle fields are now possible depending on the selected interface structure.

Injected bristle fields are manufactured in a further injection moulding tool. According to FIG. 29, an injection moulding tool “bristle field”, in which the care bristles are injected and are connected to the interface structure in the head part via the integrally co-injected bristle carrier is provided for manufacturing bristle fields with injected bristles.

In the present example, two injection moulding tools for the manufacture of an injected “bristle field 1” and “bristle field 2” are provided. However, these are based on the common interface structure “retaining geometry”.

Concerning the interface structure “retaining geometry” for injected care bristles, it is therefore possible to manufacture different, in the present case two different bristle fields with injected bristles via the same interface structure by way of different injection moulding tools for injected bristles.

The combination possibilities which are represented in FIG. 29 now result in total in 12 different care bristles, which are based on only four different main body designs.

The main body 202 of a toothbrush 201 with a grip part 203, a neck part 204 as well as a head part 205 is represented in the FIGS. 30a and 30b. The head part 205 forms the interface structure “retaining geometry” for the injecting-on of tooth care bristles 207 in an injection moulding method. The interface structure is characterised by openings, retaining structures and support surfaces, which permit a connection to the bristle component which forms the bristle carrier.

FIGS. 30c and 30d show the toothbrush 201 with the main body 202 according to FIGS. 30a and 30b with tooth care bristles 207 which are injected on the head part 205. The head part 205 and the tooth care bristles 207 form the brush head 208. The meshing of the head part 205 with the bristle component of the bristle carrier is particularly well evident from FIG. 30d, wherein this meshing is effected by the retaining structures.

The main body 252 of a toothbrush 251 with a grip part 253, a neck part 254 and a head part 255 is represented in the FIGS. 31a and 31b. The head part 255 forms the interface structure “spoon geometry” for the attachment of a carrier platelet with tooth care bristles 257, in particular of an AFT platelet. The interface structure is characterised by a spoon-shaped deepening or recess which forms a receiver for the carrier platelet subsequent to the injection moulding of the main body 252.

FIGS. 31c and 31d show the toothbrush 251 with the main body 252 according to FIGS. 31a and 31b. A carrier platelet/AFT platelet with tooth care bristles 257 is attached to the head part 255, said platelet being received into the spoon-like deepening on the head part 255. The head part 255 and the tooth care bristles 257 form the brush head 258.

The main body 302 of a toothbrush 301 with a grip part 303, a neck part 304 as well as a head part 305 is represented in FIGS. 32a and 32b. The head part 305 forms the interface structure “bristle holes” for the fastening of bristle bundles of conventional, extruded tooth care bristles 307. The interface structure is characterised by a plurality of bristle holes 309 which form a receiver for the bristle bundle subsequently to the injection moulding of the main body 302.

FIGS. 32c and 32d show the toothbrush 301 with the main body 302 according to FIGS. 32a and 32b. Conventional, extruded, anchor-stamped tooth care bristles 307 are inserted into the bristle holes 309 on the head part 305. The head part 305 and the tooth care bristles 307 form the brush head 308.

The main body 202, 252, 302 according to FIGS. 30a to 30d, 31a to 31d and 32a to 32d thus have different interface structures in the head part 205, 255, 305 for attaching the tooth care bristles 207, 257, 307, wherein the grip parts 203, 253, 303 are identical.

With reference to FIG. 29, the injection moulding machine for manufacturing the three embodiments of toothbrushes 201, 251, 301 corresponds to the injection moulding machine “main body G4”. One obtains one of the represented toothbrushes 201, 251, 301 depending on the selection of the tool insert for manufacturing the head part 205, 255, 305 with the associated interface structure “bristle holes”, “retaining geometry” or “spoon geometry”.

The combinations which are described above are hereinafter yet represented in tabular form, in each case in dependence on the process steps:

### Injection Moulded Main Body:

| main body injection moulding tool | interface structure | FIG. |
|---|---|---|
| injection moulding tool main body G4 | retaining geometry | 30a, 30b |
| injection moulding tool main body G4 | spoon geometry | 31a, 31b |
| injection moulding tool main body G4 | bristle holes | 32a, 32b |

### Finished Brush:

| main body injection | interface | | |
|---|---|---|---|
| moulding tool | structure | bristle field | FIG. |
| injection moulding tool | retaining | injection moulding | 30c, 30d |
| main body G4 | geometry | tool bristle field F2 | |
| injection moulding tool | spoon | AFT bristle field | 31c, 31d |
| main body G4 | geometry | | |
| injection moulding tool | bristle holes | anchor-stamped | 32c, 32d |
| main body G4 | | bristle field | |

FIGS. 30a to 30d, 31a to 31d and 32a to 32d further also show the transition location 210, 260, 310 from the exchangeable tool insert for the head part 205, 255, 305 to the grip cavity for manufacturing the grip part 203, 253, 303. This transition location is in the neck part 204, 254, 304, drawn in the form of a line.

The main body 402 of a toothbrush 401 according to a further embodiment with a grip part 403, a neck part 404 as well as a head part 405 is represented in the FIGS. 33a to 33f The head part 405 forms the interface structure “retaining geometry” for injecting on the tooth care bristles 407 in an injection moulding method.

The interface structure is characterised by openings or through-holes 409, 411 as well as by retaining structures and support surfaces which permits a connection, by way of positive-fit, to the bristle component which forms the bristle carrier.

Furthermore, two positioning blind holes 410 are formed in the interface structure in the region of the front side of the main body 402. On the one hand, these ensure a retention of material of the tooth care bristles 407 and on the other hand serve for the transfer from injection moulding cavity to injection moulding cavity between a first and a second injection moulding step and for the positioning of the main body in the injection moulding cavity, in the manufacturing process.

The main body 402 further comprises a through-hole 411 which leads at least a part of the plastic of the injected care bristles 407 from the nozzle opening of the injection nozzle or from the injection point through the main body 402 to the front side during manufacture. The through-hole 411 is accordingly aligned to the nozzle opening of the injection point or corresponds with this opening or point. The nozzle opening or the injection point is accordingly arranged in the region of the head part 405 towards the rear side of the head part 405.

At the front side, one can recognise that the transition from the neck part 404 to the receiving bed of the head part 405 with the care bristles 407 is designed in a U-shaped manner in the region of the mentioned through-hole 411. The U-shaped design serves for providing the main body 402 with an improved stability—this being in contrast to a straight-lined shaping design.

As is evident from FIGS. 33a to 33e, the already mentioned openings 409, 411 which permit the positive fit between the care bristles 407 and the head part 405 are realised in the interface region.

Moreover, the two lateral outwardly leading arches are shaped as a wrapping geometry so that the retention of the materials is assisted further.

Furthermore, longitudinally running deepenings 413 are arranged on the rear side of the head part 405.

The mentioned through-holes 409, 411 are differently arranged. The through-holes 409 are thus arranged in an intermediate section of a longitudinally running deepening 413. Through-holes 411 are moreover arranged at the end of a longitudinally running deepening 413.

“In an intermediate section” is to be understood in that plastic material can flow further in the deepening 413 at several sides of the through-holes 409. The plastic material flows in the deepening in particular transversely to the longitudinal axis of the through-holes 409.

“At the end” is to be understood in that the through-hole 411 is arranged at the end of a blind alley of the recess 413 and the material in the deepening flows into the “blind alley” with the through-hole 411.

FIGS. 34a to 34f show the toothbrush 401 with the main body 402 according to FIGS. 33a to 33f with tooth care bristles 407 which are injected on the head part 405. The head part 405 and the tooth care bristles 407 form the brush head 408.

The meshing of the head part 405 with the bristle component of the bristle carrier, said meshing being effected by the retaining structures, is particularly well evident from the FIGS. 34c to 34f. The wrapping geometries can be recognised, just as the openings 409, 411 and blind holes 410 which are filled with the bristle component.

The embodiment variants which are shown in this document are exemplary. Within the scope of the invention the individual variations and elements of these embodiment variants can be combined with other embodiment variants without departing from the scope of the invention.

The features of the descriptions of the figures can be combined with one another beyond the individually shown embodiments, particularly if the embodiment has the same or similar characteristic.

In particular, embodiments of certain figures can also be conferred upon other embodiments which are represented by the figures, have the same or similar characteristics and in which the characteristics are not described in detail.

1. A body care brush, with a brush head, comprising a main body with a head part, as well as comprising a plurality of care bristles, wherein the care bristles are arranged on the head part via a bristle carrier and form a bristle field, and the head part and the bristle field are part of the brush head,
wherein
the care bristles are injection moulded as one part together with the bristle carrier by way of an injection moulding method.

2. A body care brush according to claim 1, wherein the bristle field is organised into a plurality of bristle segments each with a plurality of care bristles, wherein the bristle segments are distanced to one another.

3. A body care brush according to claim 1, wherein the bristle field comprises at least one bristle segment with a plurality of care bristles, wherein the segment base surface of the bristle segment has a geometry which is different from a circular shape.

4. A body care brush according to claim 1, wherein the bristle field comprises at least one bristle segment with a plurality of care bristles, wherein the outer contour of the segment base surface of the bristle segment forms at least one corner.

5. A body care brush according to claim 1, wherein the bristle field comprises at least one bristle segment with a plurality of care bristles, wherein the outer contour of the segment base surface of the bristle segment forms at least one straight-lined stretch section.

6. A body care brush according to claim 1, wherein the care bristles within at least one bristle segment are arranged distanced to one another at their base.

7. A body care brush according to claim 1, wherein the geometry of the segment base surface of at least one bristle segment is annulus-sector-shaped.

8. A body care brush according to claim 7, wherein the bristle field comprises a plurality of bristle segments with annulus-sector-shaped segment base surface, and the bristle segments form annulus-shaped or annulus-sector-shaped bristle arrangements in the bristle field.

9. A body care brush according to claim 1, wherein the arrangement of the care bristles within a bristle segment or the arrangement of several bristle segments on the bristle carrier is such that the care bristles in a plan view represent a pattern which conveys a message or information.

10. A body care brush according to claim 1, wherein at least one opening is arranged in the head part or in the bristle carrier, and the care bristles are arranged on the head part on surface sections of the bristle carrier, wherein the surface sections at least partly surround the openings.

11. A body care brush according to claim 1, wherein the body care brush comprises a neck part which connects onto the head part, and care bristles are arranged on the neck part.

12. A body care brush according to claim 1, wherein at least one oral hygiene member which projects beyond the bristle field of the care bristles is arranged on the brush head.

13. A body care brush according to claim 1, wherein the head part forms a front side and a rear side which lie opposite the front side, and injected care bristles are arranged on the head part, on the front side as well as on the rear side of the head part.

14. A body care brush according to claim 1, wherein at least one care bristle forms a hollow channel running in the bristle longitudinal direction.

15. A body care brush according to claim 1, wherein the cross-sectional shape of at least one care bristle comprises a straight-lined stretch section.

16. A body care brush according to claim 1, wherein at least one care bristle in each case forms at least one undercut.

17. A body care brush according to claim 1, wherein the free end section of at least one care bristle is structured by at least one deepening.

18. A body care brush according to claim 1, wherein the brush head comprises at least one care bristle or oral hygiene member arranged on the edge of the head part.

19. A body care brush according to claim 1, wherein the bristle carrier with the care bristles is injection moulded onto the head part of the main body.

20. A body care brush according to claim 1, wherein the bristle carrier is formed by a separate carrier body, and the care bristles are integrally injection moulded with the carrier body, and the carrier body is placed upon the head part of the main body or is inserted into this and is connected to the head part.

21. A body care brush according to claim 1, wherein the main body forms a neck part and a grip part which connects onto the neck part, wherein the neck part is arranged between the head part and the grip part.

22. A body care brush according to claim 1, wherein the body care brush is designed as an assembly part for assembly on a grip body, wherein the main body comprises a neck part, via which the body care brush can be assembled on the grip body.

23. A method for manufacturing a body care brush according to claim 1,
wherein care bristles are injection moulded as one part together with the bristle carrier by way of an injection moulding method.

24. A method according to claim 23, wherein a main body and a bristle carrier with care bristles are injection moulded in separate method steps, wherein the main body is demoulded before the connection to the bristle carrier which comprises the care bristles.

25. A method according to claim 23, wherein at least one part of the main body, after its demoulding is inserted into a further injection moulding cavity and the bristle carrier with the care bristles is injected onto the at least one part and is thus connected to this.

26. A method according to claim 23, wherein the main body is injection moulded with an interface structure, wherein the interface structure is designed for creating a connection to the bristle carrier.

27. A method according to claim 23, wherein the injection moulding tool for manufacturing the care bristles comprises at least one undercut in at least one channel-like bristle cavity, the undercut having the effect that the care bristle is held back in the region of the undercut during the demoulding, so that the care bristle is stretched along the bristle longitudinal axis during the demoulding.

28. A method according to claim 23, wherein the bristle component is injected into the tool cavity in a manner such that this is deflected or diverted at least once before entry into the bristle cavities.

29. An injection moulding tool for manufacturing care bristles, wherein the injection moulding tool comprises a carrier cavity which is designed to form a bristle carrier, and the injection moulding tool comprises several tool inserts each with several bristle cavities which are designed to form bristle segments each with several care bristles, and the injection moulding tool is designed to form the bristle carrier and care bristles in a single-part manner.

30-40. (canceled)
